(19) United States
(12) Patent Application Publication
(10) Pub. No.: US 2026/0240627 A1
(43) Pub. Date: Aug. 20, 2026

(54) ORTHODONTIC BRACKET AND METHOD OF USING SAME

(71) Applicants: Young Joon KIM, Seoul (KR); Sang Hoon KIM, Seoul (KR); Soo Yun KIM, Seoul (KR)

(72) Inventors: Young Joon KIM, Seoul (KR); Sang Hoon KIM, Seoul (KR); Soo Yun KIM, Seoul (KR)

(21) Appl. No.: 19/643,733

(22) Filed: Apr. 9, 2026

Related U.S. Application Data
(63) Continuation of application No. PCT/KR2025/004723, filed on Apr. 8, 2025.

(30) Foreign Application Priority Data
Apr. 18, 2024 (KR) 10-2024-0052268

(51) Int. Cl. A61C 7/28

(52) U.S. Cl. CPC A61C 7/28

(57) ABSTRACT

Provided are an orthodontic bracket and a method of using the same, the orthodontic bracket being characterized in that a cap having an appropriate slot can be selected according to the thickness and shape of an orthodontic wire selected during an orthodontic process, and thus an appropriate orthodontic force can be imparted to teeth throughout the entire orthodontic process.

### TECHNICAL FIELD

The present invention relates to an orthodontic bracket and a method of using the same, wherein the bracket is characterized in that a cap having an appropriate slot can be selected according to the thickness and shape of an orthodontic wire selected during an orthodontic treatment process, so that an appropriate orthodontic force can be imparted to teeth throughout the entire orthodontic process. Furthermore, the invention is characterized by connecting the base member and the cap member required for the connection of an orthodontic wire using a slide and/or snap fit connection method, thereby enhancing convenience while enabling safe orthodontic treatment to proceed.

### BACKGROUND ART

An uneven dental alignment or irregular malocclusion may be caused by abnormal growth of the teeth themselves, abnormal growth of the jawbone, and the like. Individuals with such uneven dental alignment or malocclusion may feel compelled to cover their mouths when talking or laughing due to their dental condition, potentially becoming introverted in interpersonal relationships and experiencing difficulty in social activities. Furthermore, food may not be chewed uniformly at mealtimes, and food may become lodged between teeth, potentially causing various dental diseases or gastrointestinal diseases.

To address these issues, orthodontic technology has been researched and developed in which continuous force is applied to the teeth to cause movement of the teeth together with remodeling of the surrounding alveolar bone.

As a representative example, there is a correction method that uses a bracket as an orthodontic correction method for correcting irregular or misaligned teeth (dental malocclusion). In this orthodontic technique, brackets attached to the teeth, wires made of shape-memory materials or stainless steel that connect to the brackets to allow the teeth to move back to their proper positions, and auxiliary materials such as tie ligatures for connecting orthodontic wires to the brackets are used to correct the teeth. After fixing the brackets to the tooth surface with resin, wires are inserted into the brackets fixed to each tooth; the wire is appropriately bent or curved in consideration of the tooth shape or dental arch to match the position of each tooth. The wire, connected to the teeth through the brackets over a prolonged period in the bent state, delivers a restoring force to the teeth, thereby gradually correcting the tooth positions. In addition, throughout the entire orthodontic process using brackets, since the size and direction of the force to be delivered to the teeth differ, orthodontic wires of appropriate size and thickness must be sequentially used.

However, since conventional brackets are continuously used while attached to the teeth, the slot of the bracket is designed to correspond to the largest (thickest) orthodontic wire used, and therefore cannot provide the appropriate orthodontic force required at each stage of orthodontic treatment. That is, when an orthodontic wire is selected at each stage of treatment, the slot size should change accordingly, but since the bracket remains attached to the tooth, it is difficult to change the slot size. As a result, brackets with slots sized for the largest orthodontic wire are generally used, but in such cases the space between the orthodontic wire and the slot becomes too wide, creating a limitation in that the weak and continuous force transmitted by the wire cannot be properly delivered to the tooth. In addition, from the practitioner's perspective, the installation or replacement process of the conventional bracket's orthodontic wire is complicated, requiring much time and effort.

### SUMMARY OF THE INVENTION

### TECHNICAL PROBLEM

The present invention has been devised to solve the above problems. An object thereof is to provide an orthodontic bracket and a method of using the same that can support the selection and use of an appropriate orthodontic wire throughout the entire orthodontic treatment process through the selection of various cap members, thereby effectively delivering the restoring force of the orthodontic wire to the teeth and periodontal tissues.

Another object is to provide an orthodontic bracket and a method of using the same that enables the practitioner to perform orthodontic procedures or replace wires conveniently and without cumbersome operations.

Another object is to provide an orthodontic bracket and a method of using the same that can be used not only for the advantages of bracket-based orthodontics, but also as an attachment for use together with transparent aligner devices such as Invisalign at the appropriate stage of orthodontic treatment.

Another object is to provide an orthodontic bracket and a method of using the same wherein the cap and base constituting the bracket are connected by a hinge method, which can be conveniently used for posterior teeth(premolars and molars).

### TECHNICAL SOLUTION

To achieve the above objects, the present invention provides an orthodontic bracket used for orthodontic treatment, wherein the bracket comprises a base member and a cap member.

The bracket provides that the base member and the cap member are connected by a slide and snap fit method.

The bracket provides that after the base member and cap member are connected by sliding, the connection is completed by a snap fit method.

The bracket provides that an orthodontic wire is disposed between the base member and the cap member.

The bracket provides that the base member comprises: a 1-1 surface used for attachment to a tooth; a 1-2 surface in contact with the cap member; and a first wire slot formed on the 1-2 surface.

The bracket provides that the width value of the first wire slot is larger than the width value of the second wire slot of the cap member.

The bracket provides that the slot protrusion of the cap member is accommodated inside the first wire slot.

The bracket provides that the length value of the first wire slot is the same as the length value of the second wire slot of the cap member.

The bracket provides that the depth value of the first wire slot is larger than the depth value of the second wire slot of the cap member.

The bracket provides that the cross-section of the first wire slot is formed in a semicircular shape.

The bracket provides that the first wire slot has a curved surface formed in the width direction.

The bracket provides that the curvature value of the curved surface of the first wire slot is smaller than the curvature value of the curved surface of the second wire slot of the cap member.

The bracket provides that the depth value of the first wire slot is larger than the diameter value of a round cross-section orthodontic wire.

The bracket provides that the first wire slot accommodates 20 to 50 percent (%) of the cross-sectional area of a rectangular cross-section orthodontic wire therein.

The bracket provides that the first wire slot accommodates 20 to 50 percent of the cross-sectional area of an orthodontic wire therein.

The bracket provides that the base member further comprises: a 1-1 base connector on one side of the first wire slot; and a 1-2 base connector on the other side of the first wire slot, for sliding and snap fit connection with the cap member.

The bracket provides that the base member further comprises: a 1-1 base connector and a 1-2 base connector on both sides of the first wire slot for snap fit connection after slide connection with the cap member.

The bracket provides that the base member further comprises: a 1-1 base connector formed on one side of the first wire slot; and a 1-2 base connector formed on the other side of the first wire slot.

The bracket provides that the end of the structure for connection of the 1-1 base connector is a hook facing outward from the base member based on the width direction, and the end of the structure for connection of the 1-2 base connector is a hook facing outward from the base member based on the width direction.

The bracket provides that the length of the 1-1 base connector and the 1-2 base connector is the same as the length of the first wire slot.

The bracket provides that the 1-1 base connector is a hook-shaped rail whose end of the structure for sliding connection faces outward from the base member based on the width direction, and the 1-2 base connector is a hook-shaped rail whose end of the structure for sliding connection faces outward from the base member based on the width direction.

The bracket provides that at the end opposite to where the 2-1 cap connector of the cap member slides into the 1-1 base connector, a 1-1 groove for snap fit connection is formed, and at the end opposite to where the 2-2 cap connector of the cap member slides into the 1-2 base connector, a 1-2 groove for snap fit connection is formed.

The bracket provides that the 1-1 base connector comprises: a 1-1 rail portion which is a region connected to the 2-1 rail portion of the 2-1 cap connector of the cap member by sliding; and a 1-1 groove which is connected to the 2-1 latch of the 2-1 cap connector of the cap member by a snap fit method; and the 1-2 base connector comprises: a 1-2 rail portion which is a region connected to the 2-2 rail portion of the 2-2 cap connector of the cap member by sliding; and a 1-2 groove connected to the 2-2 latch of the 2-2 cap connector of the cap member by a snap fit method.

The bracket provides that a pattern for widening the bonding contact area with a bonding agent is formed on the 1-1 surface.

The bracket provides that a wall pattern for preventing the bonding agent from leaking to the outside along the edge of the 1-1 surface is formed.

The bracket provides that an identification mark for distinguishing the type of the base member is formed on the 1-1 surface.

The bracket provides that the cap member comprises a 2-1 surface in contact with the base member.

The bracket provides that the cap member further comprises a second wire slot formed on the 2-1 surface.

The bracket provides that the cap member further comprises a slot protrusion formed along the length direction of the second wire slot.

The bracket provides that the width value of the second wire slot is smaller than the width value of the first wire slot of the base member.

The bracket provides that the slot protrusion is accommodated inside the first wire slot of the base member.

The bracket provides that the length value of the second wire slot is the same as the length value of the first wire slot of the base member.

The bracket provides that the depth value of the second wire slot is smaller than the depth value of the first wire slot of the base member.

The bracket provides that the second wire slot is formed in a semicircular shape.

The bracket provides that the diameter value of the second wire slot is 0.3 to 0.5 millimeters (mm).

The bracket provides that the diameter value of the second wire slot is larger by 0.8 to 1.2 millimeters than the diameter value of a round cross-section orthodontic wire used.

The bracket provides that the second wire slot has a curved surface formed in the width direction.

The bracket provides that the curvature value of the curved surface of the second wire slot is greater than the curvature value of the curved surface of the first wire slot of the base member.

The bracket provides that the second wire slot accommodates 50 to 95 percent (%) of the cross-sectional area of an orthodontic wire therein.

The bracket provides that the width-direction cross-section of the second wire slot is formed in a rectangular shape.

The bracket provides that the lateral length value of the rectangular cross-section of the second wire slot in the width direction is 0.4 to 0.6 millimeters.

The bracket provides that among the horizontal sides of the rectangular cross-section in the width direction of the second wire slot, the long horizontal side length value is 0.5 to 0.8 millimeters.

The bracket provides that a virtual line extending perpendicularly from the bottom surface of the second wire slot meets perpendicularly with a virtual plane covering the top of the first wire slot.

The bracket provides that a virtual line extending perpendicularly from the bottom surface of the second wire slot meets at an inclination with a virtual plane covering the top of the first wire slot.

The bracket provides that the inclination at which the virtual line extending perpendicularly from the bottom surface of the second wire slot meets the virtual plane covering the top of the first wire slot is 9 to 35 degrees.

The bracket provides that the cap member further comprises: a 2-1 protrusion formed on a 2-3 surface; and a 2-2 protrusion formed on a 2-4 surface.

The bracket provides that the 2-1 protrusion and/or the 2-2 protrusion is used for engaging a rubber band.

The bracket provides that the cap member further comprises: a 2-1 cap connector and a 2-2 cap connector on both sides of the second wire slot for sliding and snap fit connection with the base member.

The bracket provides that the cap member further comprises: a 2-1 cap connector and a 2-2 cap connector on both sides of the second wire slot that make snap fit connection after sliding connection with the base member.

The bracket provides that the cap member further comprises: a 2-1 cap connector formed on one side of the second wire slot; and a 2-2 cap connector formed on the other side of the second wire slot.

The bracket provides that the end of the structure for connection of the 2-1 cap connector is a hook facing inward of the cap member based on the width direction, and the end of the structure for connection of the 2-2 cap connector is a hook facing inward of the cap member based on the width direction.

The bracket provides that the length of the 2-1 cap connector and the 2-2 cap connector is the same as the length of the second wire slot.

The bracket provides that the 2-1 cap connector is a hook-shaped rail whose end of the structure for sliding connection faces inward of the cap member based on the width direction, and the 2-2 cap connector is a hook-shaped rail whose end of the structure for sliding connection faces inward of the cap member based on the width direction.

The bracket provides that at the location where the 2-1 cap connector slides into the 1-1 base connector of the base member, a 2-1 latch for snap fit connection is formed, and at the location where the 2-2 cap connector slides into the 1-2 base connector of the base member, a 2-2 latch for snap fit connection is formed.

The bracket provides that the 2-1 cap connector comprises: a 2-1 rail portion which is a region connected to the 1-1 rail portion of the 1-1 base connector of the base member by sliding; and a 2-1 latch connected to the 1-1 groove of the 1-1 base connector of the base member by snap fit; and the 2-2 cap connector comprises: a 2-2 rail portion which is a region connected to the 1-2 rail portion of the 1-2 base connector of the base member by sliding; and a 2-2 latch connected to the 1-2 groove of the 1-2 base connector of the base member by snap fit.

The bracket provides that the cap member further comprises a 2-2 surface which is the reverse side of the 2-1 surface, and an identification mark indicating the shape of the cross-section of the second wire slot is displayed on the 2-2 surface.

The bracket provides that the cap member further comprises a 2-2 surface which is the reverse side of the 2-1 surface, and an identification mark indicating the sliding insertion direction for connecting the cap member to the base member is displayed on the 2-2 surface.

The bracket provides that an identification mark indicating the sliding insertion direction for connecting the cap member to the base member is displayed on the 2-2 surface.

The bracket provides that the shape of the cross-section of the second wire slot and the sliding insertion direction for connecting the cap member to the base member are indicated by a single identification mark.

The bracket provides that the base member is formed of resin, and the cap member is formed of resin.

The present invention provides a method of using an orthodontic bracket, comprising: etching the surface of the tooth; applying a first resin to the surface of the tooth; applying a second resin to the 1-1 surface of the base member; and attaching the base member to the tooth.

The method further comprises: after the base member is attached to the tooth, disposing an orthodontic wire between the base member and the cap member; and connecting the cap member to the base member.

The method further comprises: after the cap member is connected to the base member, detaching the cap member from the base member.

The method further comprises: after the cap member is detached from the base member, removing the base member from the surface of the tooth.

The method further comprises: after the cap member is detached from the base member, removing the orthodontic wire.

The method further comprises: after the cap member is detached from the base member, selecting another cap member having a second wire slot with a larger cross-sectional area than that of the removed cap member, and connecting it to the base member.

The method further comprises: after the cap member is detached from the base member, applying a temporary resin to the 1-2 surface of the base member.

The method further comprises: after the temporary resin is applied to the 1-2 surface of the base member, attaching a frame for Invisalign or transparent aligner to the tooth.

The method further comprises: after the frame for Invisalign or transparent aligner is attached to the tooth, removing the frame for Invisalign or transparent aligner from the tooth.

The method further comprises: after the orthodontic wire is removed, disposing an orthodontic auxiliary wire in the region where the 2-1 cap connector and/or the 2-2 cap connector of the cap member is inserted into the base member; and applying a temporary resin over the orthodontic auxiliary wire.

The method further comprises: after the temporary resin is applied over the orthodontic auxiliary wire, removing the temporary resin applied over the orthodontic auxiliary wire; and removing the orthodontic auxiliary wire.

The method provides that the step of attaching the base member to the tooth is performed using a curing light.

The method provides that the first resin has a lower viscosity than the second resin.

The method provides that the connection between the cap member and the base member is made by a slide and snap fit method.

The method provides that the connection between the cap member and the base member is made by a snap fit method after sliding connection.

The method provides: after the base member is attached to the tooth, disposing an orthodontic wire between the base member and the cap member; sliding the cap member from the side of the base member; completing the sliding insertion of the cap member; and completing the snap fit connection between the cap member and the base member.

The method provides that the step of sliding the cap member from the side of the base member comprises the 2-1 cap connector and 2-2 cap connector of the cap member sliding along the 1-1 base connector and 1-2 base connector of the base member respectively, and the step of completing the snap fit connection between the cap member and the base member comprises the 2-1 latch of the 2-1 cap connector and the 2-2 latch of the 2-2 cap connector being seated in the 1-1 groove of the 1-1 base connector and the 1-2 groove of the 1-2 base connector respectively.

The method further comprises: after the cap member is connected to the base member, a step of detaching the 2-1 latch and 2-2 latch of the cap member from the 1-1 groove and 1-2 groove of the base member; and sliding the cap member in the opposite direction from where the 1-1 groove and 1-2 groove are formed to detach it from the base member.

The present invention provides a bracket for orthodontic treatment, wherein the bracket comprises a base member and a cap member, the base member is formed of resin, the cap member is formed of resin, and the resin is engineering plastic.

The bracket provides that the 1-1 surface of the base member is attached to the front surface of a tooth.

The bracket provides that the 1-1 surface of the base member is formed to be concave.

The bracket provides that the base member and the cap member are connected by a snap fit method.

The bracket provides that the base member and the cap member are connected by a slide method.

The bracket provides that the base member comprises: a 1-1 surface used for attachment to a tooth; a 1-2 surface in contact with the cap member; and a first wire slot formed on the 1-2 surface.

The bracket provides that the base member further comprises: a 1-1 base connector and a 1-2 base connector on both sides of the first wire slot for snap fit connection with the cap member.

The bracket provides that the base member further comprises: a 1-1 base connector and a 1-2 base connector on both sides of the first wire slot for slide connection with the cap member.

The bracket provides that the cap member comprises a 2-1 surface in contact with the base member.

The bracket provides that the cap member further comprises: a 2-1 protrusion formed on one side surface; and a 2-2 protrusion formed on the other side surface.

The bracket provides that the cap member further comprises: a 2-1 cap connector and a 2-2 cap connector on both sides of the second wire slot for snap fit connection with the base member.

The bracket provides that the cap member further comprises: a 2-1 cap connector and a 2-2 cap connector on both sides of the second wire slot for slide connection with the base member.

The bracket provides that the cap member further comprises a 2-2 surface which is the reverse side of the 2-1 surface, and an identification mark indicating the shape of the cross-section of the second wire slot is displayed on the 2-2 surface.

The bracket provides that the cap member further comprises a 2-2 surface which is the reverse side of the 2-1 surface, and an identification mark indicating the sliding insertion direction for connecting the cap member to the base member is displayed on the 2-2 surface.

The bracket provides that an identification mark indicating the sliding insertion direction for connecting the cap member to the base member is displayed on the 2-2 surface.

The bracket provides that the shape of the cross-section of the second wire slot and the sliding insertion direction for connecting the cap member to the base member are indicated by a single identification mark.

The bracket provides that the identification mark is formed by embossing (raised engraving).

The present invention provides a method of using an orthodontic bracket, comprising: etching the surface of a tooth; applying a first resin to the surface of the tooth; applying a second resin to the 1-1 surface of the base member; and attaching the base member to the tooth; wherein the first resin is a light-cured resin, and the second resin is a light-cured resin.

The method further comprises: after the base member is attached to the tooth, disposing an orthodontic wire between the base member and the cap member; and connecting the cap member to the base member.

The method further comprises: after the cap member is connected to the base member, detaching the cap member from the base member.

The method further comprises: after the cap member is detached from the base member, selecting another cap member having a second wire slot with a larger cross-sectional area than that of the removed cap member, and connecting it to the base member.

The method provides that the connection between the cap member and the base member is made by a snap fit method.

The method provides that the connection between the cap member and the base member is made by a slide method.

The method provides that the base member comprises: a 1-1 surface attached to a tooth; a 1-2 surface in contact with the cap member; and a first wire slot formed on the 1-2 surface.

The method provides that the width value of the first wire slot is larger than the width value of the second wire slot of the cap member, the length value of the first wire slot is the same as the length value of the second wire slot of the cap member, and the depth value of the first wire slot is larger than the depth value of the second wire slot of the cap member.

The method provides that a slot protrusion of the cap member is accommodated inside the first wire slot, and the first wire slot accommodates 20 to 50 percent of the cross-sectional area of an orthodontic wire therein.

The method provides that the cross-section of the first wire slot is formed in a semicircular shape, the first wire slot has a curved surface formed in the width direction, the curvature value of the curved surface of the first wire slot is smaller than the curvature value of the curved surface of the second wire slot of the cap member, and the depth value of the first wire slot is larger than the diameter value of a round cross-section orthodontic wire.

The method provides that the 1-1 surface has been etched to widen the bonding contact area, or has fine irregularities formed thereon, or has a pattern formed thereon to widen the bonding contact area.

The method provides that a wall pattern for preventing the bonding agent from leaking to the outside along the edge of the 1-1 surface is formed, and an identification mark for distinguishing the type of the base member is formed on the 1-1 surface.

The method provides that the base member further comprises: a 1-1 base connector and a 1-2 base connector on both sides of the first wire slot for snap fit connection with the cap member.

The method provides that the base member further comprises: a 1-1 base connector and a 1-2 base connector on both sides of the first wire slot for slide connection with the cap member.

The method provides that the base member further comprises: a 1-1 base connector and a 1-2 base connector on both sides of the first wire slot for slide and snap fit connection with the cap member.

The method provides that the base member further comprises: a 1-1 base connector and a 1-2 base connector on both sides of the first wire slot that achieve snap fit connection after slide connection with the cap member.

The method provides that the base member further comprises: a 1-1 base connector formed on one side of the first wire slot; and a 1-2 base connector formed on the other side of the first wire slot.

The method provides that the end of the structure for connection of the 1-1 base connector is a hook facing outward from the base member based on the width direction, the end of the structure for connection of the 1-2 base connector is a hook facing outward from the base member, and the length of the 1-1 base connector and the 1-2 base connector is the same as the length of the first wire slot.

The method provides that the 1-1 base connector is a hook-shaped rail whose end of the structure for sliding connection faces outward from the base member based on the width direction, and the 1-2 base connector is a hook-shaped rail whose end of the structure for sliding connection faces outward from the base member based on the width direction.

The method provides that at the end opposite to where the 2-1 cap connector slides into the 1-1 base connector, a 1-1 groove for snap fit connection is formed, and at the end opposite to where the 2-2 cap connector slides into the 1-2 base connector, a 1-2 groove for snap fit connection is formed.

The method provides that the 1-1 base connector comprises: a 1-1 rail portion which is a region connected to the 2-1 rail portion of the 2-1 cap connector by sliding; and a 1-1 groove connected to the 2-1 latch of the 2-1 cap connector by snap fit; and the 1-2 base connector comprises: a 1-2 rail portion which is a region connected to the 2-2 rail portion of the 2-2 cap connector by sliding; and a 1-2 groove connected to the 2-2 latch of the 2-2 cap connector by snap fit.

The method provides that a pattern for widening the bonding contact area with a bonding agent is formed on the 1-1 surface, a wall pattern for preventing the bonding agent from leaking outside along the edge of the 1-1 surface is formed, and an identification mark for distinguishing the type of the base member is formed on the 1-1 surface.

The method provides that the cap member comprises: a 2-1 surface in contact with the base member; a second wire slot formed on the 2-1 surface; a slot protrusion formed along the length direction of the second wire slot; wherein the slot protrusion is accommodated inside the first wire slot of the base member.

The method provides that the width value of the second wire slot is smaller than the width value of the first wire slot of the base member, the length value of the second wire slot is the same as the length value of the first wire slot of the base member, the depth value of the second wire slot is smaller than the depth value of the first wire slot of the base member, and the second wire slot accommodates 50 to 95 percent (%) of the cross-sectional area of an orthodontic wire therein.

The method provides that the second wire slot is formed in a semicircular shape, the second wire slot has a curved surface formed in the width direction, and the curvature value of the curved surface of the second wire slot is greater than the curvature value of the curved surface of the first wire slot of the base member.

The method provides that the diameter value of the second wire slot is 0.3 to 0.5 millimeters (mm).

The method provides that the diameter value of the second wire slot is 0.8 to 1.2 millimeters larger than the diameter value of a round cross-section orthodontic wire used.

The method provides that the width-direction cross-section of the second wire slot is formed in a rectangular shape, the lateral length value of the rectangular cross-section of the second wire slot in the width direction is 0.4 to 0.6 millimeters, and the long horizontal side length value is 0.5 to 0.8 millimeters.

The method provides that a virtual line extending perpendicularly from the bottom surface of the second wire slot meets perpendicularly with a virtual plane covering the top of the first wire slot.

The method provides that a virtual line extending perpendicularly from the bottom surface of the second wire slot meets at an inclination with a virtual plane covering the top of the first wire slot, and the inclination is 9 to 35 degrees.

The method provides that the cap member further comprises: a 2-1 protrusion formed on a 2-3 surface; and a 2-2 protrusion formed on a 2-4 surface.

The method provides that the cap member further comprises: a 2-1 protrusion formed on one side surface; and a 2-2 protrusion formed on the other side surface.

The method provides that the 2-1 protrusion and/or the 2-2 protrusion is used for engaging a rubber band.

The method provides that the cap member further comprises: a 2-1 cap connector and a 2-2 cap connector on both sides of the second wire slot for snap fit connection with the base member.

The method provides that the cap member further comprises: a 2-1 cap connector and a 2-2 cap connector on both sides of the second wire slot for slide connection with the base member.

The method provides that the cap member further comprises: a 2-1 cap connector and a 2-2 cap connector on both sides of the second wire slot for slide and snap fit connection with the base member.

The method provides that the cap member further comprises: a 2-1 cap connector and a 2-2 cap connector on both sides of the second wire slot that achieve snap fit connection after sliding connection with the base member.

The method provides that the cap member further comprises: a 2-1 cap connector formed on one side of the second wire slot; and a 2-2 cap connector formed on the other side of the second wire slot.

The method provides that the end of the structure for connection of the 2-1 cap connector is a hook facing inward of the cap member based on the width direction, the end of the structure for connection of the 2-2 cap connector is a hook facing inward of the cap member, and the length of the 2-1 cap connector and the 2-2 cap connector is the same as the length of the second wire slot.

The method provides that the 2-1 cap connector is a hook-shaped rail whose end of the structure for sliding connection faces inward of the cap member based on the width direction, and the 2-2 cap connector is a hook-shaped rail whose end of the structure for sliding connection faces inward of the cap member based on the width direction.

The method provides that at the location where the 2-1 cap connector slides into the 1-1 base connector of the base member, a 2-1 latch for snap fit connection is formed, and at the location where the 2-2 cap connector slides into the 1-2 base connector of the base member, a 2-2 latch for snap fit connection is formed.

The method provides that the 2-1 cap connector comprises: a 2-1 rail portion connected to the 1-1 rail portion of the 1-1 base connector by sliding; and a 2-1 latch connected to the 1-1 groove of the 1-1 base connector by snap fit; and the 2-2 cap connector comprises: a 2-2 rail portion connected to the 1-2 rail portion of the 1-2 base connector by sliding; and a 2-2 latch connected to the 1-2 groove of the 1-2 base connector by snap fit.

The method provides that the cap member further comprises a 2-2 surface which is the reverse side of the 2-1 surface, and an identification mark indicating the shape of the cross-section of the second wire slot and the sliding insertion direction for connecting the cap member to the base member is displayed on the 2-2 surface.

The method provides that the shape of the cross-section of the second wire slot and the sliding insertion direction for connecting the cap member to the base member are indicated by a single identification mark.

The method provides that the identification mark is formed by embossing.

The method provides that the base member and the cap member are formed of resin, and the resin is engineering plastic.

The present invention provides a bracket for orthodontic treatment, wherein the bracket comprises a base member and a cap member, the base member is formed of resin comprising engineering plastic.

The bracket provides that the engineering plastic is TR 90.

The bracket provides that the base member and the cap member are connected by a snap fit method.

The bracket provides that one side of the 1-2 surface of the base member and one side of the 2-1 surface of the cap member are connected by a hinge method.

The bracket provides that an orthodontic wire is disposed between the base member and the cap member.

The bracket provides that the base member comprises: a 1-1 surface used for attachment to a tooth; a 1-2 surface in contact with the cap member; and a first wire slot formed on the 1-2 surface.

The bracket provides that the width value of the first wire slot is larger than the width value of the second wire slot of the cap member.

The bracket provides that a slot protrusion of the cap member is accommodated inside the first wire slot.

The bracket provides that the length value of the first wire slot is the same as the length value of the second wire slot of the cap member.

The bracket provides that the depth value of the first wire slot is smaller than the depth value of the second wire slot of the cap member.

The bracket provides that the first wire slot has a curved surface formed in the width direction.

The bracket provides that the curvature value of the curved surface of the first wire slot is smaller than the curvature value of the curved surface of the second wire slot of the cap member.

The bracket provides that the second wire slot accommodates 50 to 90 percent (%) of the cross-sectional area of an orthodontic wire therein.

The bracket provides that the base member further comprises a 1-1 base connector on the other side of the first wire slot for snap fit connection with the cap member.

The bracket provides that the base member further comprises a 1-2 base connector on one side of the first wire slot for snap fit connection with the cap member.

The bracket provides that the base member further comprises a pair of hinge protrusions on one side of the first wire slot for hinge connection with the cap member.

The bracket provides that the 1-1 base connector is formed through the 1-3 surface of the base member.

The bracket provides that the 1-2 base connector is formed through the 1-4 surface of the base member.

The bracket provides that a pattern for widening the bonding contact area with a bonding agent is formed on the 1-1 surface.

The bracket provides that a bonding groove for widening the bonding contact area with a bonding agent is formed on the 1-1 surface.

The bracket provides that the 1-1 surface of the base member is attached to the front surface of a tooth.

The bracket provides that the 1-1 surface of the base member is formed to be concave.

The bracket provides that the cap member comprises a 2-1 surface in contact with the base member.

The bracket provides that the cap member further comprises a second wire slot formed on the 2-1 surface.

The bracket provides that the cap member further comprises a slot protrusion formed along the length direction of the second wire slot.

The bracket provides that the width value of the second wire slot is smaller than the width value of the first wire slot of the base member.

The bracket provides that the length value of the second wire slot is the same as the length value of the first wire slot of the base member.

The bracket provides that the depth value of the second wire slot is larger than the depth value of the first wire slot of the base member.

The bracket provides that the second wire slot is formed in a semicircular shape.

The bracket provides that the diameter value of the second wire slot is 0.3 to 0.9 millimeters (mm).

The bracket provides that the diameter value of the second wire slot is 0.8 to 1.2 millimeters larger than the diameter value of a round cross-section orthodontic wire used.

The bracket provides that the second wire slot has a curved surface formed in the width direction.

The bracket provides that the curvature value of the curved surface of the second wire slot is greater than the curvature value of the curved surface of the first wire slot of the base member.

The bracket provides that the second wire slot accommodates 45 to 95 percent (%) of the cross-sectional area of an orthodontic wire therein.

The bracket provides that the width-direction cross-section of the second wire slot is formed in a rectangular shape.

The bracket provides that the lateral length value of the rectangular cross-section in the width direction of the second wire slot is 0.3 to 0.6 millimeters.

The bracket provides that among the horizontal sides of the rectangular cross-section in the width direction of the second wire slot, the long horizontal side length value is 0.5 to 0.8 millimeters.

The bracket provides that a virtual plane parallel to the inner side wall of the second wire slot meets perpendicularly with the virtual plane passing through the 2-2 surface of the cap member.

The bracket provides that a virtual plane parallel to the inner side wall of the second wire slot meets at an inclination with the virtual plane passing through the 2-2 surface of the cap member.

The bracket provides that the inclination at which the virtual plane parallel to the inner side wall of the second wire slot meets the virtual plane passing through the 2-2 surface of the cap member is 3 to 20 degrees.

The bracket provides that the base member further comprises: a 1-1 protrusion formed on the 1-3 surface; and a 1-2 protrusion formed on the 1-4 surface.

The bracket provides that the 1-1 protrusion and/or the 1-2 protrusion is used for engaging a rubber band.

The bracket provides that the 1-1 protrusion is formed to have a first inclination with a virtual plane covering the 1-2 surface, and the 1-2 protrusion is formed to have a first inclination with a virtual plane covering the 1-2 surface.

The bracket provides that the first inclination is 15 degrees.

The bracket provides that the cap member further comprises a 2-1 cap connector on the other side of the second wire slot for snap fit connection with the base member.

The bracket provides that the cap member further comprises a 2-2 cap connector on one side of the second wire slot for snap fit connection with the base member.

The bracket provides that the cap member further comprises a pair of hinge grooves on one side of the second wire slot for hinge connection with the base member.

The bracket provides that the end of the structure for connection of the 2-1 cap connector is a hook facing outward of the cap member based on the width direction, and the end of the structure for connection of the 2-2 cap connector is a hook facing outward of the cap member based on the width direction.

The bracket provides that the cap member further comprises a 2-2 surface which is the reverse side of the 2-1 surface, and an identification mark indicating the shape of the cross-section of the second wire slot and/or the inclination of the second wire slot is displayed on the 2-2 surface.

The bracket provides that the identification mark is formed by embossing.

The bracket provides that the cap member further comprises a cap groove capable of accommodating the 1-2 protrusion of the base member therein about the hinge axis when rotating.

The present invention provides a method of using an orthodontic bracket, comprising: etching the surface of a tooth; applying a first resin to the surface of the tooth; applying a second resin to the 1-1 surface of the base member; and attaching the base member to the tooth; wherein the first resin is a light-cured resin and the second resin is a light-cured resin.

The method further comprises: after the base member is attached to the tooth, disposing an orthodontic wire between the base member and the cap member; and connecting the cap member to the base member.

The method further comprises: after the cap member is connected to the base member, detaching the cap member from the base member.

The method further comprises: after the cap member is detached from the base member, removing the base member from the surface of the tooth.

The method further comprises: after the cap member is detached from the base member, removing the orthodontic wire.

The method further comprises: after the cap member is detached from the base member, selecting another cap member having a second wire slot with a larger cross-sectional area than that of the removed cap member, and connecting it to the base member.

The method further comprises: after the cap member is detached from the base member, applying a temporary resin to the 1-2 surface of the base member or attaching an attachment cap member.

The method further comprises: after a temporary resin is applied to the 1-2 surface of the base member or an attachment cap member is attached, attaching a frame for Invisalign or transparent aligner to the tooth.

The method further comprises: after the frame for Invisalign or transparent aligner is attached to the tooth, removing the frame for Invisalign or transparent aligner from the tooth.

The method further comprises: after the orthodontic wire is removed, disposing an orthodontic auxiliary wire in the region where the 2-1 cap connector and/or the 2-2 cap connector of the cap member is inserted into the base member; and applying a temporary resin over the orthodontic auxiliary wire.

The method further comprises: after the temporary resin is applied over the orthodontic auxiliary wire, removing the temporary resin applied over the orthodontic auxiliary wire; and removing the orthodontic auxiliary wire.

The method provides that the step of attaching the base member to the tooth is performed using a curing light.

The method provides that the first resin has a lower viscosity than the second resin.

The method provides that the connection between the cap member and the base member is made by a snap fit method.

The method provides that the connection between the cap member and the base member is made by a hinge rotation snap fit method.

The method further comprises: after the base member is attached to the tooth, disposing an orthodontic wire between the base member and the cap member.

The method further comprises: after the orthodontic wire is disposed between the base member and cap member, moving the cap member toward the base member; and as the cap member moves toward the base member, the 2-1 cap connector and 2-2 cap connector of the cap member each snap fitting with the 1-1 base connector and 1-2 base connector of the base member.

The method further comprises: after the orthodontic wire is disposed between the base member and cap member, rotating the cap member connected by the hinge method toward the base member; and as the cap member rotates toward the base member, the 2-1 cap connector of the cap member snap fitting with the 1-1 base connector of the base member.

The method provides that the step of detaching the cap member from the base member is accomplished by the 2-1 cap connector and 2-2 cap connector of the cap member moving to the interior of the cap member, and the cap member moving in a direction opposite to the base member.

The method provides that the step of detaching the cap member from the base member is accomplished by the 2-1 cap connector of the cap member moving to the interior of the cap member, and the cap member rotating away from the base member.

The method provides that the base member comprises: a 1-1 surface attached to a tooth; a 1-2 surface in contact with the cap member; and a first wire slot formed on the 1-2 surface; and the width value of the first wire slot is larger than the width value of the second wire slot of the cap member, a slot protrusion of the cap member is accommodated inside the first wire slot, the length value of the first wire slot is the same as the length value of the second wire slot of the cap member, the depth value of the first wire slot is smaller than the depth value of the second wire slot of the cap member, the first wire slot has a curved surface formed in the width direction, and the base member and cap member are formed of resin comprising engineering plastic.

The method provides that the base member further comprises a 1-1 base connector on the other side of the first wire slot for snap fit connection with the cap member, and the curvature value of the curved surface of the first wire slot is smaller than the curvature value of the curved surface of the second wire slot of the cap member, and the second wire slot accommodates 50 to 90 percent (%) of the cross-sectional area of an orthodontic wire therein.

The method provides that the base member further comprises a 1-2 base connector on one side of the first wire slot for snap fit connection with the cap member.

The method provides that the base member further comprises a pair of hinge protrusions on one side of the first wire slot for hinge connection with the cap member.

The method provides that the 1-1 base connector is formed through the 1-3 surface of the base member, and the 1-2 base connector is formed through the 1-4 surface of the base member.

The method provides that a pattern and/or bonding groove for widening the bonding contact area with a bonding agent is formed on the 1-1 surface of the base member, the 1-1 surface of the base member is used for attachment to the front surface of a tooth, and the 1-1 surface of the base member is formed to be concave.

The method provides that the cap member comprises: a 2-1 surface in contact with the base member; a second wire slot formed on the 2-1 surface; a slot protrusion formed along the length direction of the second wire slot; and the width value of the second wire slot is smaller than the width value of the first wire slot of the base member, the length value of the second wire slot is the same as the length value of the first wire slot of the base member, the depth value of the second wire slot is larger than the depth value of the first wire slot of the base member, and the second wire slot accommodates 45 to 95 percent (%) of the cross-sectional area of an orthodontic wire therein.

The method provides that the second wire slot is formed in a semicircular shape, the diameter value of the second wire slot is 0.3 to 0.9 millimeters (mm), and the diameter value of the second wire slot is 0.8 to 1.2 millimeters larger than the diameter value of a round cross-section orthodontic wire used.

The method provides that the second wire slot has a curved surface formed in the width direction, and the curvature value of the curved surface of the second wire slot is greater than the curvature value of the curved surface of the first wire slot of the base member.

The method provides that the width-direction cross-section of the second wire slot is formed in a rectangular shape, the lateral length value of the rectangular cross-section in the width direction of the second wire slot is 0.3 to 0.6 millimeters, and the long horizontal side length value is 0.5 to 0.8 millimeters.

The method provides that a virtual plane parallel to the inner side wall of the second wire slot meets perpendicularly with a virtual plane passing through the 2-2 surface of the cap member.

The method provides that a virtual plane parallel to the inner side wall of the second wire slot meets at an inclination of 3 to 20 degrees with a virtual plane passing through the 2-2 surface of the cap member.

The method provides that the base member further comprises: a 1-1 protrusion formed on the 1-3 surface; and a 1-2 protrusion formed on the 1-4 surface, and the 1-1 protrusion and/or the 1-2 protrusion is used for engaging a rubber band.

The method provides that the 1-1 protrusion is formed to have a first inclination of 15 degrees with a virtual plane covering the 1-2 surface, and the 1-2 protrusion is formed to have a first inclination of 15 degrees with a virtual plane covering the 1-2 surface.

The method provides that the cap member further comprises a 2-1 cap connector on the other side of the second wire slot for snap fit connection with the base member, and the end of the structure for connection of the 2-1 cap connector is a hook facing outward of the cap member based on the width direction.

The method provides that the cap member further comprises a 2-2 cap connector on one side of the second wire slot for snap fit connection with the base member, and the end of the structure for connection of the 2-2 cap connector is a hook facing outward of the cap member based on the width direction.

The method provides that the cap member further comprises a 2-2 surface which is the reverse side of the 2-1 surface, and on the 2-2 surface an identification mark indicating the shape of the cross-section of the second wire slot and/or the inclination of the second wire slot is formed by embossing.

The present invention provides a bracket for orthodontic treatment, wherein the bracket comprises a base member and a cap member, the base member is formed of resin, the cap member is formed of resin, the resin is engineering plastic, and the cap member further comprises: a 2-1 cap connector and a 2-2 cap connector on both sides of the second wire slot for snap fit and/or slide connection with the base member.

The bracket provides that the cap member further comprises a 2-1 surface, and the 2-2 surface which is the reverse side of the 2-1 surface bears an identification mark indicating the sliding insertion direction for connecting the cap member to the base member.

The bracket provides that the cap member further comprises a 2-1 surface, and the 2-2 surface which is the reverse side of the 2-1 surface bears an identification mark indicating the shape of the cross-section of the second wire slot and the sliding insertion direction for connecting the cap member to the base member in one single mark.

The present invention provides a method of using an orthodontic bracket, comprising: etching the surface of a tooth; applying a first resin to the surface of the tooth; applying a second resin to the 1-1 surface of the base member; attaching the base member to the tooth; disposing an orthodontic wire between the base member and the cap member; and connecting the cap member to the base member; wherein the first resin is a light-cured resin, the second resin is a light-cured resin, and the connection between the cap member and the base member is by snap fit and/or slide method.

The method provides that the base member comprises: a 1-1 surface attached to a tooth; a 1-2 surface in contact with the cap member; and a first wire slot formed on the 1-2 surface.

The method provides that the width value of the first wire slot is larger than the width value of the second wire slot of the cap member, the length value of the first wire slot is the same as the length value of the second wire slot of the cap member, and the depth value of the first wire slot is larger than the depth value of the second wire slot of the cap member.

The method provides that a slot protrusion of the cap member is accommodated inside the first wire slot, and the first wire slot accommodates 20 to 50 percent of the cross-sectional area of an orthodontic wire therein.

The method provides that the cross-section of the first wire slot is formed in a semicircular shape, and the first wire slot has a curved surface formed in the width direction; the curvature value of the curved surface of the first wire slot is smaller than the curvature value of the curved surface of the second wire slot of the cap member, and the depth value of the first wire slot is larger than the diameter value of a round cross-section orthodontic wire.

The method provides that the 1-1 surface has been etched to widen the bonding contact area, or has fine irregularities formed thereon, or has a pattern formed thereon to widen the bonding contact area.

The method provides that a wall pattern for preventing the bonding agent from leaking to the outside along the edge of the 1-1 surface is formed, and an identification mark for distinguishing the type of the base member is formed on the 1-1 surface.

The method provides that the base member further comprises: a 1-1 base connector and a 1-2 base connector on both sides of the first wire slot for snap fit connection with the cap member.

The method provides that the base member further comprises: a 1-1 base connector and a 1-2 base connector on both sides of the first wire slot for slide connection with the cap member.

The method provides that the base member further comprises: a 1-1 base connector and a 1-2 base connector on both sides of the first wire slot for slide and snap fit connection with the cap member.

The method provides that the base member further comprises: a 1-1 base connector and a 1-2 base connector on both sides of the first wire slot that achieve snap fit connection after slide connection with the cap member.

The method provides that the base member further comprises: a 1-1 base connector formed on one side of the first wire slot; and a 1-2 base connector formed on the other side of the first wire slot.

The method provides that the end of the structure for connection of the 1-1 base connector is a hook facing outward from the base member based on the width direction, the end of the structure for connection of the 1-2 base connector is a hook facing outward from the base member, and the length of the 1-1 base connector and the 1-2 base connector is the same as the length of the first wire slot.

The method provides that the 1-1 base connector is a hook-shaped rail whose end of the structure for sliding connection faces outward from the base member based on the width direction, and the 1-2 base connector is a hook-shaped rail whose end of the structure for sliding connection faces outward from the base member based on the width direction.

The method provides that at the end opposite to where the 2-1 cap connector slides into the 1-1 base connector, a 1-1 groove for snap fit connection is formed, and at the end opposite to where the 2-2 cap connector slides into the 1-2 base connector, a 1-2 groove for snap fit connection is formed.

The method provides that the 1-1 base connector comprises: a 1-1 rail portion connected to the 2-1 rail portion of the 2-1 cap connector by sliding; and a 1-1 groove connected to the 2-1 latch of the 2-1 cap connector by snap fit; and the 1-2 base connector comprises: a 1-2 rail portion connected to the 2-2 rail portion of the 2-2 cap connector by sliding; and a 1-2 groove connected to the 2-2 latch of the 2-2 cap connector by snap fit.

The method provides that a pattern for widening the bonding contact area with a bonding agent is formed on the 1-1 surface, a wall pattern for preventing the bonding agent from leaking outside along the edge of the 1-1 surface is formed, and an identification mark for distinguishing the type of the base member is formed on the 1-1 surface.

The method provides that the cap member comprises: a 2-1 surface in contact with the base member; a second wire slot formed on the 2-1 surface; and a slot protrusion formed along the length direction of the second wire slot; wherein the slot protrusion is accommodated inside the first wire slot of the base member.

The method provides that the width value of the second wire slot is smaller than the width value of the first wire slot of the base member, the length value of the second wire slot is the same as the length value of the first wire slot of the base member, the depth value of the second wire slot is smaller than the depth value of the first wire slot of the base member, and the second wire slot accommodates 50 to 95 percent (%) of the cross-sectional area of an orthodontic wire therein.

The method provides that the second wire slot is formed in a semicircular shape, the second wire slot has a curved surface formed in the width direction, and the curvature value of the curved surface of the second wire slot is greater than the curvature value of the curved surface of the first wire slot of the base member.

The method provides that the diameter value of the second wire slot is 0.3 to 0.5 millimeters (mm).

The method provides that the diameter value of the second wire slot is 0.8 to 1.2 millimeters larger than the diameter value of a round cross-section orthodontic wire used.

The method provides that the width-direction cross-section of the second wire slot is formed in a rectangular shape, the lateral length value is 0.4 to 0.6 millimeters, and the long horizontal side length value is 0.5 to 0.8 millimeters.

The method provides that a virtual line extending perpendicularly from the bottom surface of the second wire slot meets perpendicularly with a virtual plane covering the top of the first wire slot.

The method provides that a virtual line extending perpendicularly from the bottom surface of the second wire slot meets at an inclination of 9 to 35 degrees with a virtual plane covering the top of the first wire slot.

The method provides that the cap member further comprises: a 2-1 protrusion formed on a 2-3 surface; and a 2-2 protrusion formed on a 2-4 surface.

The method provides that the cap member further comprises: a 2-1 protrusion formed on one side surface; and a 2-2 protrusion formed on the other side surface.

The method provides that the 2-1 protrusion and/or the 2-2 protrusion is used for engaging a rubber band.

The method provides that the cap member further comprises: a 2-1 cap connector and a 2-2 cap connector on both sides of the second wire slot for snap fit connection with the base member.

The method provides that the cap member further comprises: a 2-1 cap connector and a 2-2 cap connector on both sides of the second wire slot for slide connection with the base member.

The method provides that the cap member further comprises: a 2-1 cap connector and a 2-2 cap connector on both sides of the second wire slot for slide and snap fit connection with the base member.

The method provides that the cap member further comprises: a 2-1 cap connector and a 2-2 cap connector on both sides of the second wire slot that achieve snap fit connection after sliding connection with the base member.

The method provides that the cap member further comprises: a 2-1 cap connector formed on one side of the second wire slot; and a 2-2 cap connector formed on the other side of the second wire slot.

The method provides that the end of the structure for connection of the 2-1 cap connector is a hook facing inward of the cap member based on the width direction, and the end of the structure for connection of the 2-2 cap connector is a hook facing inward of the cap member, and the length of the 2-1 cap connector and the 2-2 cap connector is the same as the length of the second wire slot.

The method provides that the 2-1 cap connector is a hook-shaped rail whose end of the structure for sliding connection faces inward of the cap member based on the width direction, and the 2-2 cap connector is a hook-shaped rail whose end of the structure for sliding connection faces inward of the cap member based on the width direction.

The method provides that at the location where the 2-1 cap connector slides into the 1-1 base connector of the base member, a 2-1 latch for snap fit connection is formed, and at the location where the 2-2 cap connector slides into the 1-2 base connector of the base member, a 2-2 latch for snap fit connection is formed.

The method provides that the 2-1 cap connector comprises: a 2-1 rail portion connected to the 1-1 rail portion of the 1-1 base connector by sliding; and a 2-1 latch connected to the 1-1 groove of the 1-1 base connector by snap fit; and the 2-2 cap connector comprises: a 2-2 rail portion connected to the 1-2 rail portion of the 1-2 base connector by sliding; and a 2-2 latch connected to the 1-2 groove of the 1-2 base connector by snap fit.

The method provides that the cap member further comprises a 2-2 surface which is the reverse side of the 2-1 surface, and an identification mark indicating the shape of the cross-section of the second wire slot and the sliding insertion direction for connecting the cap member to the base member is displayed on the 2-2 surface.

The method provides that the shape of the cross-section of the second wire slot and the sliding insertion direction for connecting the cap member to the base member are indicated by a single identification mark.

The method provides that the identification mark is formed by embossing.

The method provides that the base member and the cap member are formed of resin, and the resin is engineering plastic.

### EFFECTS OF THE INVENTION

The orthodontic bracket and method of using the same according to the present invention have the following effects.

First, it is possible to adjust and apply an appropriate force to the teeth during the entire orthodontic process in a timely manner. Specifically, since an appropriate cap can be selected and used according to the shape and thickness of the orthodontic wire used, the restoring force of the orthodontic wire is effectively transmitted to the teeth and periodontal tissues. Through this, the treatment period for orthodontic treatment can also be shortened, and side effects such as root resorption can be minimized.

Second, since conventional brackets cannot provide appropriate slots for the size and shape of orthodontic wires used at each stage of orthodontic treatment, it was necessary to either use a bracket equipped with a slot for the largest orthodontic wire, or to perform the cumbersome task of removing the bracket; however, the present invention can provide an appropriate slot to the bracket corresponding to the size and shape of the orthodontic wire being used through replacement of caps, thereby increasing convenience for both the patient and the practitioner.

Third, in embodiments where the connection between the base member and cap member uses both slide and snap fit methods in a dual process, there is an effect of improving stability throughout the entire orthodontic process while simultaneously increasing convenience of use.

Fourth, at stages of orthodontic treatment where the use of transparent aligner devices such as Invisalign is required, the use of transparent aligner devices can also be supported. Specifically, by applying a temporary resin to the base member so that it can function as an attachment, the advantages of bracket-based orthodontics and the advantages of treatment using transparent aligners can be selectively utilized for more effective orthodontic treatment.

Fifth, wire ties and the like are not used for fixing the orthodontic wire, and rubber bands can also be threaded in a smaller and neater form compared to conventional brackets, reducing the possibility of food becoming lodged between teeth or injury occurring in the oral cavity. Also, foreign body sensation can be reduced.

Sixth, with the present invention, the force provided by nickel-titanium wire, which has lower stiffness but can exert weak and continuous force, can also be effectively transmitted to the teeth, enabling nickel-titanium wire to be more actively used in orthodontic treatment. Through this, the number of orthodontic wire replacements can be drastically reduced, potentially increasing patient and/or orthodontist convenience.

Seventh, through the identification marks formed on the cap member, the shape of the second wire slot of the cap and the sliding insertion direction can be predicted, thereby increasing user convenience and preventing errors from occurring in advance.

Eighth, through the pattern formed on the 1-1 surface of the base member, while preventing bonding agent from spreading to areas such as the first wire slot or the sliding and/or snap fit connection portion, excess resin can be moved up and down to be usable for attachment to the tooth surface, allowing for more convenient application and stronger attachment of the base member.

Ninth, in embodiments where the cap member and base member are connected by a hinge method, it more easily supports the connection between the cap member and base member, and at the same time can conveniently support the sliding movement of posterior and/or molar teeth during the orthodontic process.

### BRIEF DESCRIPTION OF THE DRAWINGS

FIG. 1 is a drawing showing the appearance of a transparent aligner device called Invisalign, one of the conventional orthodontic devices.

FIG. 2 is a drawing showing an example of a conventional metal orthodontic device.

FIG. 3 is a drawing showing the conventional metal orthodontic device in use.

FIG. 4 is a drawing showing the appearance of a conventional self-ligating bracket with its cover closed.

FIG. 5 is a drawing showing the appearance of a conventional self-ligating bracket with its cover open.

FIG. 6 shows the appearance of an orthodontic wire fixed using a conventional self-ligating bracket.

FIG. 7 is a drawing comparing orthodontic wires used with the conventional self-ligating bracket.

FIG. 8 shows the use of a thin-diameter orthodontic wire for imparting a weak and continuous force at the beginning of orthodontic treatment.

FIG. 9 is an enlarged view of section 'E1' of FIG. 8.

FIG. 10 shows the wire changed to a thicker, larger-diameter orthodontic wire.

FIG. 11 is an enlarged view of section 'E2' of FIG. 10.

FIG. 12 is a drawing showing root resorption occurring during orthodontic treatment.

FIG. 13 is a drawing showing root resorption occurring during orthodontic treatment.

FIG. 14 is a drawing showing, in a graph, the force applied according to the material of the orthodontic wire used and the range of movement.

FIG. 15 is a drawing showing the appearance when various sizes and shapes of orthodontic wires are placed in the slots provided by a conventional self-ligating bracket or conventional metal orthodontic device.

FIG. 16 is a drawing organizing and showing the ideal slot shape and size to be provided according to the size and shape of orthodontic wires.

FIG. 17 is a drawing showing the overall appearance of the orthodontic bracket according to the present invention.

FIG. 18 is a drawing showing a side view of the base member constituting the orthodontic bracket according to the present invention.

FIG. 19 is a drawing showing an overview of the method of using the orthodontic bracket according to the present invention.

FIG. 20 is a drawing showing the orthodontic wire disposed and held between the base member and cap member of the orthodontic bracket according to the present invention.

FIG. 21 is a drawing of the orthodontic bracket of FIG. 20 viewed from the side.

FIG. 22 is a drawing showing the cap member bearing an identification mark combined with the base member of the present invention.

FIG. 23 is a drawing showing the overall appearance of the base member constituting the present invention.

FIG. 24 is a drawing showing the 1-2 surface of the base member constituting the present invention.

FIG. 25 is a drawing showing the 1-2 surface of the base member constituting the present invention.

FIG. 26 is a drawing showing the base member in the direction of cap member sliding insertion.

FIG. 27 is a drawing showing the base member in the direction of cap member sliding insertion.

FIG. 28 is a drawing showing the base member on the opposite side from the direction of cap member sliding insertion.

FIG. 29 is a drawing showing the surface irregularities (fine protrusions and recesses) formed on the 1-1 surface of the base member constituting the orthodontic bracket according to the present invention.

FIG. 30 is a drawing showing the pattern formed on the 1-1 surface of the base member constituting the orthodontic bracket according to the present invention.

FIG. 31 is a drawing showing a side view of the cap member constituting the present invention.

FIG. 32 is an enlarged drawing showing the second wire slot portion of the cap member constituting the present invention.

FIG. 33 is a drawing showing a side view of the portion where the cap member slides into the base member.

FIG. 34 is a drawing showing the 2-1 surface of the cap member constituting the present invention that contacts the base member.

FIG. 35 is a drawing showing the 2-1 surface of the cap member constituting the present invention that contacts the base member.

FIG. 36 is a drawing comparing the 1-2 surface of the base member and the 2-1 surface of the cap member that contact each other when combined.

FIG. 37 is a drawing showing the second wire slot with a semicircular cross-section that supports an orthodontic wire in the orthodontic bracket according to the present invention.

FIG. 38 is a drawing showing the second wire slot with a rectangular cross-section that supports an orthodontic wire in the orthodontic bracket according to the present invention.

FIG. 39 is a drawing showing the second wire slot with a tilted rectangular cross-section that supports an orthodontic wire in the orthodontic bracket according to the present invention.

FIG. 40 is a drawing showing the identification mark formed on the 2-2 surface of the cap member constituting the present invention and its function.

FIG. 41 is an enlarged drawing showing the etched tooth surface.

FIGS. 42 and 43 are drawings showing the process of attaching the base member constituting the present invention to a tooth surface.

FIGS. 44 and 45 are drawings showing the process of the cap member connecting to the base member with an orthodontic wire placed.

FIG. 46 is a drawing showing the completion of support for the orthodontic wire through the orthodontic bracket according to the present invention.

FIGS. 47 and 48 are drawings showing an orthodontic auxiliary wire placed in the open region of the base member constituting the present invention to provide additional orthodontic force needed for orthodontic treatment.

FIG. 49 is a drawing schematically summarizing the concept of use of the orthodontic bracket according to the present invention.

FIG. 50 is a drawing showing the process of removing the base member attached to a tooth.

FIGS. 51 to 54 are sequential drawings showing the method of using the orthodontic bracket according to the present invention.

FIG. 55 is a sequential drawing showing the process of combining the base member and cap member constituting the present invention.

FIG. 56 is a sequential drawing showing the process of detaching the base member and cap member constituting the present invention.

FIG. 57 is a drawing showing the overall appearance of another embodiment of the orthodontic bracket according to the present invention.

FIG. 58 is a drawing showing the process of the cap member and base member being combined in another embodiment of the orthodontic bracket according to the present invention.

FIG. 59 is a drawing showing a side view of another embodiment of the orthodontic bracket according to the present invention.

FIG. 60 is a drawing showing the overall appearance of the base member of another embodiment of the orthodontic bracket according to the present invention.

FIG. 61 is a drawing showing a side view of the base member of another embodiment of the orthodontic bracket according to the present invention.

FIG. 62 is a drawing showing the appearance of the 1-3 surface of the base member of another embodiment of the orthodontic bracket according to the present invention.

FIG. 63 is a drawing showing the 1-2 surface viewed from the base member of another embodiment of the orthodontic bracket according to the present invention.

FIG. 64 is a drawing showing a view of the 1-1 surface of another embodiment of the base member of the present invention.

FIG. 65 is a drawing showing the overall appearance of the cap member of another embodiment of the orthodontic bracket according to the present invention.

FIG. 66 is a drawing showing a side view of another embodiment of the cap member of the present invention.

FIG. 67 is a drawing showing the 2-3 surface of the cap member of the present invention.

FIG. 68 is a drawing showing the 2-1 surface of another embodiment of the cap member of the present invention.

FIG. 69 is a drawing showing the overall appearance of yet another embodiment of the cap member of the present invention.

FIG. 70 is a drawing showing a side view of yet another embodiment of the cap member of the present invention.

FIG. 71 is a drawing showing the appearance of yet another embodiment of the orthodontic bracket of the present invention, with the base member and cap member combined.

FIG. 72 is a drawing showing, in yet another embodiment of the orthodontic bracket of the present invention, the appearance of the orthodontic wire placed between the base member and cap member.

FIG. 73 is a drawing showing the overall appearance of yet another embodiment of the orthodontic bracket of the present invention.

FIG. 74 is a drawing showing a side view of yet another embodiment of the orthodontic bracket of the present invention.

FIG. 75 is a drawing showing, in yet another embodiment of the orthodontic bracket of the present invention, the appearance with the cap member open.

FIG. 76 is a drawing showing the overall appearance of the base member of yet another embodiment of the orthodontic bracket of the present invention.

FIG. 77 is a drawing showing the appearance of the 1-2 surface of the base member of yet another embodiment.

FIG. 78 is a drawing showing a side view of the base member of yet another embodiment.

FIG. 79 is a drawing showing the 1-4 surface of the base member of yet another embodiment.

FIG. 80 is a drawing showing the overall appearance of the cap member of yet another embodiment.

FIG. 81 is a drawing showing a side view of the cap member of yet another embodiment.

FIG. 82 is a drawing showing the portion where a hinge groove is formed in the cap member of yet another embodiment.

FIG. 83 is a drawing showing the cap member of yet another embodiment viewed from above.

FIG. 84 is a drawing showing the 2-1 surface of the cap member of yet another embodiment of the present invention.

### DETAILED DESCRIPTION OF EMBODIMENTS

Hereinafter, embodiments of the present invention will be described in detail with reference to the accompanying drawings. Since the present invention can be modified in various ways and can have various forms, specific embodiments will be illustrated in the drawings and described in detail in the text.

However, this is not intended to limit the present invention to a specific form of disclosure, and it should be understood to include all modifications, equivalents, and substitutions included in the spirit and scope of the present invention.

In the description of the present invention, terms such as 'first' and 'second' are used only for the purpose of distinguishing one component from another. A singular expression includes a plural expression unless the context clearly indicates otherwise, and the terms 'comprise' or 'have' are used to designate that a stated feature, number, step, operation, component, part, or combination thereof exists, and do not preclude the existence or possibility of one or more other features or combinations thereof.

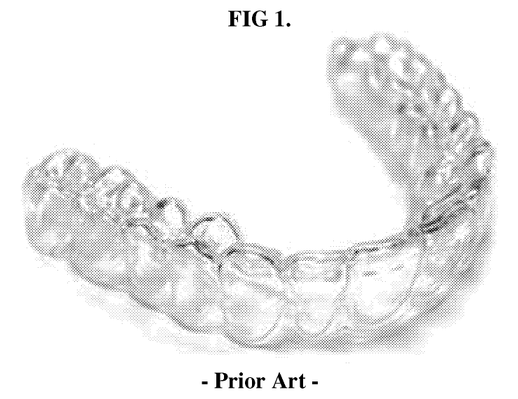

FIGS. 1 to 13 are drawings for explaining conventional orthodontic devices, and are drawings illustrating the problems and limitations that may arise from the use of conventional orthodontic devices.

FIG. 1 is a drawing showing the appearance of Invisalign, one of the conventional orthodontic devices, also called a transparent correction device.

The transparent aligner device, also called Invisalign, is made of transparent plastic and, compared to traditional metal braces, is less visible and has less impact on daily life. Such Invisalign is manufactured to fit each patient's tooth structure, and a series of aligners are used to gradually move the teeth to the correct position; usually about 2 weeks of wearing each aligner is required.

Although Invisalign has the advantage of being relatively less noticeable from the outside compared to metal braces, it takes longer than metal braces to achieve the desired treatment results, and since it is a removable device, if the patient does not comply with wearing it, the treatment results may be poor.

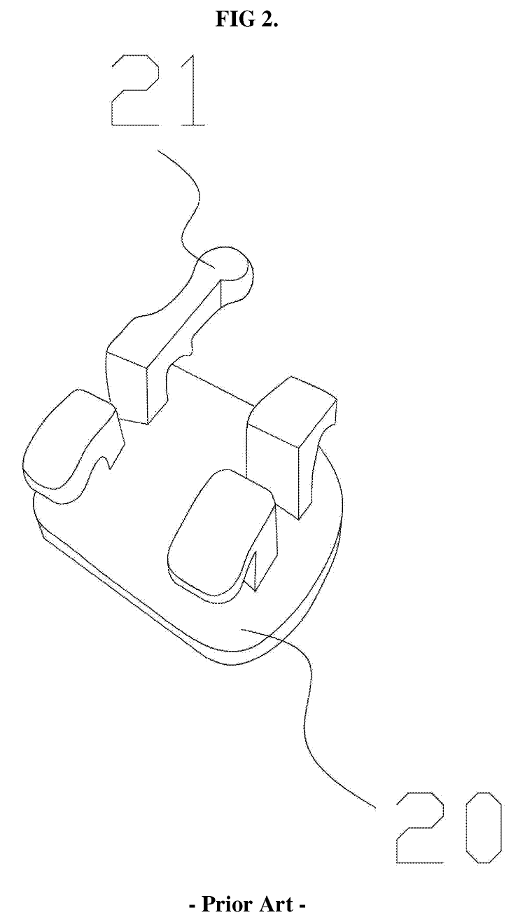

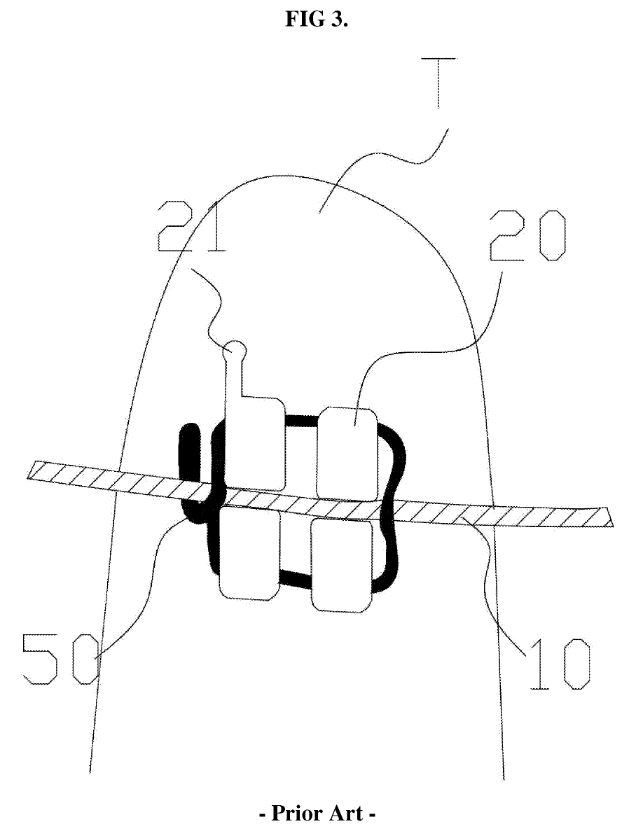

FIG. 2 is a drawing showing an example of a conventional metal orthodontic device, and FIG. 3 is a drawing showing the appearance of the use of such a conventional metal orthodontic device.

FIG. 2 is a drawing briefly showing the appearance of a conventional metal orthodontic device 20 used attached to a tooth, and this conventional metal orthodontic device 20 is used attached to individual teeth T and used to support orthodontic wires 10. More specifically, the conventional metal orthodontic device 20 is attached to the tooth T and the tie wire 50 is used to fix the orthodontic wire 10 and the conventional metal orthodontic device 20 together. Through this, the restoring force of the orthodontic wire 10 made of shape memory alloy etc. is transmitted to the tooth T to arrange the tooth T in the correct position, and in this process, if necessary, a rubber band hook 21 on the device can be used to thread a rubber band for transmitting additional force for adjusting the alignment of the jaw and teeth.

This conventional metal orthodontic device 20, compared to transparent correction devices such as Invisalign, operates more effectively for serious dental misalignment, requires less treatment time, and has lower cost advantages. However, to effectively perform tooth alignment and occlusal adjustment using the conventional metal orthodontic device 20, continuous observation and adjustment by a specialist is needed. The conventional metal orthodontic device 20 is not easily removed once attached to the tooth, and there are limitations in supporting the use of appropriate orthodontic wires 10 at each treatment stage. Also, the fact that the orthodontic wire 10 must be fixed one by one to the conventional metal orthodontic device 20 using tie wire 50 etc. was inconvenient from the practitioner's perspective, and furthermore there were also problems of food getting stuck in the mouth or the tongue getting injured due to the protruding rubber band hook 21 or tie wire 50 etc.

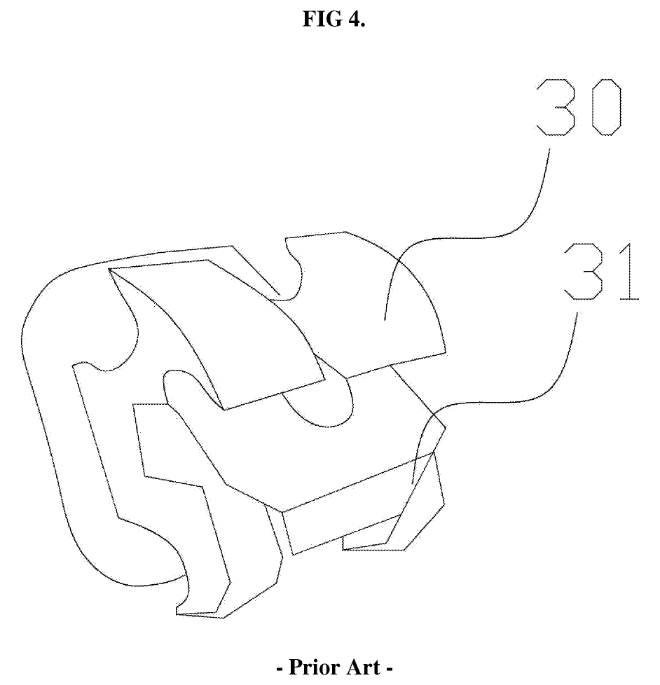

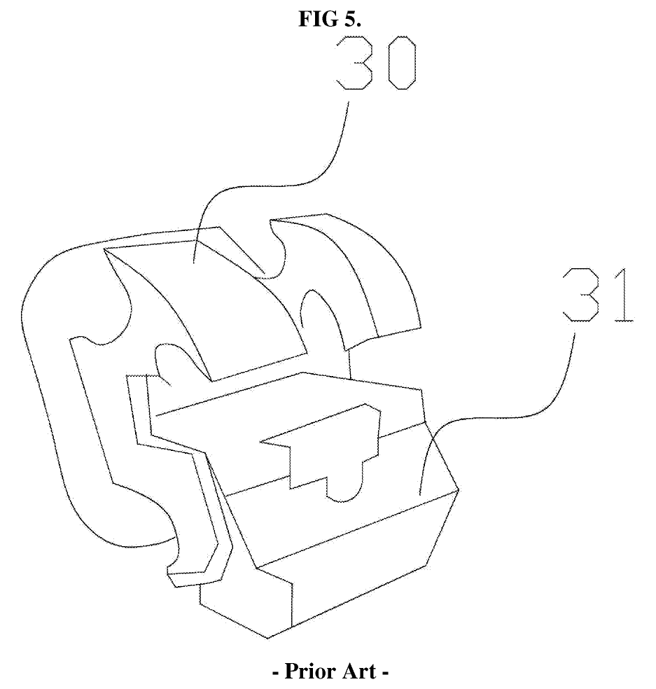

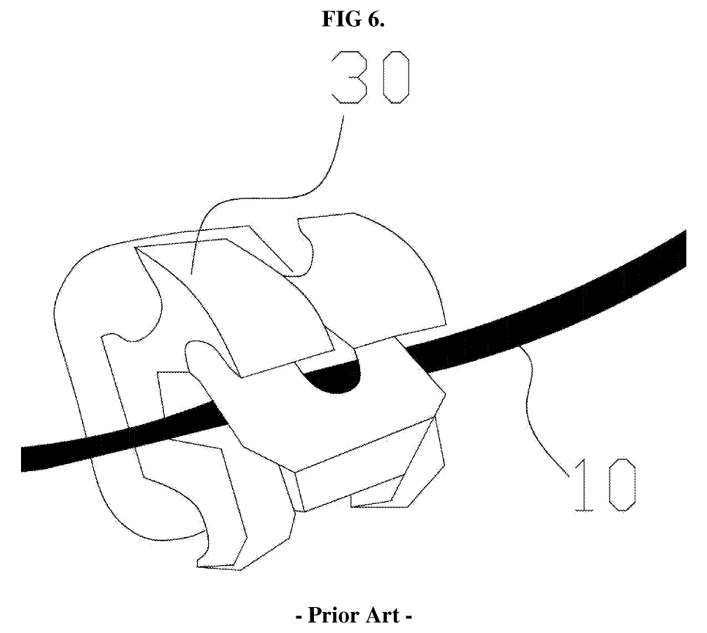

FIGS. 4 to 6 are drawings showing the appearance and method of use of a conventional self-ligating bracket, where FIG. 4 shows the appearance of a conventional self-ligating bracket with the cover closed, FIG. 5 shows the appearance of a conventional self-ligating bracket with the cover open, and FIG. 6 shows the appearance of the orthodontic wire being fixed using the conventional self-ligating bracket.

To address the inconvenience of fixing the orthodontic wire 10 one by one in the conventional metal orthodontic device 20 using tie wire 50 etc., a self-ligating bracket 30 has been developed. This conventional self-ligating bracket 30 has the advantage of increasing the convenience of practitioners etc. in that there is no need to fix the orthodontic wire 10 one by one using tie wire 30 etc. And the friction between the orthodontic wire 10 and the conventional self-ligating bracket 30 is also reduced compared to the conventional metal orthodontic device 20, which has the advantage of shortening treatment time. However, this conventional self-ligating bracket 30 is also generally used while attached to the tooth T, and as will be explained through the drawings below, the problem has arisen that it cannot optimally support the orthodontic wire 10 selected at each stage of orthodontic treatment. Also, there was also the problem that the cover 31 frequently broke down.

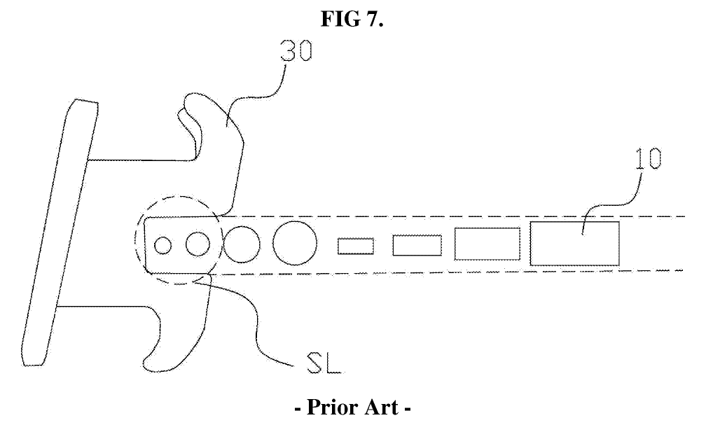

FIG. 7 is a drawing showing a comparison of orthodontic wires used compared to conventional self-ligating brackets etc.

In orthodontic treatment, an appropriate orthodontic wire 10 must be selected and used at each treatment stage. To gradually move the tooth T to the desired position, it is desirable to first use a thin and flexible orthodontic wire 10 to provide weak and continuous force, and to replace the orthodontic wire 10 with thicker and harder ones as treatment progresses. However, since it is difficult to remove or replace the device attached to the tooth T in treatment using the conventional metal orthodontic device 20 or the conventional self-ligating bracket 30, instead of using a slot SL with appropriate size for the orthodontic wire 10, the case where the bracket with the largest slot SL for the largest-diameter orthodontic wire 10 to be used in the future is used was general. For example, the conventional self-ligating bracket 30 also provides two slot SL specifications, but this only supports the practitioner etc. in selecting the slot SL specification at the approximate range of wire used at treatment start — it is not prepared to support the selection of appropriate wires selected by timing during the treatment process. To use an orthodontic wire 10 that goes beyond the range of the attached conventional self-ligating bracket 30, the old one had to be removed from the tooth and a new one re-attached.

When the size of the slot SL becomes mismatched with the orthodontic wire 10 in this way, the thin orthodontic wire 10 used initially cannot transmit force properly to the tooth, and to resolve this, suddenly using a large-diameter orthodontic wire 10 results in optimal corrective force not being applied and root resorption occurring.

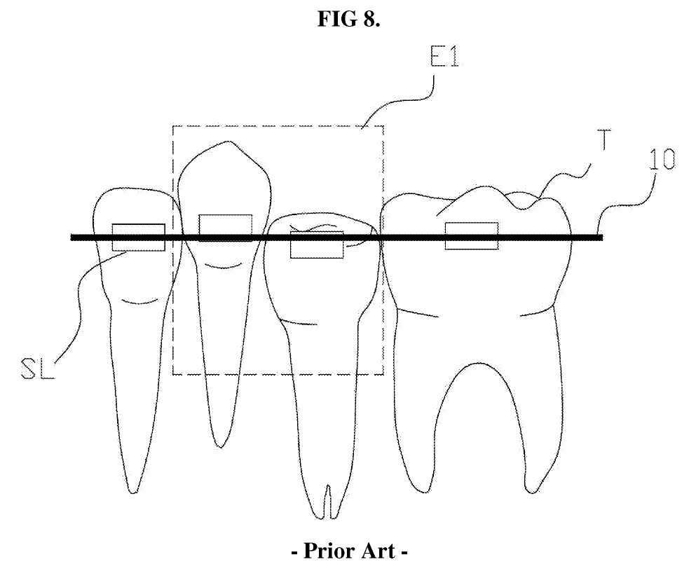

FIGS. 8 to 13 are drawings showing the limitations arising from the lack of an appropriately sized slot SL for the orthodontic wire diameter.

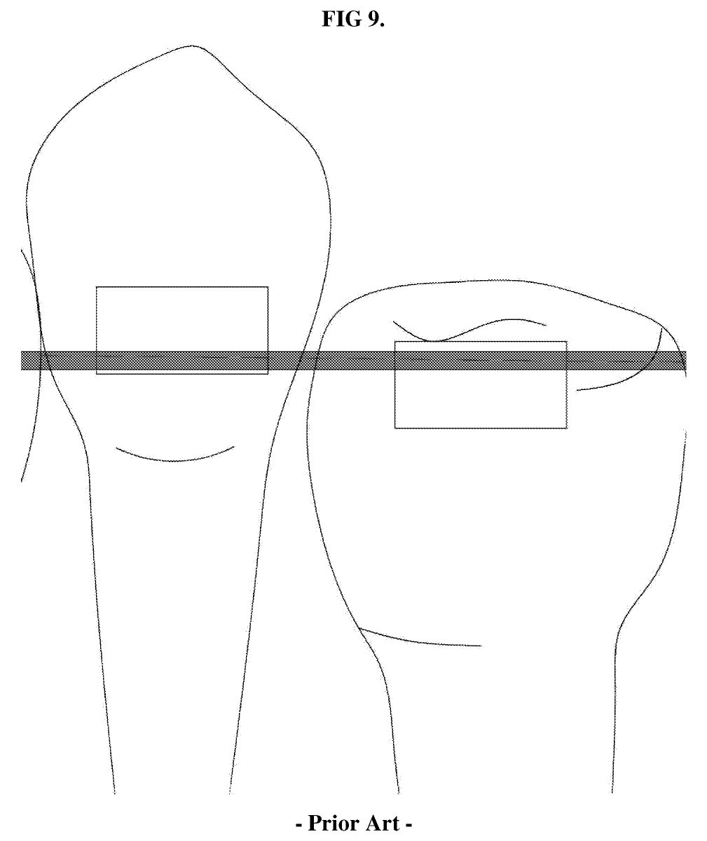

First, FIG. 8 is a drawing showing the appearance of using a thin-diameter orthodontic wire 10 to provide weak and continuous force at the initial stage of correction treatment — in the conventional metal orthodontic device 20 and conventional self-ligating bracket 30, the slot SL is designed for the largest orthodontic wire 10 diameter as described above, so as shown in FIG. 9, the gap between the orthodontic wire 10 and the slot SL is large. Therefore, the weak and continuous force that the orthodontic wire 10 provides cannot be properly transmitted to the tooth, and the goal of the initial orthodontic treatment stage cannot be achieved.

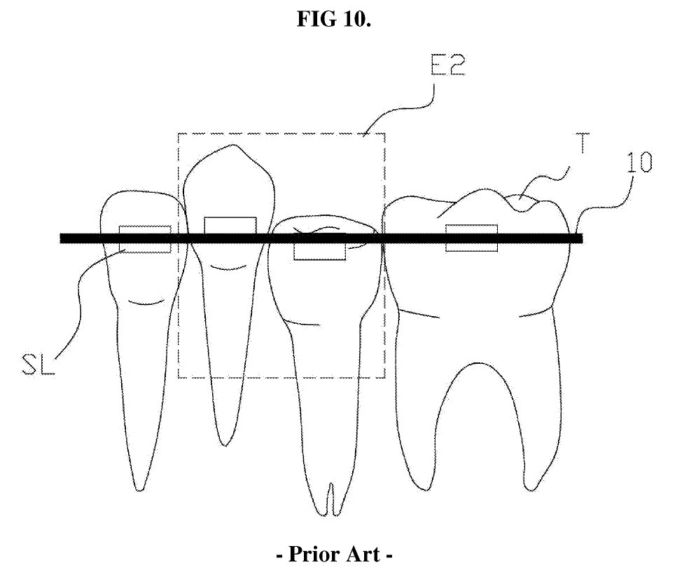

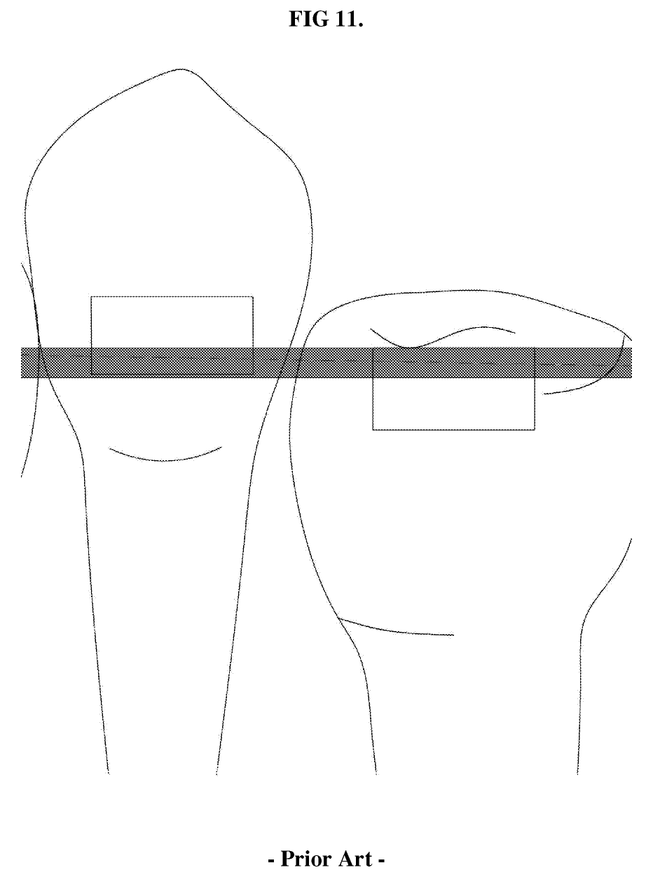

After going through this initial correction treatment process, as shown in FIG. 10, replacing with a thicker and harder diameter stainless steel (stainless) steel (steel) wire etc. results in the orthodontic wire 10 coming into contact with the slot SL and the height difference between teeth T being recognized, and the movement of the tooth T finally begins. However, as can be seen through FIG. 11, even this replaced orthodontic wire 10 does not contact the slot SL with the optimal gap, so it cannot provide the optimal corrective force targeted for the tooth T, and provides strong and intermittent force to the tooth T. In this case the speed of movement of the tooth T also slows down, and the side effect of root resorption also occurs.

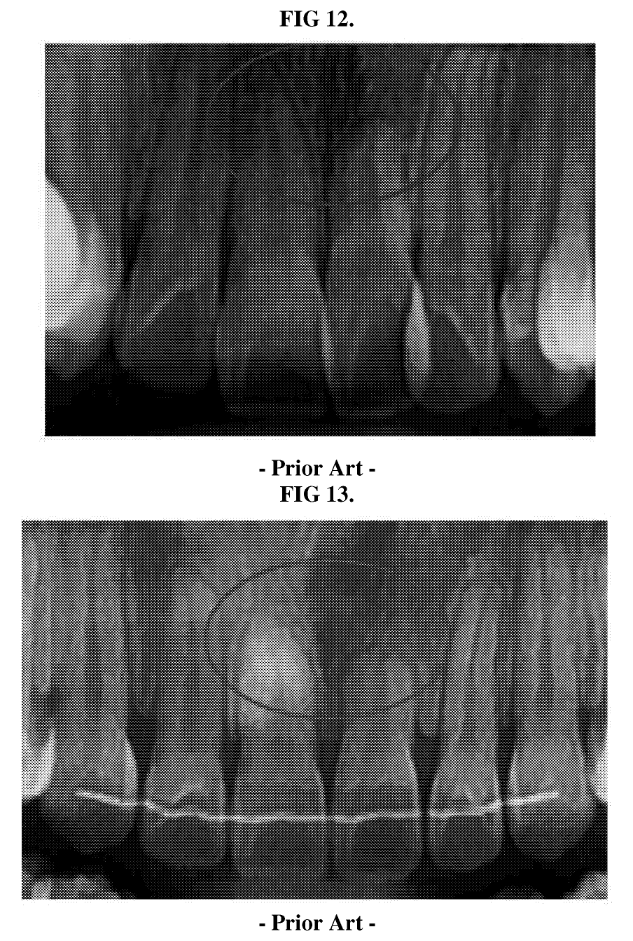

FIGS. 12 and 13 are drawings showing the appearance of root resorption occurring while performing orthodontic treatment.

Root resorption, a phenomenon in which the length or volume of a tooth root decreases, is known to occur frequently when strong and intermittent force is continuously applied to the tooth T. As noted above, since an appropriate slot SL corresponding to the diameter and size of the orthodontic wire 10 is not prepared, and weak and continuous force is not provided to the tooth T in the initial treatment stage, but then suddenly strong and intermittent force is provided to the tooth T through wire replacement, the likelihood of occurrence increases, and this root resorption can cause discomfort such as pain to the patient.

Therefore, It is necessary to provide and develop a new orthodontic bracket that can maintain an appropriate gap between the orthodontic wire 10 and the bracket to ensure optimal corrective force is provided to the tooth T, while shortening treatment time and minimizing side effects such as root resorption.

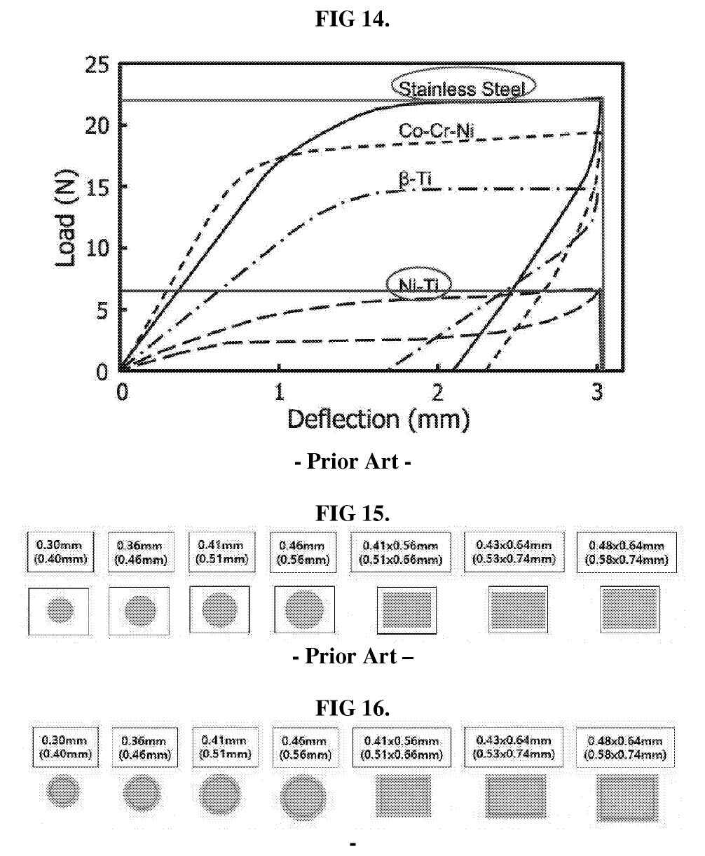

FIG. 14 is a graph showing the force that is applied according to the displacement, depending on the material of the orthodontic wire used.

As can be seen from the graph, when there is a 3 millimeter (mm) displacement change, nickel-titanium (Ni-Ti, Nickel-Titanium) wire exerts approximately 6 Newtons (N) of force, and this force is maintained up to a 1 millimeter displacement, but stainless steel wire shows that at a 3 millimeter displacement change a large force of 22 Newtons changes and as the displacement decreases the force drops sharply. Through this, it can be seen that nickel-titanium wire provides the ideal corrective force for orthodontic treatment — weak and continuous force.

However, as described above, conventional self-ligating brackets 30 and conventional metal orthodontic devices 20 are provided with a slot SL designed for the largest wire, so as can be seen from the graph, wires with high spring back such as nickel-titanium cannot properly transmit the force they provide to the tooth T, and many orthodontists have been performing orthodontic treatment using thicker stainless steel wire instead. However, when such thick stainless steel wire is used, intermittent and strong force is exerted, the speed of tooth T movement also progresses more slowly, and there is a high possibility of side effects such as root resorption.

Therefore, there is a need to develop a new orthodontic bracket that can actively support the use of nickel-titanium wire as an orthodontic wire 10, completing orthodontic treatment faster, and preventing side effects such as pain and root resorption. For reference, nickel-titanium wire has characteristics of low rigidity, high spring back, and high stored energy — low rigidity means it can be flexibly and easily manipulated, high spring back means the ability to return to its original shape after deformation or bending is excellent, and high stored energy means it stores a considerable amount of energy through deformation and releases it while returning to its original shape. In summary, nickel-titanium wire stores a considerable amount of energy even with small deformation, and releases this stored energy slowly while gradually returning to its original shape, thereby providing weak and continuous corrective force to the tooth.

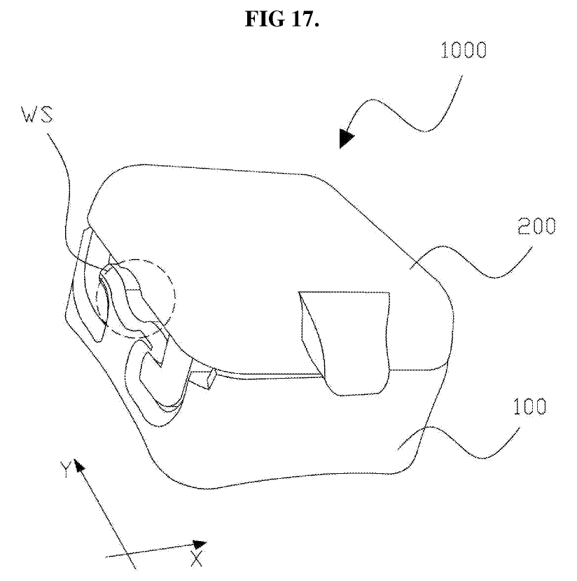

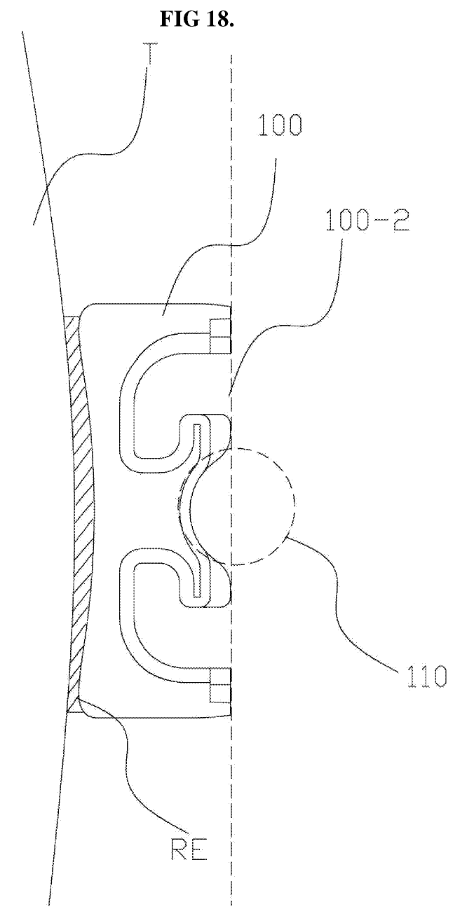

FIG. 15 is a drawing showing the appearance when various sizes and shapes of orthodontic wires are placed in the slots provided by conventional self-ligating brackets or conventional metal orthodontic devices, and FIG. 16 is a drawing showing the ideal slot shape and size to be provided according to the size and shape of the orthodontic wire.

As described above, conventional self-ligating brackets 30 and conventional metal orthodontic devices 20 can only provide a slot SL of one fixed size, and to change the size of the slot SL they must be removed from the tooth T and a different bracket attached. For this reason, in many cases only one bracket is used throughout the entire orthodontic treatment process, and in this case, when the gap between the slot SL and the orthodontic wire 10 is too large, the restoring force provided by the orthodontic wire 10 cannot be properly transmitted to the tooth. Conversely, when the gap is too small so that the friction between the orthodontic wire 10 and the slot SL is increased, the force exerted by the orthodontic wire 10 is canceled out by friction and appropriate corrective force cannot be provided to the tooth T.

Therefore, to ensure that appropriate corrective force is provided, as shown in FIG. 16, it is appropriate to have a gap of approximately 0.1 millimeters (mm) between the orthodontic wire 10 used and the slot SL. Since the present invention can provide slots SL corresponding to the various sizes and shapes of orthodontic wires 10 used, it can achieve the effect of ensuring that the appropriate corrective force required at each stage of orthodontic treatment is transmitted directly to the tooth T. Furthermore, when using nickel-titanium wire that provides continuously weak force as the primary wire, a single nickel-titanium wire provides corrective force over a wider range in orthodontic treatment, so the number of times the orthodontic wire 10 is replaced can also be reduced. Specifically, since the number of replacements that was approximately 9 times in general orthodontic treatment can be reduced to approximately 3 times, an effect of increased convenience for patients and/or orthodontists in orthodontic treatment can also be expected.

Based on the foregoing, the configuration and operation of the orthodontic bracket and method of using the same according to the present invention will be examined in detail one by one.

FIG. 17 is a drawing showing the overall appearance of the orthodontic bracket according to the present invention.

The orthodontic bracket 1000 according to the present invention comprises a base member 100 and a cap member 200. The corrective force provided by the orthodontic wire 10 is transmitted to the tooth T through a wire slot WS formed by coupling and connecting the cap member 200 onto the base member 100, which is directly attached to the surface of the tooth T. The cap member 200 coupled to the base member 100 may be replaced or changed with a different cap member during the course of orthodontic treatment, and through such replacement of the cap member, a wire slot WS suitable for the shape and diameter of various orthodontic wires 10 can be provided, thereby enabling the appropriate corrective force required at each stage of orthodontic treatment to be delivered to the tooth. Here, the base member 100 and the cap member 200 may be formed using resin, and specifically, white or transparent engineering plastic may be used so as not to be easily visible from the outside. For reference, the base member 100 and the cap member 200 are connected by means of a slide and/or snap fit method, which will be examined in more detail through the drawings below.

FIG. 18 is a drawing showing a side view of the base member constituting the orthodontic bracket according to the present invention.

The base member 100, which is attached and fixed to the tooth T using resin RE and serves as the foundation of the orthodontic bracket 1000 according to the present invention, may comprise a 1-1 surface 100-1 used for attachment to the tooth T and a 1-2 surface 100-2 in contact with the cap member 200. A first wire slot 110 that forms the wire slot WS through coupling with the cap member 200 may be formed on the 1-2 surface 100-2. The orthodontic bracket 1000 according to the present invention is used by sliding the cap member 200 onto the base member 100 from the lateral direction, the specific process of which will be described through the drawings below. For reference, the end of the lateral side of the base member 100 where the cap member 200 enters may be slightly tapered to allow the cap member 200 to slide in easily, and the first wire slot may have a curved surface formed in the width direction Y.

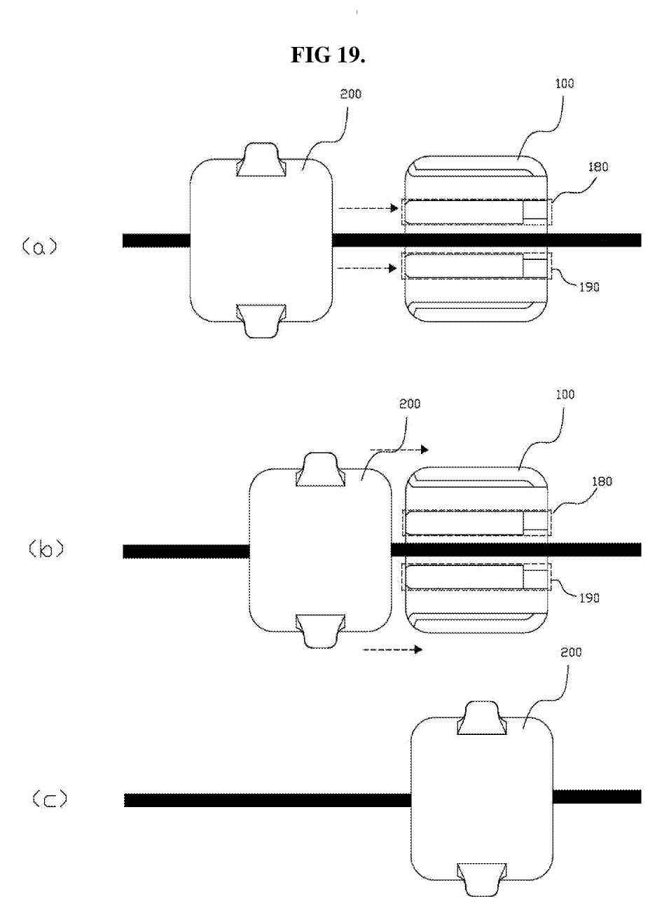

FIG. 19 is a drawing showing the method of using the orthodontic bracket according to the present invention in outline.

With the base member 100 fixed at the desired position on the surface of the tooth T, the practitioner such as an orthodontist places an orthodontic wire 10 appropriate for the relevant orthodontic stage into the first wire slot 110 of the base member 100, and then slides the cap member 200 toward the base member 100 to connect and couple the cap member 200 to the base member 100. More specifically, the cap member 200 is connected to the base member 100 through the steps (a) to (c) shown in the drawing: the 2-1 cap connector 220 and 2-2 cap connector 230 of the cap member 200 slide along the 1-1 base connector 180 and 1-2 base connector 190 of the base member 100, and a snap fit connection is finally made, completing the installation of the cap member 200. That is, the base member 100 and cap member 200 first form a slide connection, followed by an additional snap fit connection. The detailed configuration of the base member 100 and cap member 200 for this purpose will be examined through the description below.

In this way, the present invention has the effect of supporting the easy use of an appropriate orthodontic wire 10 throughout the entire orthodontic process, since an appropriate cap member 200 can be selected and used according to the shape and thickness of the orthodontic wire 10 being used. Furthermore, since the support of the orthodontic wire 10 is completed simply by sliding the cap member 200 into position, there is also the effect of increasing the convenience of the practitioner and/or patient during the overall treatment process.

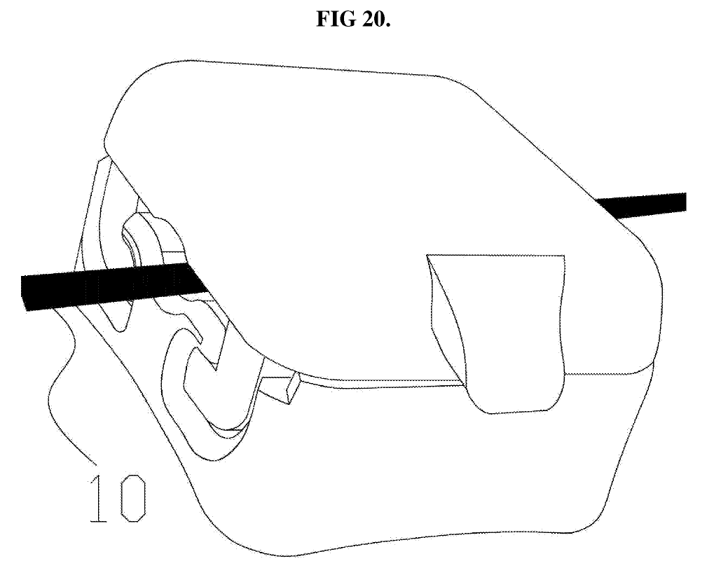

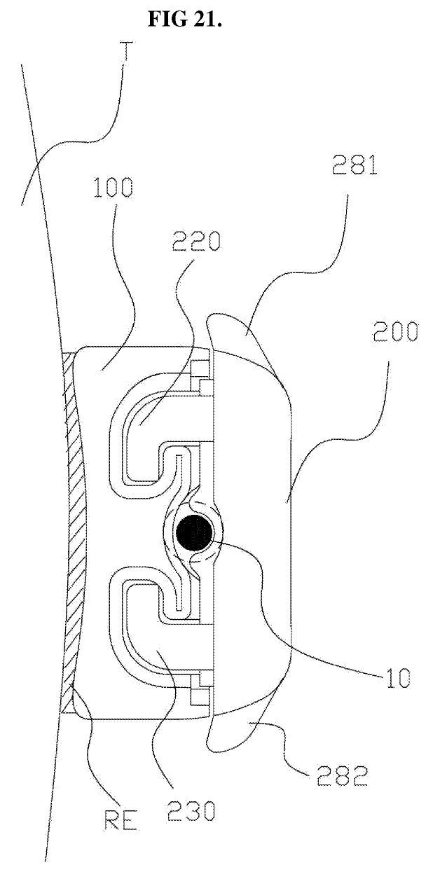

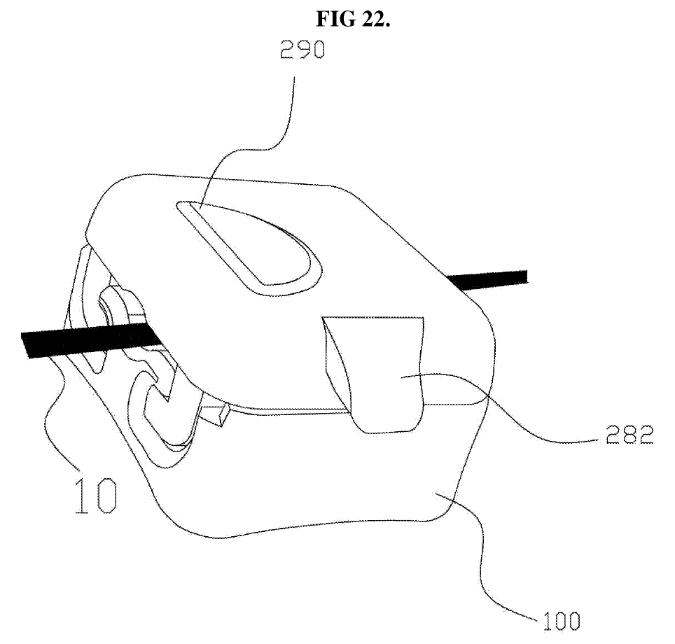

FIG. 20 is a drawing showing the orthodontic bracket according to the present invention with the orthodontic wire placed and supported between the base member and cap member, and FIG. 21 is a drawing showing the orthodontic bracket of FIG. 20 viewed from the side.

Once the connection between the base member 100 and cap member 200 is completed, the present invention performs orthodontic work to move the tooth T using the orthodontic force provided through the orthodontic wire 10 disposed between the base member 100 and cap member 200. The orthodontic wire 10 is held through the wire slot WS formed by the combination of the cap member 200 and base member 100. The second wire slot 210 of the cap member 200 can be formed with an appropriate gap corresponding to the size and shape of the orthodontic wire 10 used, and when the orthodontic wire is replaced, a cap member with a second wire slot having the corresponding shape and size can be replaced and used.

Through this, the present invention has the effect of being able to support efficient use of appropriate orthodontic wires throughout the entire orthodontic process.

FIG. 22 is a drawing showing the cap member bearing an identification mark combined with the base member of the present invention.

As described above, the present invention achieves connection and coupling of the two members through slide connection and snap fit connection that occur as the cap member 200 is slid relative to the base member 100. In order to assist orthodontists, dentists, and other practitioners in easily identifying which direction the cap member 200 must be moved, and what shape the second wire slot 210 formed in the cap member 200 is, the 2-2 surface 200-2 of the cap member 200 may be formed with an identification mark 290 in an embossed or engraved form. For example, if the identification mark 290 is displayed in a semicircular shape, this may indicate that the cross-sectional shape of the second wire slot 210 of the cap member 200 is semicircular, and the direction in which the curved portion of the semicircle faces may indicate the direction in which the cap member 200 must be slid to connect it with the base member 100. Through this, users of the present invention, such as orthodontists, can conveniently, even with a small cap member 200, confirm the shape of the second wire slot 210 and the slide movement direction and connect it to the base member 100. That is, errors and mistakes in selecting and connecting the cap member 200 can be prevented in advance.

Up to this point, the overall appearance of the orthodontic bracket 1000 according to the present invention and a brief connection and coupling method have been confirmed. Hereinafter, the detailed configuration of the base member 100 constituting the orthodontic bracket according to the present invention will be examined in more detail.

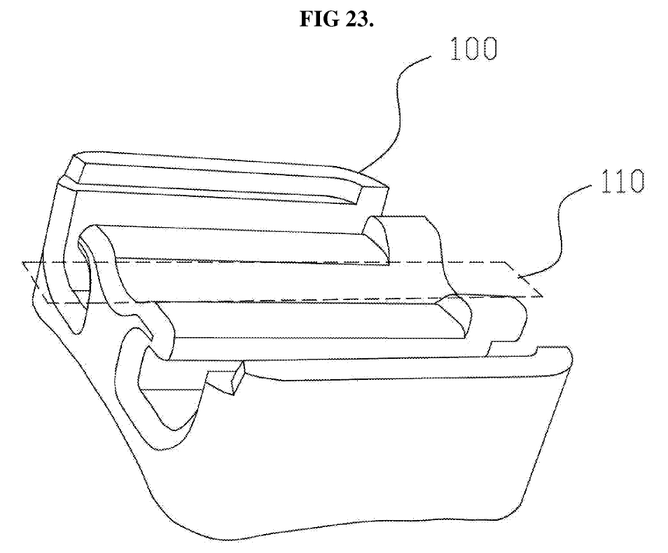

FIG. 23 is a drawing showing the overall appearance of the base member constituting the present invention.

The base member 100, which is attached to the tooth T and serves as the foundation role for the cap member 200 to be coupled thereto, may comprise a 1-1 surface 100-1 used for attachment to the tooth T using bonding agents such as resin RE, and a 1-2 surface 100-2 where contact with the cap member 200 occurs. On this 1-2 surface 100-2, a slot protrusion 211 formed along the length direction X of the second wire slot 210 of the cap member 200 and a first wire slot 110 performing the role of accommodating the orthodontic wire 10 may be formed. The first wire slot 110 of the base member 100, together with the second wire slot 210 of various sizes and shapes formed in the cap member 200, supports the orthodontic wire 10 while maintaining an appropriate gap, thereby performing the role of enabling the orthodontic force provided by the orthodontic wire 10 to be effectively transmitted to the tooth T. This will be examined in more detail through the drawings below. For reference, the first wire slot 110 of the base member 100 and the second wire slot 210 may be formed with the same length, and may be formed to accommodate 20 to 50 percent of the cross-sectional area of the orthodontic wire 10 to be placed therein. Also, the cross-section of the first wire slot 110 may be formed in a semicircular shape, with a curved surface formed in the width direction Y, and the curvature value of this curved surface is smaller than the curvature value of the curved surface of the second wire slot 210 of the cap member 200, and the depth value of the first wire slot 110 may be formed to be larger than the diameter value of a round cross-section orthodontic wire.

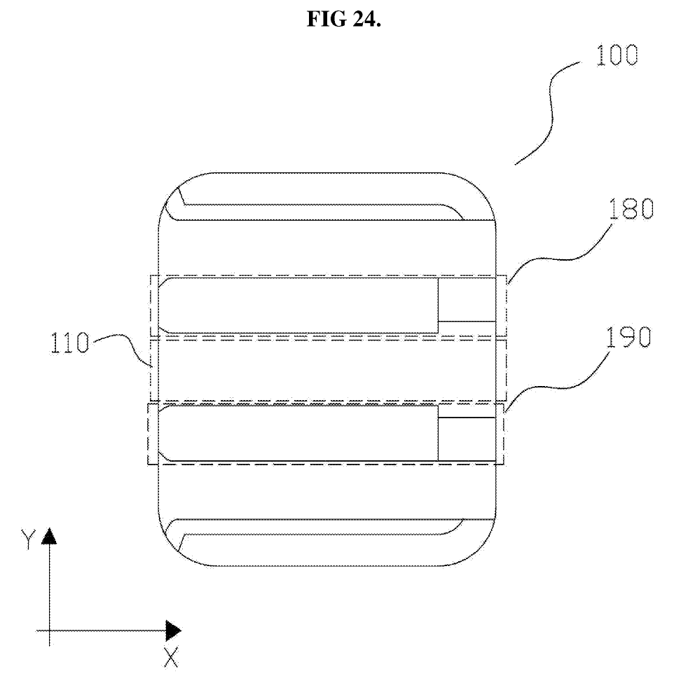

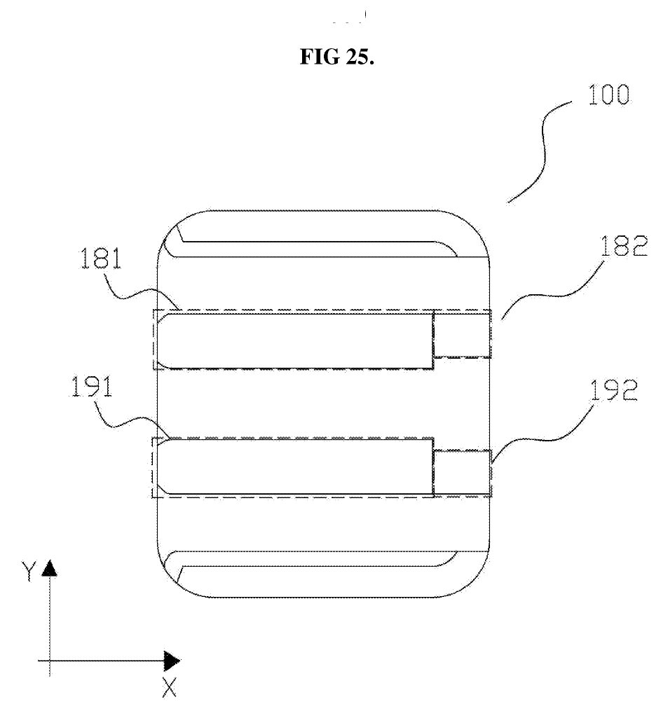

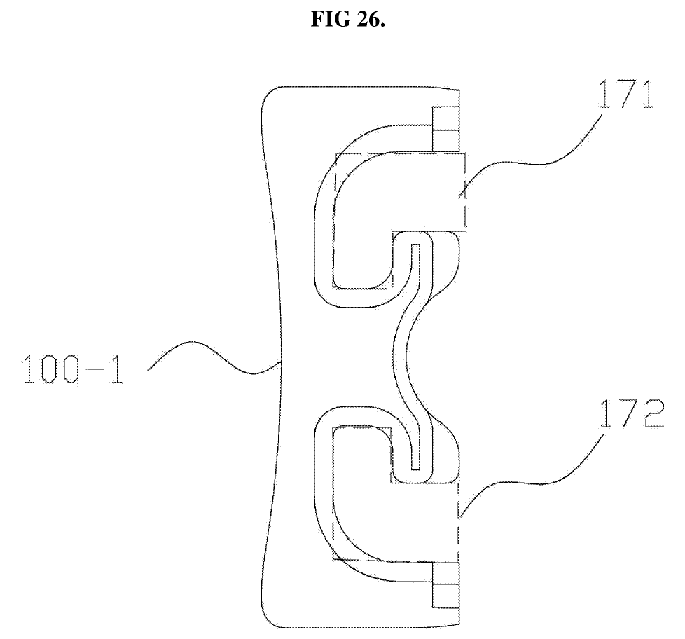

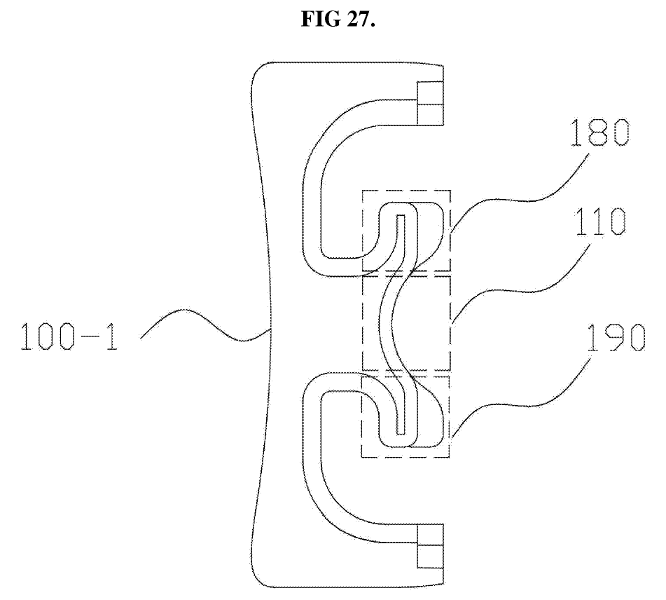

FIGS. 24 and 25 are drawings showing the 1-2 surface of the base member constituting the present invention.

On both sides of the first wire slot 110 of the base member 100, a 1-1 base connector 180 and a 1-2 base connector 190 may be formed along the length direction X, and these 1-1 base connector 180 and 1-2 base connector 190 can perform the role of supporting the slide and snap fit connection with the cap member 200. Specifically, the 1-1 base connector 180 may comprise a 1-1 rail portion 181, which is a region supporting slide-type connection with the cap member 200, and a 1-1 groove portion 182, which is a region supporting snap fit-type connection with the cap member 200. The 1-2 base connector 190 may comprise a 1-2 rail portion 191, which is a region supporting slide-type connection with the cap member 200, and a 1-2 groove portion 192, which is a region supporting snap fit-type connection with the cap member 200. For reference, the lengths of the 1-1 base connector 180 and 1-2 base connector 190 formed in this way may be formed the same as the length of the first wire slot 110, and the width value of the first wire slot 110 may be larger than the width value of the second wire slot 210 of the cap member 200.

FIGS. 26 and 27 are drawings showing the appearance of the base member from the direction in which the cap member slides in.

The cap member 200 constituting the present invention slides along the length direction represented as 'X' in the drawing to connect to the base member 100, and FIGS. 26 and 27 are drawings showing the left side view of the base member 100 where the cap member 200 slides in.

Through the drawings, it can be confirmed that the first wire slot 110 is formed in the center along the width direction represented as 'Y' in the drawing of the base member 100, and that the 1-1 base connector 180 and 1-2 base connector 190 for supporting the slide and snap fit connection with the cap member 200 are formed on both sides of the first wire slot 110. More specifically, based on the width direction, the ends of the structures for connection of the 1-1 base connector 180 and 1-2 base connector 190 may be formed in a hook shape facing outward from the base member 100. That is, when viewed from the side, the cross-sections of the 1-1 base connector 180 and 1-2 base connector 190 may be formed in a hook shape. In other words, since the 2-1 cap connector 220 and 2-2 cap connector 230 of the cap member 200 enter and move into the base member 100 like riding on a rail, the ends of the structures for slide connection of the 1-1 base connector 180 and 1-2 base connector 190 can be expressed as being formed in a hook-shaped rail shape facing outward of the base member based on the width direction. For reference, the region where the 2-1 cap connector 220 of the cap member 200 is inserted can be referred to as the 1-1 space 171, and the region where the 2-2 cap connector 230 is inserted can be referred to as the 1-2 space 172. This space can be formed in an undercut shape like '⌐', 'L' below the 1-1 base connector 180 and 1-2 base connector 190 for stable connection and coupling between the cap member 200 and base member 100. Also, the 1-1 space 171 and 1-2 space 172 can also be utilized as spaces where the orthodontic auxiliary wire 40 providing additional corrective force needed for orthodontic treatment is seated and fixed.

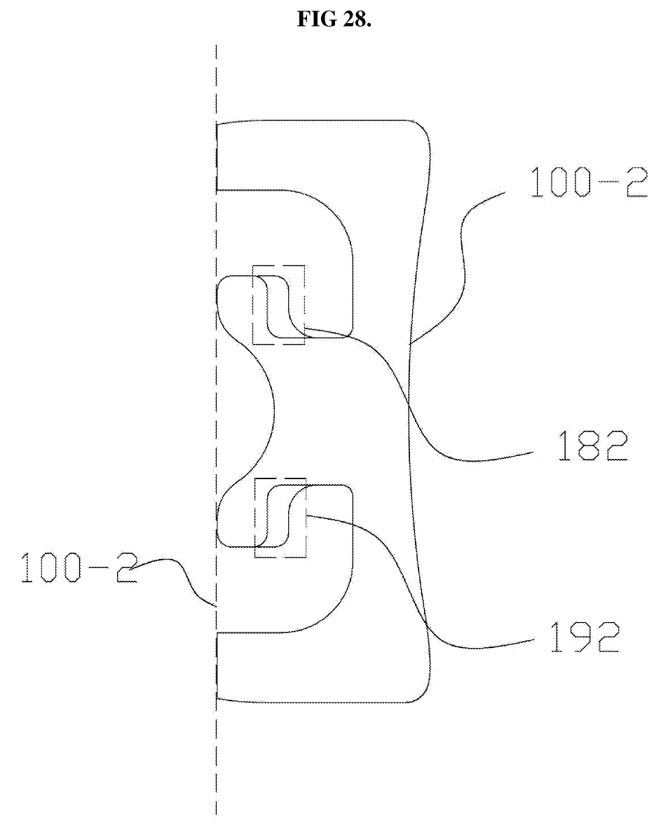

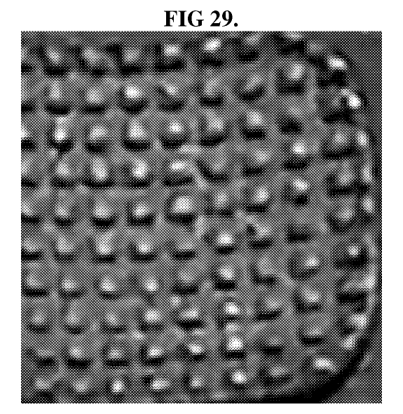

FIG. 28 is a drawing showing the appearance of the base member from the opposite side from the direction in which the cap member slides in.

For snap fit connection with the cap member 200, a 1-1 groove portion 182 and a 1-2 groove portion 192 may each be formed in the 1-1 base connector 180 and 1-2 base connector 190 of the base member 100, and these may be formed at the opposite side of the 1-1 base connector 180 and 1-2 base connector 190 from where the 2-1 cap connector 220 of the cap member 200 slides in. More specifically, by forming the ends of the 1-1 base connector 180 and 1-2 base connector 190 to be slightly raised, an undercut can be formed below them to create the 1-1 groove portion 182 and 1-2 groove portion 192, and the 2-1 latch 222 and 2-2 latch 232 of the cap member 200 are caught here to achieve snap fit connection. For reference, the term 'end' used in describing the shapes of the 1-1 base connector 180 and 1-2 base connector 190 refers to the tip of the part extending from and formed on the body, and can be understood as being used to include the meaning of the direction the tip faces.

In this way, since the present invention proceeds with double connection and coupling of the base member 100 and cap member 200 through slide and snap fit methods, it prevents the cap member 200 from unintentionally detaching or separating from the base member 100, enabling stable coupling to be maintained throughout the entire orthodontic treatment process.

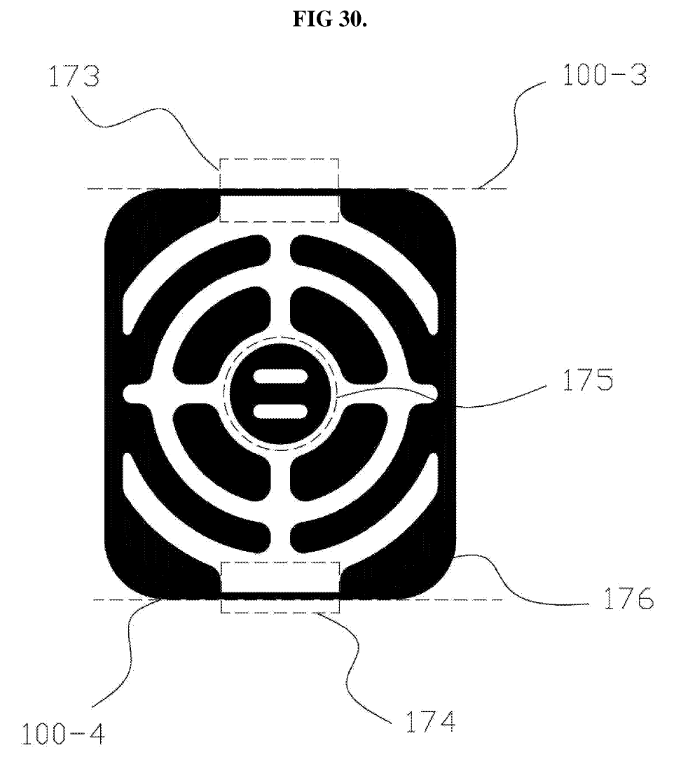

FIG. 29 is a drawing showing the surface irregularities (fine protrusions and recesses) formed on the 1-1 surface of the base member constituting the orthodontic bracket according to the present invention, and FIG. 30 is a drawing showing the pattern formed on the 1-1 surface of the base member constituting the orthodontic bracket according to the present invention.

On the 1-1 surface 100-1 of the base member 100 constituting the present invention, a surface irregularity for widening the bonding contact area with bonding agent RE such as resin may be formed to enable more firm attachment to the tooth T surface, and FIG. 29 is a drawing showing one example of such a groove formed for this purpose. Furthermore, as shown in FIG. 30, a pattern for widening the bonding contact area with bonding agent RE such as resin may also be formed on the 1-1 surface 100-1 of the base member 100. Such a pattern may include a wall pattern 176 to prevent the bonding agent from leaking to the outside, particularly to prevent it from leaking to the left and right sides where the cap member 200 slides in. This wall pattern 176 may be formed entirely along the edge of the 1-1 surface 100-1, but in some areas it may not be formed, and a 3rd open portion 173 and 4th open portion 174 may each be formed at the upper portion, which is the portion toward the 1-3 surface 100-3 of the base member 100, and the lower portion, which is the portion toward the 1-4 surface 100-4, so that the bonding agent can flow out to the outside. By forming such a structured pattern on the 1-1 surface 100-1 of the base member 100, the present invention prevents the bonding agent embedded in the 1-1 surface 100-1 from flowing into the space where slide and snap fit coupling occurs, and allows excess bonding agent to move upward and downward toward the 1-3 surface 100-3 and 1-4 surface 100-4, so that it can be used for attachment of the base member 100 to the tooth T surface. For reference, the 1-1 surface 100-1 of the base member 100 may be formed slightly concave in the center to be well-attached to the convex tooth T surface, and an identification mark 175 that can be easily confirmed by practitioners such as orthodontists and dentists to identify the type of the base member being used may be formed in an engraved or embossed manner. However, although it is preferable to form the identification mark 175 in an embossed or engraved manner, it is not limited to the identification mark 175 necessarily being formed in an embossed or engraved manner.

Hereinafter, each component of the cap member 200, which is another component constituting the orthodontic bracket 1000 according to the present invention, will be examined in detail one by one.

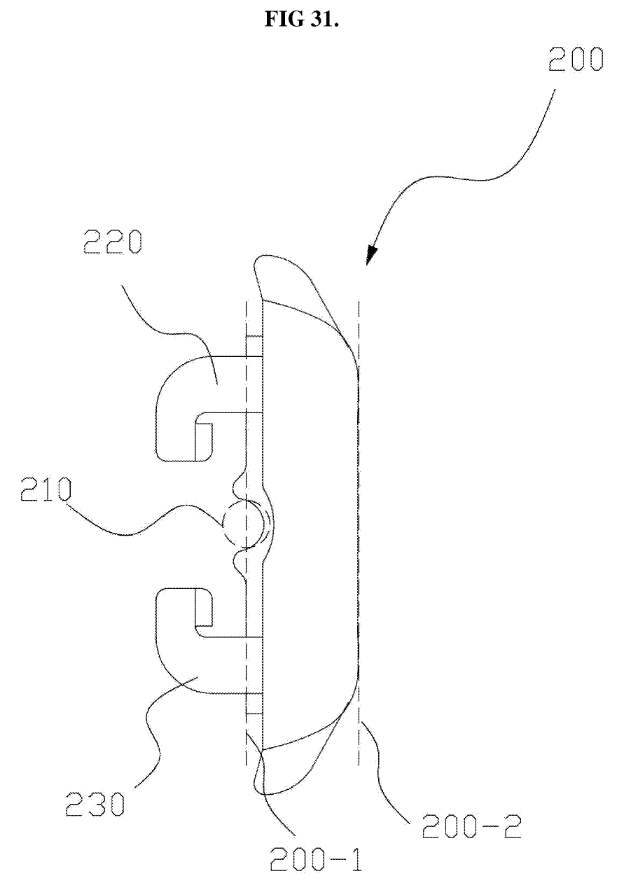

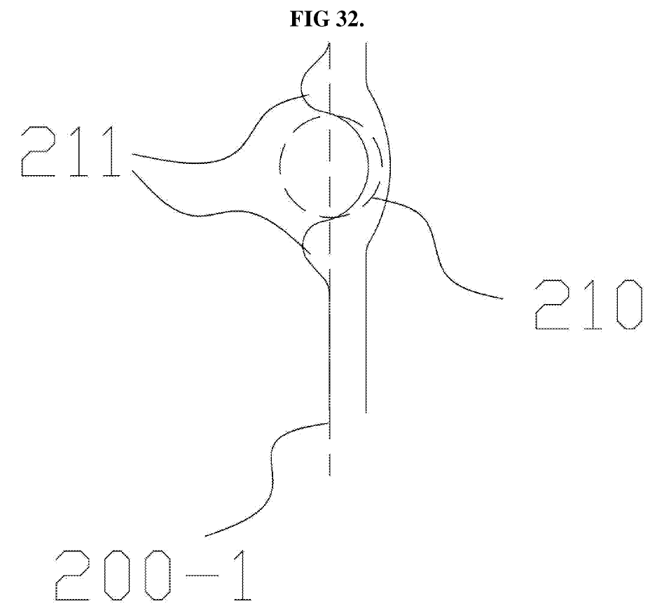

FIG. 31 is a drawing showing a side view of the cap member constituting the present invention.

The corresponding drawing shows the left side view of the cap member 200, and the cap member 200 constituting the orthodontic bracket 1000 according to the present invention may be formed to comprise the 2-1 surface 200-1 in contact with the base member 100 and the second wire slot 210 formed on the 2-1 surface 200-1. And, additionally, a 2-1 cap connector 220 and 2-2 cap connector 230 for supporting the slide and snap fit connection with the base member 100 on both sides of the second wire slot 210 may further be included. Specifically, the end of the structure for connection of the 2-1 cap connector 220 for connection with the 1-1 base connector 180 of the base member 100 is formed in a hook shape facing the inside, inner side of the cap member 200 based on the width direction, and the same applies to the 2-2 cap connector 230. In other words, the 2-1 cap connector 220 may be formed as a hook-shaped rail whose cross-section is in the shape of '⌐' or 'L' facing the interior and center of the cap member 200 for the end of the structure for slide connection based on the width direction, and the 2-2 cap connector 230 may be formed the same. Here, 'inside' and 'inner side' of the cap member 200 means the direction toward the center of the cap member 200, and 'end' refers to the tip of the part that extends and is formed from the body, and can be understood to mean the direction the tip faces. For reference, the surface opposite to the 2-1 surface 200-1 in contact with the base member 100 may be referred to as the 2-2 surface 200-2, and an identification mark 290 that collectively indicates the slide insertion direction and the shape of the second wire slot 210 described above may be formed here in an embossed or engraved manner.

FIG. 32 is an enlarged drawing showing the second wire slot portion of the cap member constituting the present invention.

A second wire slot 210 for supporting the orthodontic wire 10 and performing the role of transmitting the orthodontic force provided by this orthodontic wire 10 to the tooth T may be formed on the 2-1 surface 200-1 of the cap member 200, and the slot protrusion 211 may be formed along the length direction on both sides of the second wire slot 210. The second wire slot 210 can be formed in various shapes according to the shape and gauge of the orthodontic wire 10 it supports; in the drawing, the second wire slot 210 formed in a semicircular shape is shown. Here, the slot protrusion 211 plays an important role in the process of supporting the orthodontic wire 10 and transmitting the orthodontic force provided by the orthodontic wire 10 to the tooth T; specifically, it performs the role of ensuring the orthodontic wire 10 is supported while maintaining an appropriate gap without detaching, through the force transmitted as the base member 100 and cap member 200 are coupled. Therefore, even though the second wire slot 210 is merely semicircular in shape, the orthodontic wire 10 can be stably supported through the assistance of the slot protrusion 211 and the first wire slot 110. For reference, the curvature value of the curved surface of the second wire slot 210 may be larger than the curvature value of the curved surface of the first wire slot 110 of the base member 100.

In this way, since the present invention allows selection and use of a cap with an appropriate second wire slot 210 according to the shape and gauge of the orthodontic wire 10 used, the effect of enabling the restoring force of the orthodontic wire to be effectively transmitted to the teeth and periodontal tissues can be achieved.

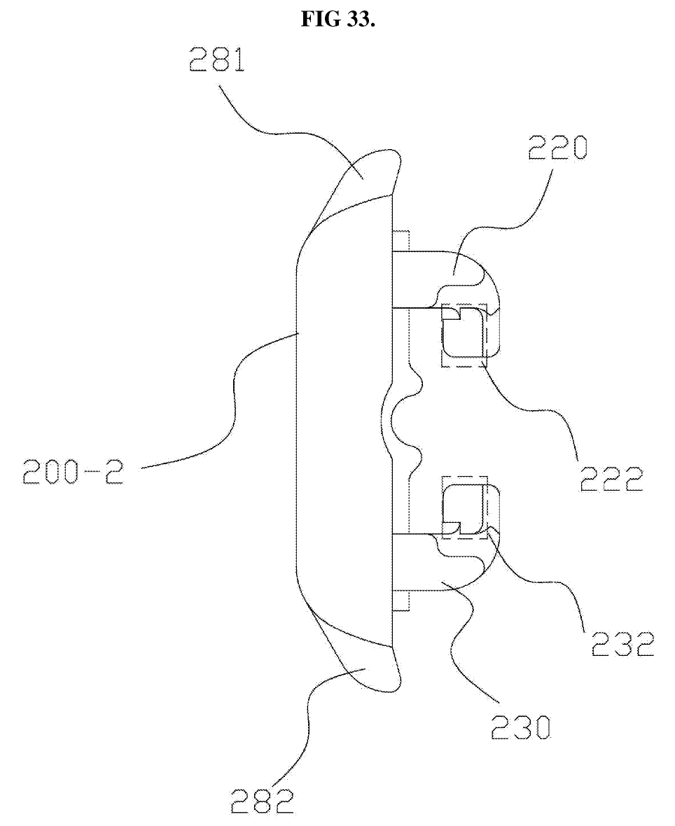

FIG. 33 is a drawing showing, in the cap member constituting the present invention, a side view of the portion that slides into the base member.

FIG. 33 is a drawing showing the right side view of the cap member 200, and when combined with the base member 100, this portion makes contact with the base member 100 first. In the 2-1 cap connector 220 of the cap member 200, a 2-1 latch 222 for snap fit connection may be formed at the portion where slide insertion into the base member 100 begins, and similarly, a 2-2 latch 232 for snap fit connection may also be formed at the portion where slide insertion into the base member 100 begins in the 2-2 cap connector 230. This 2-1 latch 222 is caught on the 1-1 groove portion 182 formed in an undercut structure in the 1-1 base connector 180 of the base member 100 to achieve snap fit connection, and the same applies to the 2-2 latch 232. More specifically, since the cap member 200 is manufactured with elastic resin, when the cap member 200 starts to slide into the base member 100, the 2-1 latch 222 of the cap member 200 moves slightly downward due to the 1-1 base connector 180 of the base member 100, and while continuing to slide, when it meets the 1-1 groove portion 182 of the 1-1 base connector 180, the 2-1 latch 222 moves upward and enters the groove, thereby achieving snap fit connection. And this process can occur equally on the side of the 2-2 latch 232 of the cap member 200. Through this structure, the orthodontic bracket 1000 according to the present invention can effectively support stable connection and coupling between the base member 100 and cap member 200. For reference, if necessary, the 2-1 latch 222 and 2-2 latch 232 may not be formed, and the corresponding 1-1 groove portion 182 and 1-2 groove portion 192 may also not be formed, in which case the connection between the base member 100 and cap member 200 can be made by slide connection. Also, if necessary, the 2-1 rail portion 221 and 2-2 rail portion 231 may not be provided, and the corresponding 1-1 rail portion 181 and 1-2 rail portion 191 may also not be formed, in which case the connection between the base member 100 and cap member 200 can be made by snap fit connection.

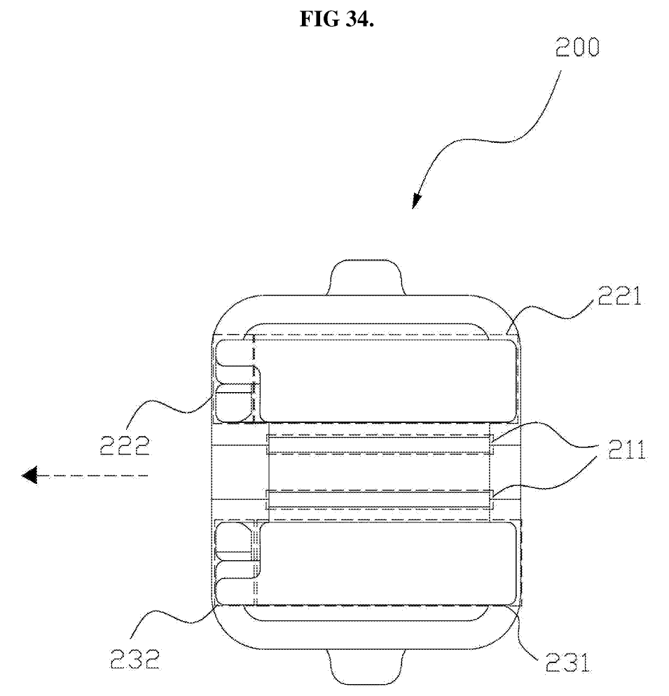

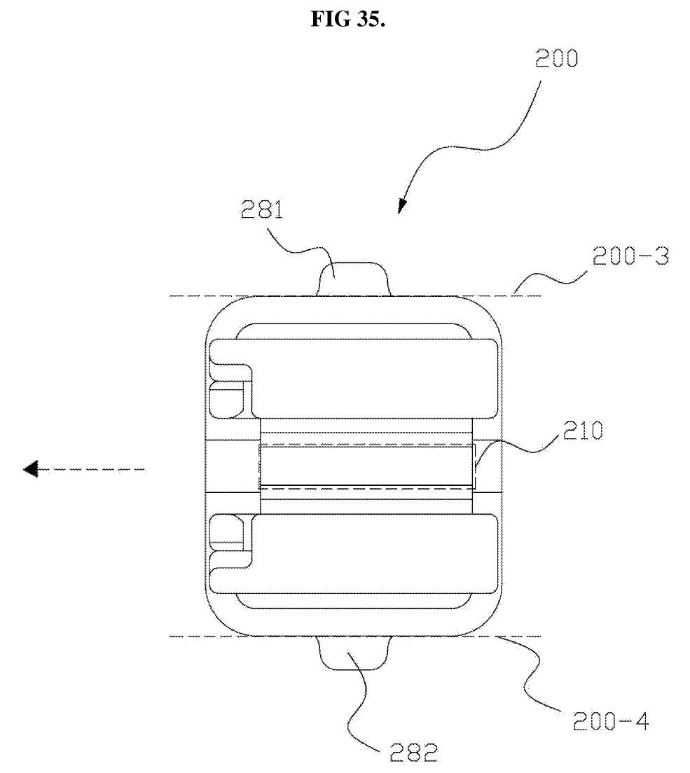

FIGS. 34 and 35 are drawings showing the 2-1 surface of the cap member in contact with the base member constituting the present invention.

In the center and middle of the cap member 200 constituting the present invention, a second wire slot 210 may be formed along the length direction, and a slot protrusion 211 for supporting the orthodontic wire 10 may be formed on both sides thereof. Here, the lengths of the second wire slot 210 and the slot protrusion 211 may be formed the same. For reference, in the drawing, the second wire slot 210 is formed smaller than the length of the cap member 200, but this is not limiting, and if necessary, it may be formed the same as the length of the cap member 200, and the length of the second wire slot 210 and the first wire slot 110 may also be formed the same.

On both sides of the second wire slot 210 and slot protrusion 211, a 2-1 cap connector 220 and 2-2 cap connector 230 used for connection and coupling with the base member 100 may be formed, and the 2-1 cap connector 220 may be formed comprising a 2-1 rail portion 221 and a 2-1 latch 222. And the 2-2 cap connector 230 may be formed comprising a 2-2 rail portion 231 and a 2-2 latch 232. Looking at the roles of each component in more detail, the 2-1 rail portion 221 can perform the role of connecting in a slide manner with the 1-1 rail portion 181 of the base member 100, and the 2-1 latch 222 can perform the role of connecting in a snap fit manner with the 1-1 groove portion 182 of the base member 100. And equally, the 2-2 rail portion 231 can perform the role of connecting in a slide manner with the 1-2 rail portion 191 of the base member 100, and the 2-2 latch 232 can perform the role of connecting in a snap fit manner with the 1-2 groove portion 192 of the base member 100. For reference, in the drawing, the length of the second wire slot 210 is shown shorter than the 2-1 cap connector 220 or 2-2 cap connector 230, but if necessary, the lengths may be formed the same as each other. Also, in the drawing, the dashed arrow indicates the direction in which the cap member 200 must move to connect with the base member 100.

On the 2-3 surface 200-3 of the cap member 200 constituting the orthodontic bracket 1000 according to the present invention, a 2-1 protrusion 281 may be formed, and on the other side surface of the 2-3 surface 200-3, which is the 2-4 surface 200-4, a 2-2 protrusion 282 may be formed. These 2-1 protrusion 281 and 2-2 protrusion 282 can be used for threading rubber bands such as power chains used to provide additional corrective force during orthodontic treatment. And for ease of threading power chains, the sizes of the 2-1 protrusion 281 and 2-2 protrusion 282 may be formed slightly smaller than the diameter of the holes formed in the power chain, and the entry and end of the 2-1 protrusion 281 and 2-2 protrusion 282 may be formed slightly narrower inside than the outer side. For reference, these 2-1 protrusion 281 and 2-2 protrusion 282 have a considerably small and smooth shape compared to the rubber band hook 21 of the conventional metal orthodontic device 20. For reference, these 2-1 protrusion 281 and 2-2 protrusion 282 have a considerably smaller and smoother shape compared to the rubber band hook 21 of the conventional metal orthodontic device 20, and can prevent damage to the oral mucosa or lodging of foreign matter such as food caused by such protrusions.

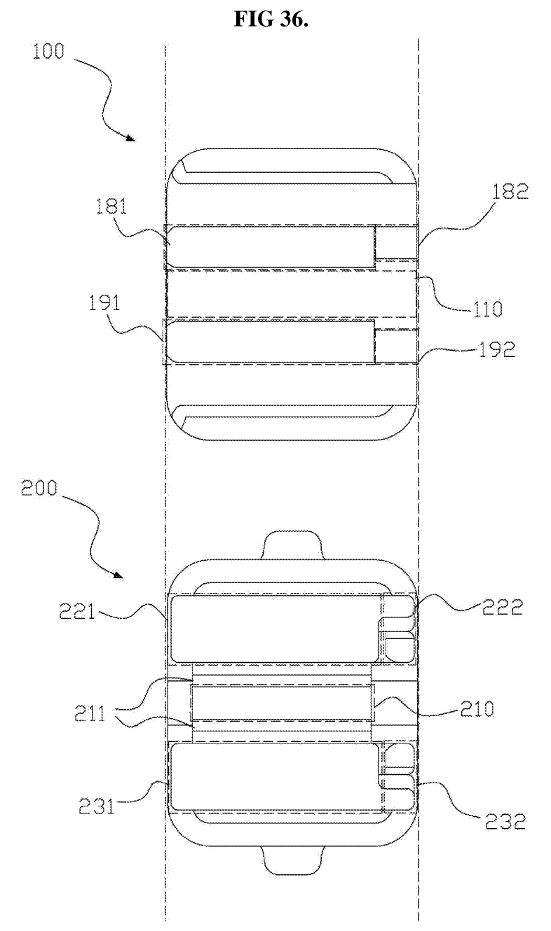

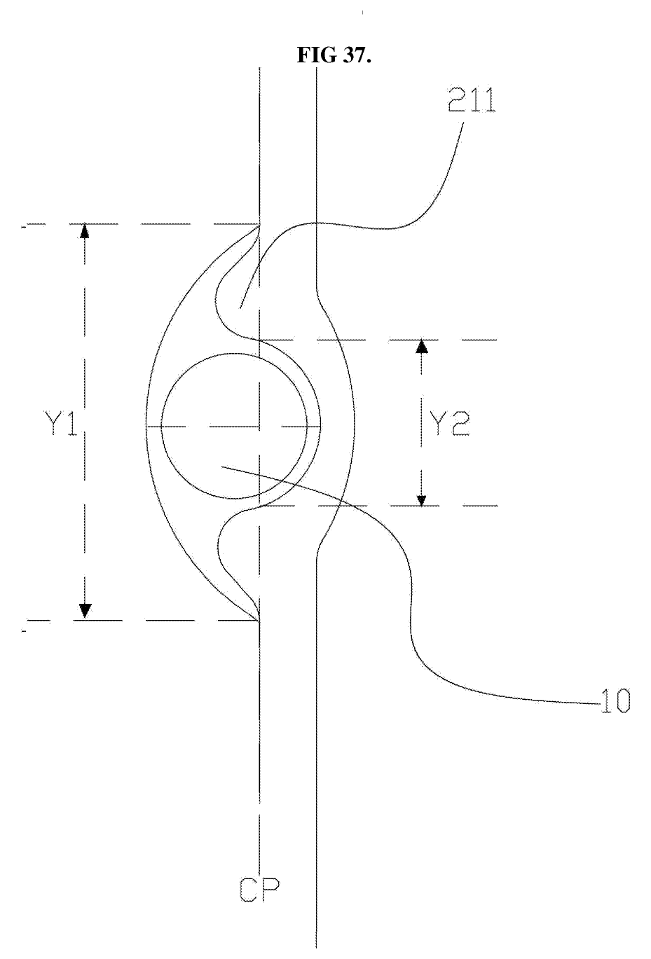

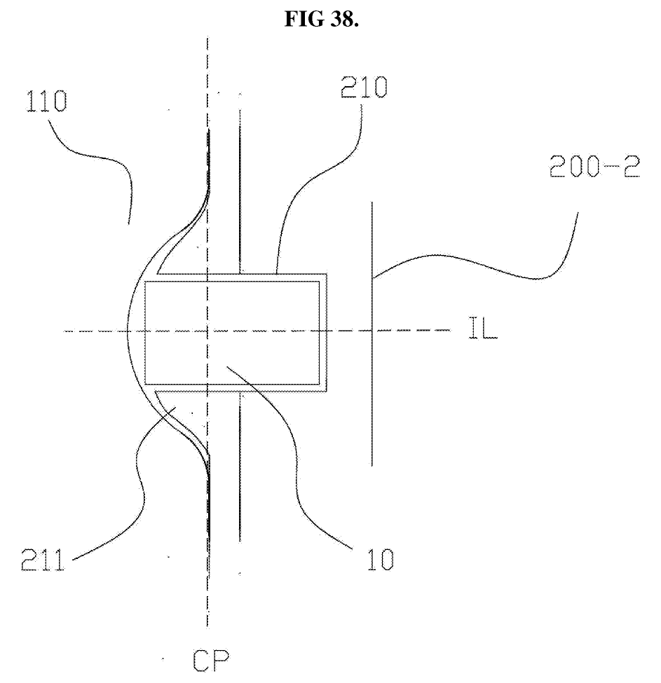

FIG. 36 is a drawing comparing the 1-2 surface of the base member and the 2-1 surface of the cap member that contact each other when combined.

To facilitate easy explanation of the process by which the base member 100 and cap member 200 are combined and coupled with each other, the corresponding drawing is a drawing showing a comparative view of the detailed configurations of the 1-2 surface 100-2 of the base member 100 and the 2-1 surface 200-1 of the cap member 200, the contacting surfaces, and it is a view from above, but the 2-1 surface 200-1 of the cap member 200 is shown transparently for convenience of explanation.

Now looking more carefully at the roles of each component in the coupling process of the 1-2 surface 100-2 of the base member 100 and the 2-1 surface 200-1 of the cap member 200, as the cap member 200 moves from the side of the base member 100 from left to right in the drawing, the 2-1 latch 222 of the 2-1 cap connector 220 contacts the 1-1 rail portion 181 of the 1-1 base connector 180 whose edge is tapered, causing the 2-1 latch 222 to move downward. And as force continues to be applied, the 2-1 latch 222 continues to move while riding the 1-1 rail portion 181, and when it meets the 1-1 groove portion 182, the 2-1 latch 222 moves upward and enters the 1-1 groove portion 182, completing the connection and coupling of the cap member 200 and base member 100. Specifically, the 2-1 latch 222 is inserted into the 1-1 groove portion 182, and the 2-1 rail portion 221 contacts the 1-1 rail portion 181, completing both snap fit and slide connection. Here, at the far right of the 1-1 groove portion 182, a wall may be formed to prevent further movement of the 2-1 latch 222, or a wall may be formed at the end of the 2-1 cap connector 220 on the opposite side from the insertion direction to prevent further movement. And this same process can proceed between the 2-2 cap connector 230 and the 1-2 base connector 190. Through this, the present invention can guarantee stable connection and coupling between the cap member 200 and base member 100. For reference, in the process where coupling of the cap member 200 and base member 100 occurs in this way, the second wire slot 210, slot protrusion 211, and first wire slot 110 also form the wire slot WS for supporting the orthodontic wire 10 to be placed, and for this, the width value of the first wire slot 110 may be manufactured larger than the width value of the second wire slot 210 of the cap member 200.

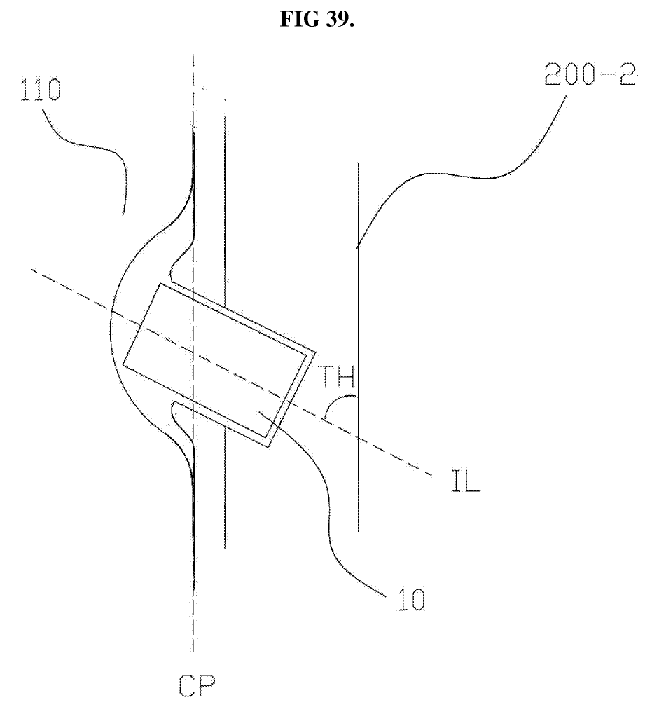

FIG. 37 is a drawing showing, in the orthodontic bracket according to the present invention, the appearance of the second wire slot with a semicircular cross-section that supports the orthodontic wire.

The cross-section of the first wire slot 110 of the base member 100 constituting the present invention is formed in a semicircular shape. And while the cap member 200 is changed to provide an appropriate slot, the base member 100 remains attached to the tooth T, so the shape of the first wire slot 110 does not change with the replacement of the orthodontic wire 10. Nevertheless, the first wire slot 110 of the base member 100 is formed with a depth value D1 larger than the depth value D2 of the second wire slot 210, and the cross-section of the first wire slot 110 is formed with a depth value larger than the diameter value of the round cross-section orthodontic wire. Furthermore, the first wire slot 110 has a width value Y1 larger than the width value Y2 of the second wire slot 210, and the curvature value of the curved surface formed in the width direction is formed smaller than the curvature value of the second wire slot 210, so that the orthodontic wire 10 placed between the first wire slot 110 and the second wire slot 210 is effectively supported at an appropriate gap. In particular, by accommodating even the slot protrusion 211 of the cap member 200 into the first wire slot 110, most of the placed orthodontic wire 10 can be accommodated inside, and through this, even if part of the second wire slot 210 is open, the orthodontic wire 10 can be effectively supported through the first wire slot 110. Here, the first wire slot 110 accommodates 20 to 50 percent of the cross-sectional area of the orthodontic wire 10, and the second wire slot 210 can accommodate 50 to 95 percent of the cross-sectional area of the orthodontic wire 10 inside. For reference, the imaginary plane formed by the 1-2 surface 100-2 of the base member 100 and the 2-1 surface 200-1 of the cap member 200 coming into contact can be referred to as the contact plane CP. In the drawing, only the appearance of the second wire slot 210 for a single diameter was shown as an example, but when the diameter of the orthodontic wire 10 changes, a cap member 200 equipped with a corresponding second wire slot 210 can be selected and used. For example, the diameter value of the cross-section of the second wire slot 210 may be selected in the range of 0.3 to 0.5 millimeters, or when supporting a round cross-section orthodontic wire 10, it may be formed to be 0.8 to 1.2 millimeters larger than the diameter value of that orthodontic wire 10. Alternatively, taking note from orthodontic textbooks that a gap of 0.1 millimeters between the orthodontic wire 10 and the slot has the lowest friction coefficient and provides the optimal corrective force, the second wire slot 210 may be formed so that the gap relative to the placed orthodontic wire 10 is approximately 0.05 to 0.1 millimeters larger.

By forming the first wire slot 110, second wire slot 210, and slot protrusion 211 around the orthodontic wire 10 with an optimal gap suitable for the wire, the present invention, with the base member 100 remaining attached to the tooth T, can support the replacement use of various orthodontic wires 10 depending on the treatment stage through replacement of the cap member 200.

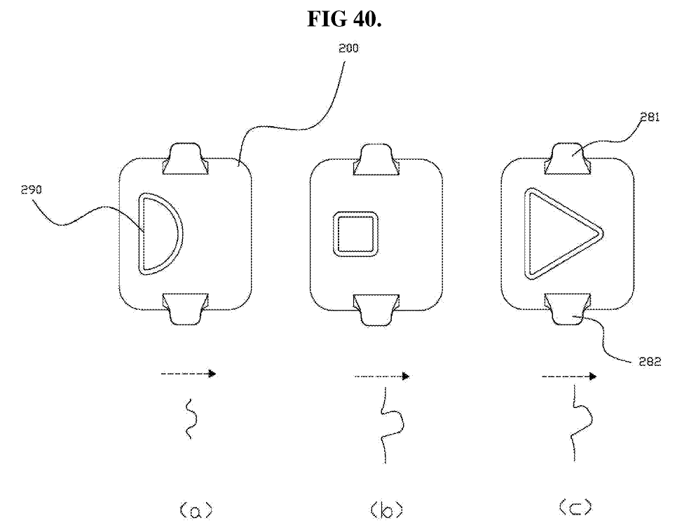

FIG. 38 is a drawing showing, in the orthodontic bracket according to the present invention, the appearance of the second wire slot with a rectangular cross-section that supports the orthodontic wire.

In addition to round cross-section orthodontic wires 10, rectangular cross-section orthodontic wires may also be used during the orthodontic treatment process, and these orthodontic wires 10 may be used when there is a need to provide corrective force in the torque direction to the tooth, etc. However, since conventional self-ligating brackets 30 and conventional metal orthodontic devices 20 are not easily removed once attached to the tooth T, they had to accommodate the use of these rectangular cross-section orthodontic wires 10 as well as the use of the largest size orthodontic wires 10, so their slots were already prepared large, and this resulted in the problem of not being able to maintain an appropriate gap with the orthodontic wire 10 and the corrective force not being properly transmitted to the tooth T or being lost through friction.

In contrast, the present invention, when it is necessary to use a rectangular cross-section orthodontic wire 10, allows selection and use of a cap member 200 equipped with a supporting second wire slot 210, resolving the problem of gaps being too large to transmit corrective force, and enabling appropriate corrective force transmitted by the orthodontic wire 10 to be delivered to the tooth T. Specifically, the second wire slot 210 with a rectangular cross-section used to support a rectangular orthodontic wire 10 when it is not necessary to impart torque can be formed so that the imaginary line IL extending perpendicularly from the bottom surface of the second wire slot 210 meets perpendicularly with the imaginary plane covering the upper part of the first wire slot 110, i.e., the contact plane CP, which is the imaginary plane formed by the 1-2 surface 100-2 and 2-1 surface 200-1 contacting each other. In this way, when using a rectangular cross-section orthodontic wire 10, the first wire slot 110 accommodates about 20 to 50 percent %, percent of the cross-sectional area of the orthodontic wire 10. And the second wire slot 210 with a rectangular cross-section formed in the width direction may be formed so that the lateral width side length value is 0.4 to 0.6 millimeters and the horizontal CP direction side length is 0.5 to 0.8 millimeters, so that 50 to 95 percent of the cross-sectional area of the orthodontic wire 10 can be accommodated therein. For reference, the slot protrusion 211 disposed on both sides of the second wire slot 210 limits the movement of the placed orthodontic wire 10 from the center position in the first wire slot 110 to a non-centered position, thereby preventing increased friction between the orthodontic bracket 1000 according to the present invention and the orthodontic wire 10.

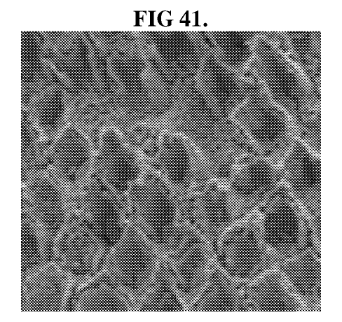

FIG. 39 is a drawing showing, in the orthodontic bracket according to the present invention, the appearance of the second wire slot with a tilted rectangular cross-section that supports the orthodontic wire.

When torque needs to be imparted during orthodontic treatment, a cap member 200 equipped with a tilted rectangular-shaped second wire slot 210 can be selected and used. Looking at the shape of the second wire slot 210 of this cap member 200 in more detail, the second wire slot 210 can be manufactured to have a tilted rectangular or parallelogram cross-section so that the imaginary line IL extending perpendicularly from the bottom surface of the second wire slot 210 meets at an inclination with the imaginary plane 'CP' formed by the 1-2 surface 100-2 and 2-1 surface 200-1 contacting each other, which is the imaginary plane covering the upper part of the first wire slot 110. The inclination at which the imaginary line and contact plane CP meet can be appropriately selected as needed, and can be selected in the range of 9 to 35 degrees.

In this way, the bracket according to the present invention enables provision of appropriate slots according to the size and shape of the orthodontic wire used at each stage of orthodontic treatment, enabling appropriate corrective force to be provided to the tooth T at each treatment stage, thereby maximizing treatment effectiveness and shortening the treatment period. For reference, in FIGS. 37 to 39, the second wire slot 210 shapes of semicircular, rectangular, and tilted rectangular have been shown to support round and rectangular cross-section orthodontic wires 10, but as the gauge and shape of the wire being used changes, the shape and size of the second wire slot 210 may also change accordingly to appropriately support the wire. That is, the second wire slot 210 can be changed to the appropriate shape and size to maintain a gap of approximately 0.1 millimeters between the used orthodontic wire 10 and the slot.

FIG. 40 is a drawing showing the identification mark formed on the 2-2 surface of the cap member constituting the present invention and its role.

As explained previously, the 2-2 surface 200-2 of the cap member 200 constituting the present invention may be formed with an identification mark 290 for indicating the shape and/or slide insertion direction of the second wire slot 210. Without limitation, this identification mark 290 may be formed in an embossed form, and the slide insertion direction for connecting the cap member 200 to the base member 100 and the cross-sectional shape of the second wire slot 210 can be indicated by a single identification mark 290. For example, as in the case of the right-facing semicircle shown in drawing a, when displayed on the 2-2 surface 200-2, it can tell the user that the cross-sectional shape of the second wire slot 210 of the corresponding cap member 200 is semicircular, and the slide insertion direction is from left to right. Similarly, in the case of the triangle shape as in drawing c, the cross-sectional shape of the second wire slot 210 is a 30-degree tilted rectangle, and the slide insertion direction is from left to right in the direction the triangle points, like the dashed line in the drawing. Also, in the case of the rectangular shape as in drawing b, the cross-sectional shape of the second wire slot 210 is a 15-degree tilted rectangle, and the slide insertion direction for slide and snap fit connection can be indicated as being from left to right by the absence of the mark from the portion where the identification mark 290 is displayed.

Through the identification mark 290 formed in the cap member 200 in this way, the shape of the second wire slot 210 and the slide progress direction of the cap member 200 can be predicted, increasing the convenience of users such as orthodontists, and mistakes can be prevented in advance.

Hereinafter, the use process of the orthodontic bracket 1000 according to the present invention will be described more specifically through drawings by stage.

FIG. 41 is a drawing showing an enlarged view of an etched tooth surface.

To effectively attach the base member 100 constituting the present invention to the tooth T, first, a process of etching ET the surface of the tooth T using acid, etc. may be performed, and the drawing is a drawing showing an enlarged view of the tooth surface on which etching has been performed in this way. For reference, this etching ET is a preliminary measure to ensure that bonding agents such as resin used for subsequent attachment of the base member 100 penetrate well into the tooth T.

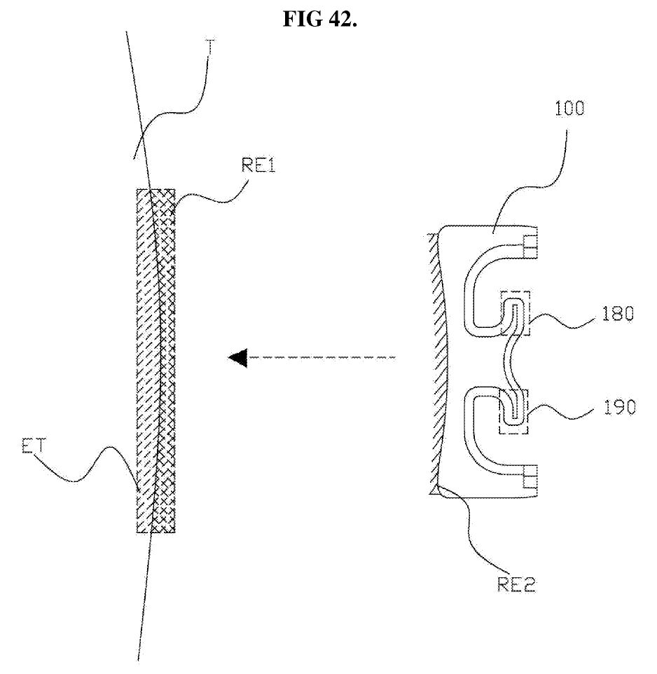

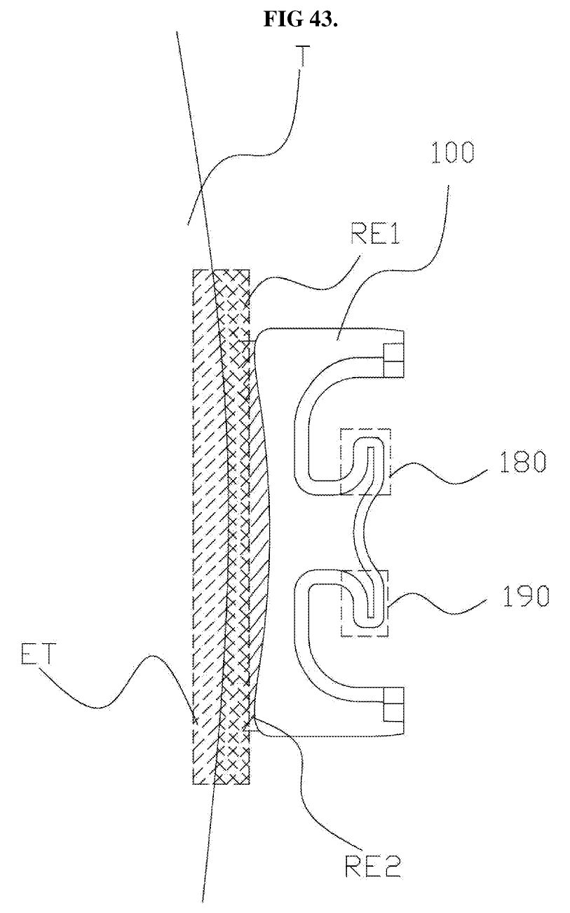

FIGS. 42 and 43 are drawings showing the process of attaching the base member constituting the present invention to the tooth surface.

After performing etching ET on the surface of the tooth T in this way, a process of coating the etched tooth T surface with flowable first resin RE1 may be performed, and a process of coating the 1-1 surface 100-1 of the base member 100 with second resin RE2 having higher viscosity than the first resin RE1 may also be performed. Here, the 1-1 surface 100-1 of the base member 100 may have a pattern or groove formed thereon in advance as described above to widen the contact area with the second resin RE2, and in cases where such a pattern or groove is not formed in advance, etching may be performed before coating the second resin RE2. Next, a process of moving the base member 100 coated with the second resin RE2 to the tooth T and attaching it to the tooth T may be performed, and this attachment process can be completed by irradiating light on the photo-curing type first resin RE1 and second resin RE2 using a curing lamp. By separately applying the first resin RE1 and second resin RE2 in this way, the present invention ensures that the adhesive strength between the first resin RE1 and the tooth T, and between the second resin RE2 and the base member 100 is greater than the adhesive strength between the first resin RE1 and the second resin RE2, so that after treatment is complete, the base member 100 can be easily removed from the tooth T surface.

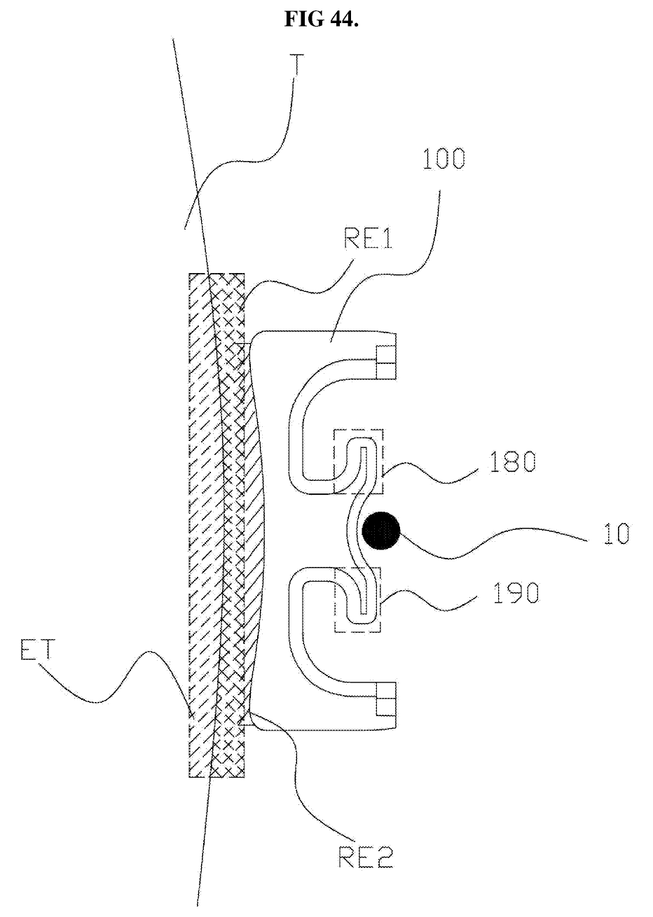

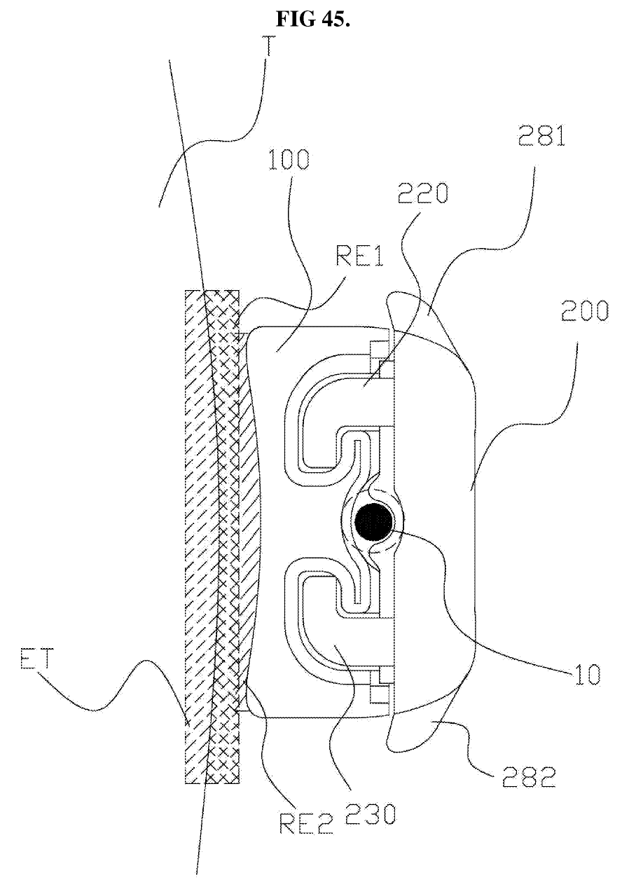

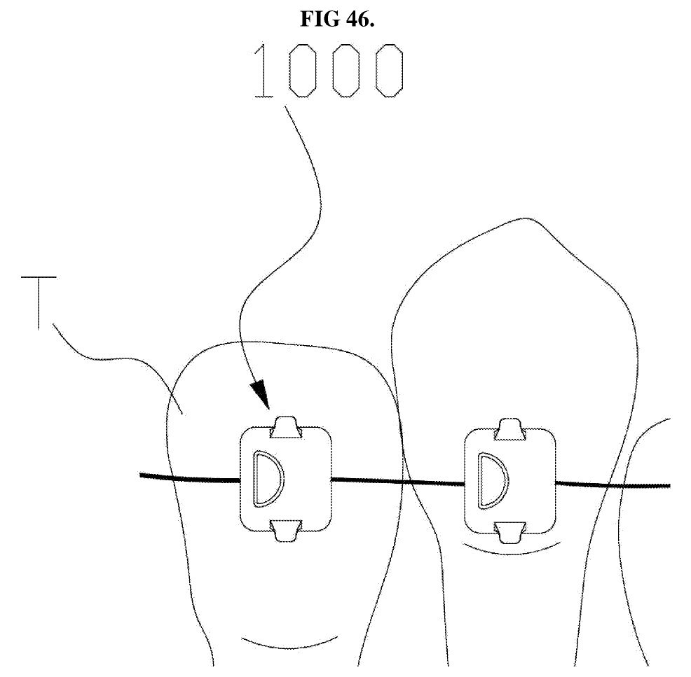

FIGS. 44 and 45 are drawings showing the process of the cap member connecting to the base member with an orthodontic wire placed, and FIG. 46 is a drawing showing the completion of support for the orthodontic wire through the orthodontic bracket according to the present invention.

After attachment of the base member 100 is completed in this way, at each stage of orthodontic treatment an appropriate orthodontic wire 10 is selected and placed, and then the cap member 200 equipped with a second wire slot 210 capable of supporting that orthodontic wire 10 at an appropriate gap is selected and connected to the base member 100, enabling the corrective force provided by the orthodontic wire 10 to be transmitted to the tooth T. For reference, in the corresponding drawing, a round cross-section orthodontic wire 10 was selected and a cap member 200 equipped with a semicircular second wire slot 210 was selected and used to confirm this, but when an orthodontic wire 10 of another size or shape is selected, a cap member 200 equipped with an appropriate second wire slot 210 for supporting that orthodontic wire 10 can be selected and used again.

Since it can support providing a slot with an appropriate gap according to the wire being actively used in this way, the present invention can actively support the use of nickel-titanium wire which has weak elasticity but exerts weak and continuous force, and can also effectively transmit the force provided by nickel-titanium wire to the tooth. Therefore, the number of times the orthodontic wire 10 is replaced during orthodontic treatment can be drastically reduced, enabling increased patient and/or orthodontist convenience.

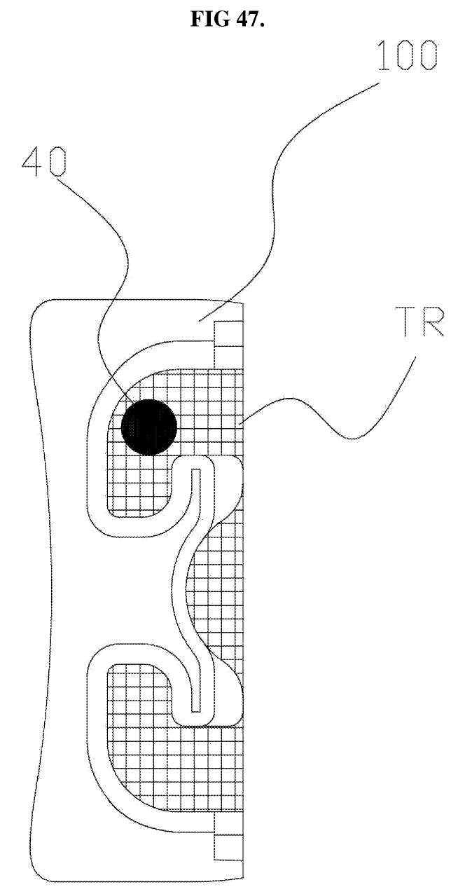

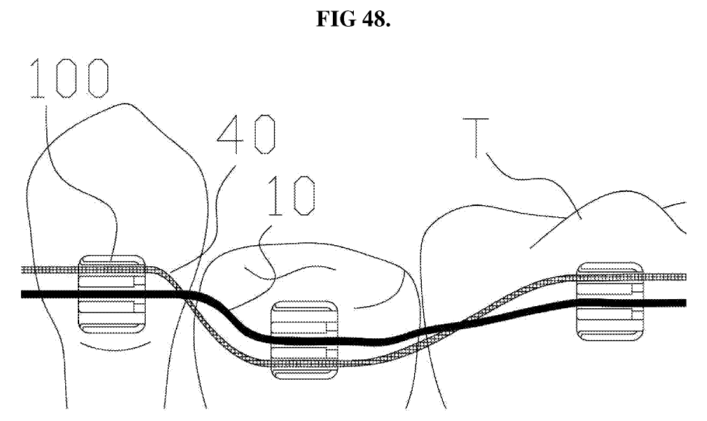

FIGS. 47 and 48 are drawings showing the appearance of an orthodontic auxiliary wire attached to the open area of the base member constituting the present invention to provide additional corrective force needed for orthodontic treatment.

During orthodontic treatment, there are cases where additional corrective force beyond that provided by the orthodontic wire 10 is needed. In these cases, the present invention can help deliver such additional corrective force to the tooth T by using orthodontic auxiliary wire 40 utilizing the 1-1 space 171 and 1-2 space 172 of the base member 100. Specifically, in areas where delivery of additional corrective force is needed, with the connected cap member 200 removed, the orthodontic auxiliary wire 40 is placed in the 1-1 space 171 or 1-2 space 172 of the base member 100, and then temporary resin TR is coated over the orthodontic auxiliary wire 40 to fix the orthodontic auxiliary wire 40, which can deliver additional corrective force and pulling force to the tooth T. The temporary resin TR used here can be easily removed when it is necessary to connect the cap member 200 again later.

In addition to the rubber band method, since the present invention can also support the use of orthodontic auxiliary wire 40 using the base member 100 attached to the tooth T in this way, more effective tooth T orthodontic treatment is possible.

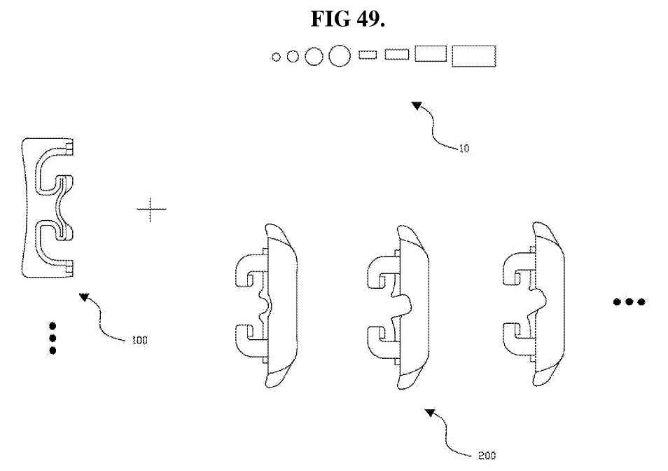

FIG. 49 is a drawing schematically summarizing the concept of use of the orthodontic bracket according to the present invention.

FIG. 49 schematically summarizes and shows the appearance of the orthodontic bracket 1000 according to the present invention described so far and the method of use of the orthodontic bracket 1000 to be described hereafter, showing that various orthodontic wires 10 can be placed on a single base member 100 attached to the tooth T, and for this, various cap members 200 equipped with different second wire slots 210 can be selected and used.

By selecting various orthodontic wires 10 throughout the entire process of orthodontic treatment and effectively transmitting the corrective force provided by those orthodontic wires 10 to the tooth T in this way, the present invention can shorten the treatment period of tooth T orthodontic treatment and minimize side effects such as root resorption.

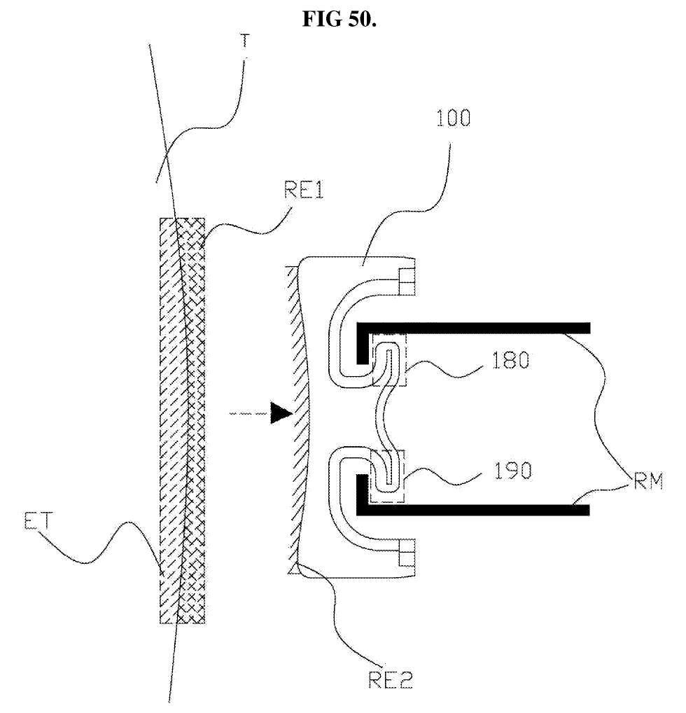

FIG. 50 is a drawing showing the appearance of removing the base member attached to the tooth.

When there is a need to remove the base member 100 from the tooth T surface as orthodontic treatment is completed, etc., the present invention can be removed from the tooth T surface more easily compared to conventional self-ligating brackets 30 or conventional metal orthodontic devices 20. For example, in the process of removing conventional brackets, there are many cases where the bracket breaks, requiring grinding with a high-speed cutting instrument, and the resin remaining on the tooth surface also had to be ground off, making the removal process difficult in many cases. However, the present invention helps the base member to be removed more conveniently by gripping and pulling the connector structure formed in the base member 100. This process can be achieved by gripping the 1-1 base connector 180 and 1-2 base connector 190 of the base member 100, and a removal tool RM specially designed to more effectively grip the 1-1 base connector 180 and 1-2 base connector 190 can be used. Particularly, this removal method increases its effectiveness through the method of applying the first resin RE1 and second resin RE2 applied separately upon attachment of the base member 100 described above, and through the method of applying and attaching by using resins of different properties.

The orthodontic bracket 1000 according to the present invention can remove even the base member 100 cleanly from the tooth T surface in this way, having the effect of shortening treatment time and increasing the convenience of orthodontists and patients.

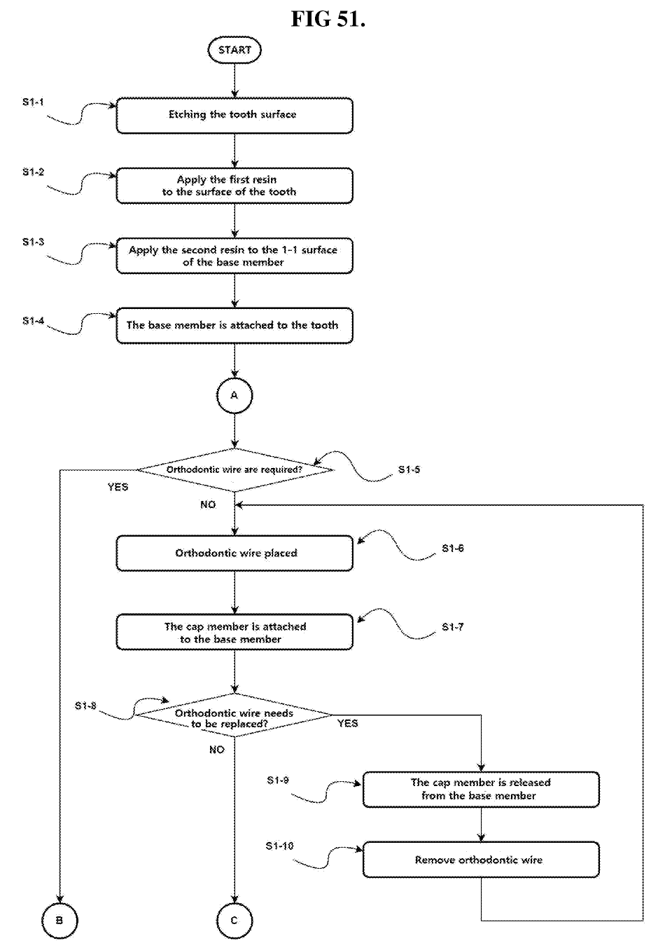

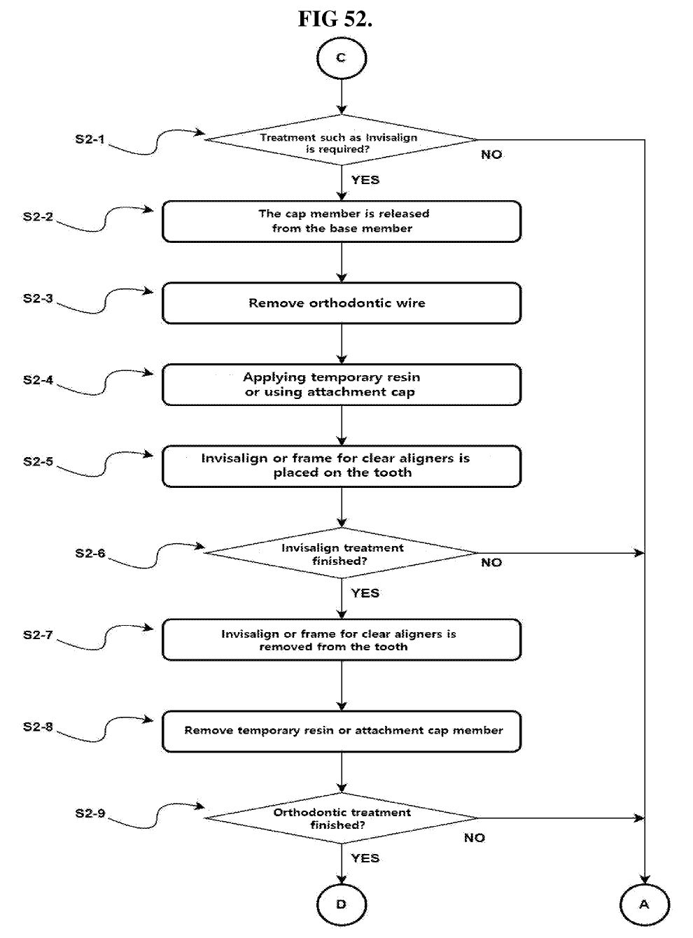

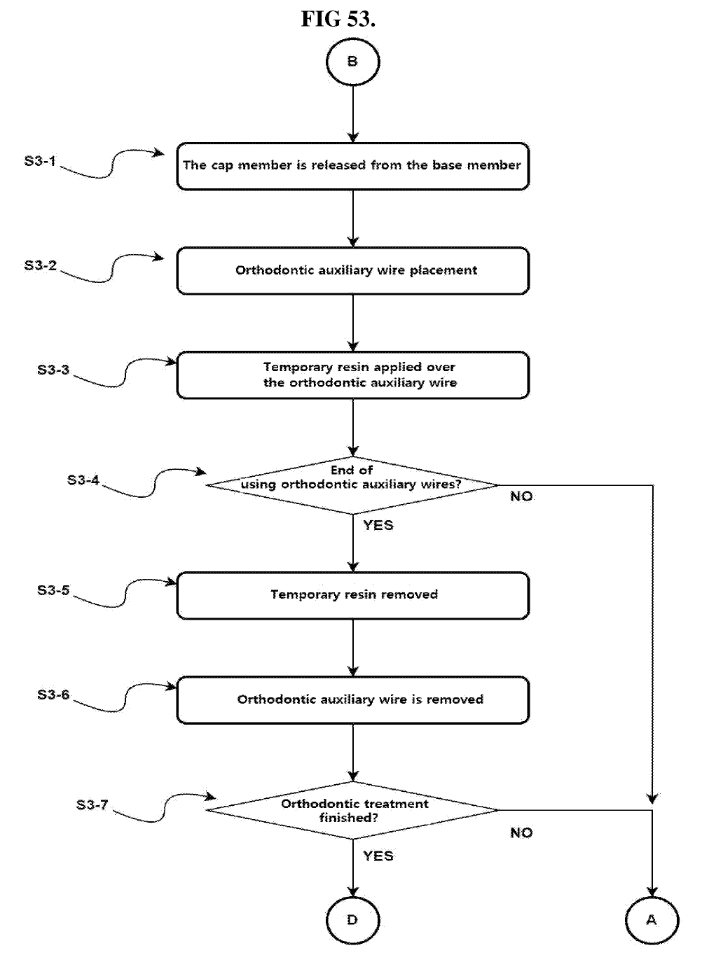

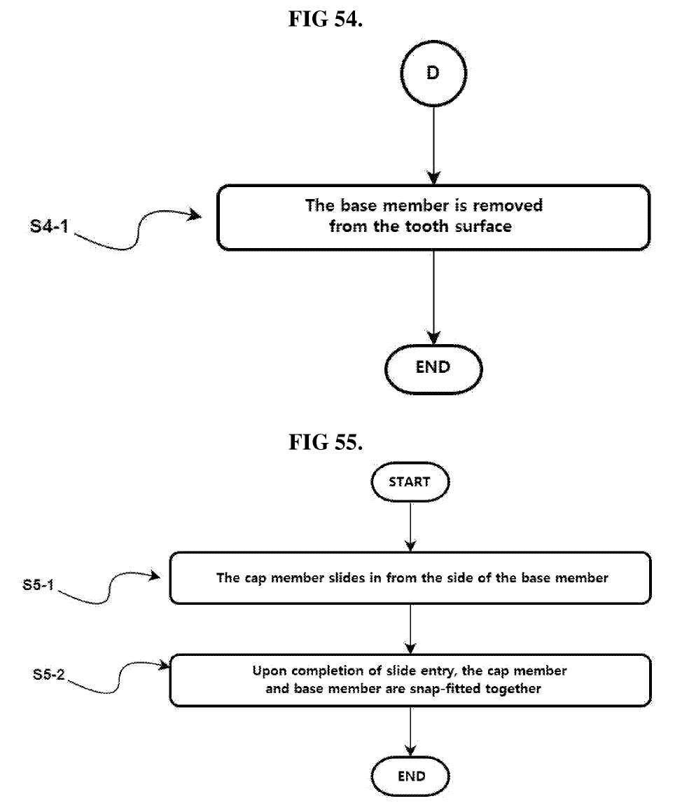

FIGS. 51 to 54 are sequential drawings showing the method of using the orthodontic bracket according to the present invention.

The present invention can be performed starting from the process of etching the tooth T surface using acid, etc. as a preliminary step for using the orthodontic bracket 1000 according to the present invention S1-1. More specifically, etching can be performed on the surface of the tooth T where the base member 100 will be attached. Next, the process of coating the etched tooth T surface with the first resin RE1 can be performed S1-2, and the process of coating the 1-1 surface 100-1 of the base member 100 with the second resin RE2 can also be performed S1-3, and the process of attaching the base member 100 coated with the second resin RE2 to the tooth T can be performed S1-4. The reason for separately applying the first resin RE1 and second resin RE2 in two steps is that since the adhesive strength between the first resin RE1 and the tooth T and the adhesive strength between the second resin RE2 and the base member 100 are greater than the adhesive strength between the first resin RE1 and the second resin RE2, this is to allow the first resin RE1 and second resin RE2 to separate when the base member 100 is removed from the tooth T surface later, enabling the base member 100 to be easily detached.

After the base member 100 is attached to the tooth T in this way, the practitioner such as the orthodontist can go through the process of judging whether orthodontic auxiliary wire 40 is needed S1-5. Here, when it is judged that orthodontic auxiliary wire 40 is not needed, the process of placing the orthodontic wire 10 between the base member 100 and cap member 200 is performed S1-6, and the process of connecting the cap member 200 to the base member 100 can be performed S1-7. For reference, in the above process the orthodontic wire 10 is placed between the first wire slot 110 of the base member 100 and the second wire slot 210 of the cap member 200, and the connection between the cap member 200 and base member 100 can be achieved through slide and/or snap fit methods. Also, in the embodiment where the cap member 200 and base member 100 are connected by a hinge method, snap fit connection can be made by rotating the cap member 200 toward the base member 100 centered on the hinge axis.

After attaching the orthodontic bracket 1000 according to the present invention to the tooth T and using it in this way, the practitioner such as the orthodontist can go through the process of confirming whether replacement of the orthodontic wire 10 is needed at the stage of tooth T orthodontic treatment S1-8. Here, when it is judged that replacement of the orthodontic wire 10 is needed, the process of releasing the cap member 200 from the base member 100 can be performed S1-9, and then going through the process of removing the orthodontic wire 10 S1-9, the orthodontic wire 10 can be replaced. Here the replacement orthodontic wire 10 can be larger in diameter than the previous one, and accordingly, a cap member 200 with a second wire slot 210 of larger cross-sectional area than the removed one will be selected and used.

Here, when it is considered that replacement with an orthodontic wire 10 is not needed, next, the practitioner, etc. can go through the process of confirming whether treatment using transparent correction devices such as Invisalign is needed S2-1. In this stage, when it is judged that use of Invisalign, etc. is needed, the process of releasing the cap member 200 from the base member 100 by the practitioner, etc. S2-2 and the process of removing the orthodontic wire 10 can be performed S2-3. Next, the process of coating the temporary resin TR on the 1-2 surface 100-2 of the base member 100 to fill the 1-1 space 171 and 1-2 space 172, etc. of the base member 100 S2-4, and the process of attaching the frame for Invisalign or transparent correction to the tooth can be performed S2-5. The base member 100 with temporary resin TR coated in this way for Invisalign can perform the same role as an attachment. Or, instead of coating temporary resin TR, a thin-thickness attachment-use cap member can be attached to the base member 100. For reference, correction treatment using Invisalign is less effective than correction using brackets for tooth T movement and alignment, but is effective for dental arch expansion, etc. The present invention enables utilization as an attachment without removing the base member 100, enabling selective use of the advantages of bracket-based orthodontic treatment and the advantages of treatment using transparent correction devices such as Invisalign for more effective orthodontic treatment to be achieved.

Next, the practitioner, etc. can go through the process of confirming whether treatment using transparent correction devices such as Invisalign is complete S2-6. When it is judged that treatment using Invisalign, etc. is no longer needed, the process of removing the frame for Invisalign or transparent correction from the tooth by the practitioner, etc. S2-7 and the process of removing the temporary resin TR or attachment-use cap member coated on the base member 100 can be performed S2-9. For reference, since the temporary resin TR coated on the base member 100 does not chemically bond with the base member 100 as hard as a bonding agent even after curing, removal using tweezers, etc. is possible.

Next, the process of judging whether orthodontic treatment of the tooth T is complete is performed S2-9, and if orthodontic treatment still needs to be continued, proceeding to stage 'A' of FIG. 51 allows the treatment process to be continued. In this process, when it is judged by the practitioner, etc. that orthodontic auxiliary wire 40 is needed S1-5, to support use of the orthodontic auxiliary wire 40, first, the process of releasing the cap member 200 from the base member 100 S3-1 and the process of placing the orthodontic auxiliary wire 40 utilizing the 1-1 space 171, etc. of the base member 100 can be performed S302. Specifically, in the region where the 2-1 cap connector 220 and/or 2-2 cap connector 230 of the base member 100 are inserted, the orthodontic auxiliary wire 40 can be placed, and temporary resin TR can be coated over it to fix the orthodontic auxiliary wire 40 S3-3.

In this way, after conducting correction treatment using the orthodontic auxiliary wire 40, the practitioner, etc. can make the judgment that use of the orthodontic auxiliary wire 40 is complete S3-4, and when judged to be complete, the process of removing the temporary resin TR coated over the orthodontic auxiliary wire 40 using tweezers, etc. S3-5 and the process of removing the orthodontic auxiliary wire 40 placed in the 1-1 space 171 and/or 1-2 space 172 can be performed S3-6.

During this process, the practitioner, etc. can perform the process of ultimately deciding whether to end the correction treatment S3-7, and here if the decision to end correction treatment is made, going through the process of removing all components used for tooth correction including the base member 100 from the tooth T surface S4-1, the treatment process can be concluded.

In this way, the present invention can support convenient use of appropriate orthodontic wires throughout the entire process of orthodontic treatment, and at stages where use of transparent correction devices such as Invisalign is needed, use of transparent correction devices can also be supported, enabling maximization of the treatment effectiveness of orthodontic treatment, and shortening of the treatment period, improvement of patient and practitioner convenience, etc. to be achieved.

FIG. 55 is a sequential drawing showing the process of the base member and cap member constituting the present invention being combined.

The process of the base member 100 and cap member 200 described in FIG. 51 being connected can, in detail, start with the cap member 200 starting to slide in from the side of the base member 100 S5-1, and be achieved through the process where the connection between the cap member 200 and base member 100 is completed by snap fit at the stage where the cap member 200 has continuously moved and completed the slide insertion S5-2. More specifically, the 2-1 latch 222 and 2-2 latch 232 of the cap member 200 ride along the 1-1 base connector 180 and 1-2 base connector 190 of the base member 100 and move downward under the force applied, and continuing to move, when they meet the 1-1 groove portion 182 and 1-2 groove portion 192, they move upward and fit into the grooves, thereby achieving snap fit connection. Or depending on the embodiment, connection may be made directly by snap fit without slide insertion being made, or snap fit connection may be made following rotation. Specifically, in another embodiment of the orthodontic bracket 1000, the cap member 200 moves toward the base member 100 and snap fit connection is made by the force applied. And in yet another embodiment, the cap member 200 connected by the hinge method can rotate toward the base member 100 while snap fit connection is made by the force applied. The detailed appearance of these embodiments will be specifically confirmed through the drawings below.

In this way, the present invention's connection and coupling of the base member and cap member constituting the orthodontic bracket 1000 proceeds through slide and/or snap fit methods, with the effect of simultaneously increasing convenience of use and improving stability throughout the entire orthodontic treatment process.

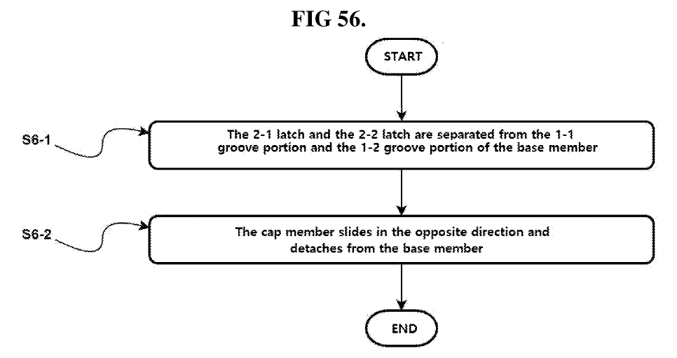

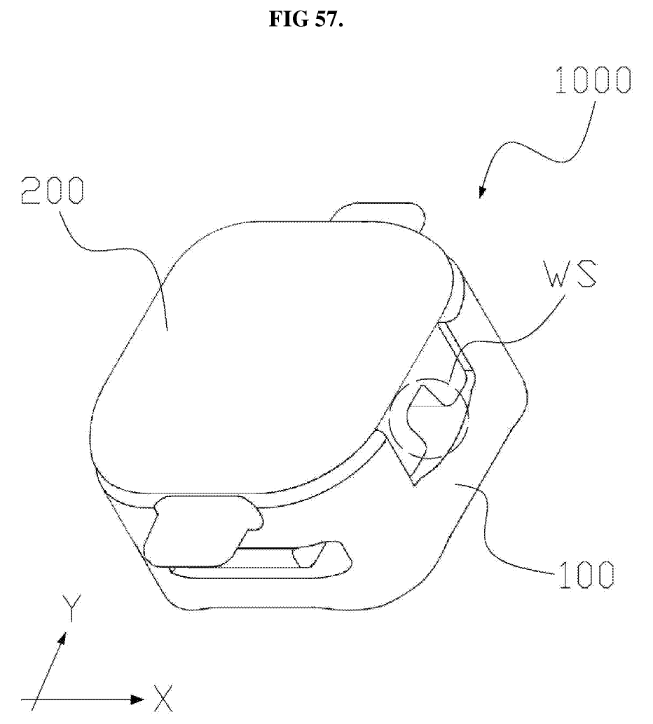

FIG. 56 is a sequential drawing showing the process of the base member and cap member constituting the present invention being released.

The release of the base member 100 and cap member 200 can proceed in the reverse order of the connection and coupling process, which can be started from the process of the 2-1 latch 222 and 2-2 latch 232 of the cap member 200 detaching from the 1-1 groove portion 182 and 1-2 groove portion 192 of the base member 100 S6-1. Here, the process of detaching the 2-1 latch 222 from the 1-1 groove portion 182 or detaching the 2-2 latch 232 from the 1-2 groove portion 192 can be performed through specially designed tools. Next, the cap member 200 can slide in the opposite direction from the direction it was inserted, detaching from the base member 100, thereby the base member 100 and cap member 200 constituting the present invention can be mutually released S6-2. For reference, in another embodiment, after the 2-1 cap connector 220 and 2-2 cap connector 230 of the cap member 200 have moved to the inside of the cap member 200, the snap fit coupling between the two can be released by moving the cap member 200 away from the base member 100, and in yet another embodiment, after the 2-1 cap connector 220 of the cap member 200 has moved to the inside of the cap member 200, the coupling between the two can be released by rotating the cap member 200 in the direction away from the base member 100 centered on the axis connected by the hinge method.

The orthodontic bracket 1000 according to the present invention is not only thus easily connected but also easily released, enabling practitioners such as orthodontists to conveniently replace and remove the cap member 200 in operations such as replacing the orthodontic wire 10.

FIG. 57 is a drawing showing the overall appearance of another embodiment of the orthodontic bracket according to the present invention.

The other embodiment of the orthodontic bracket 1000 according to the present invention is also largely composed of the base member 100 and cap member 200, and the roles of the base member 100 and cap member 200 are the same as the previous embodiment in that they transmit the corrective force provided by the orthodontic wire 10 to the tooth T by connection and coupling with each other to form a wire slot WS. Also, the same is that the cap member 200 coupled to the base member 100 can be replaced and changed with another cap member 200 during the orthodontic treatment process. However, there is a change in the structure for snap fit connection between the base member 100 and cap member 200, and this part will be examined in more detail through the drawings below. For reference, the base member 100 and cap member 200 constituting the bracket may be formed with resin including engineering plastic, and specifically TR 90 having high durability and safety can be selected and used.

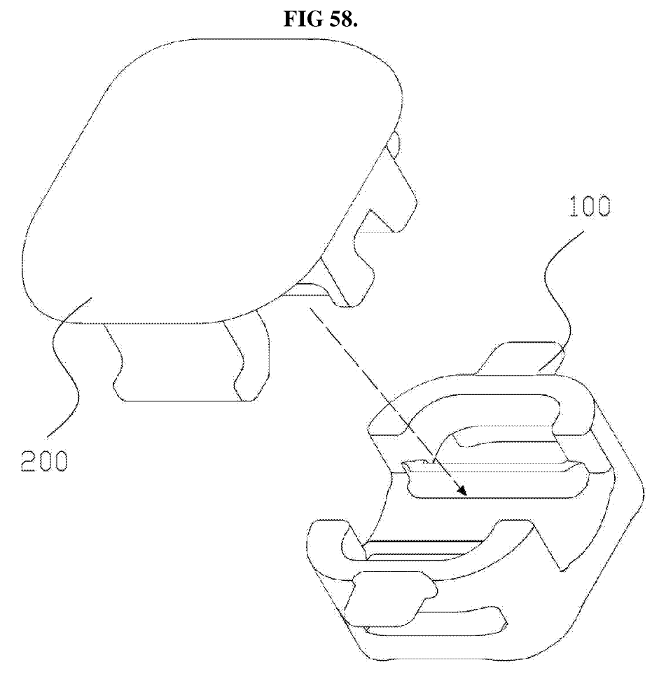

FIG. 58 is a drawing showing the process of the cap member and base member being combined in another embodiment of the orthodontic bracket according to the present invention.

While the previous embodiment of the orthodontic bracket 1000 achieved continuous slide and snap fit coupling of the base member 100 by sliding the cap member 200 in the lateral direction, in another embodiment of the orthodontic bracket 1000, by moving the cap member 200 in the arrow direction and applying pressing force, snap fit connection of the cap member 200 and base member 100 is made. Through this, the other embodiment of the orthodontic bracket according to the present invention and its method of use can achieve the effect of further increasing convenience of use. The detailed configuration of the cap member 200 and base member 100 achieving this snap fit connection will be confirmed more specifically through the following drawings.

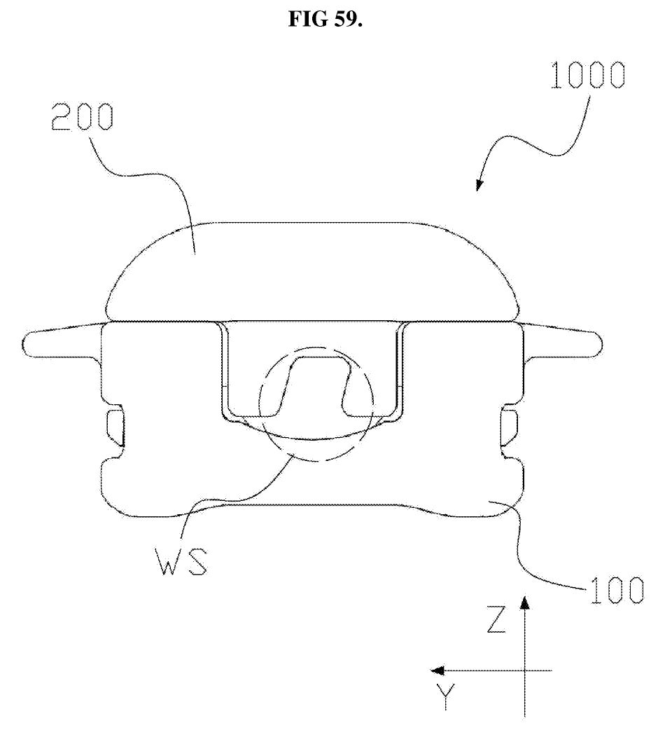

FIG. 59 is a drawing showing a side view of another embodiment of the orthodontic bracket according to the present invention.

In another embodiment of the orthodontic bracket 1000 as well, the base member 100 and cap member 200 are connected to form a wire slot WS, which is used to transmit the corrective force provided by the orthodontic wire 10 to the tooth T and allow the tooth T to move in the intended direction. For reference, 'Y' in the drawing indicates the width direction, 'Z' indicates the height direction, and 'X' indicates the length direction. For reference, the size of the orthodontic bracket 1000 can be manufactured in various sizes as long as it can be attached to the tooth T surface and support the orthodontic wire 10, for example, it can be manufactured in a size of width 3 to 4 millimeters, length 3 to 4 millimeters, and height 2 to 3 millimeters.

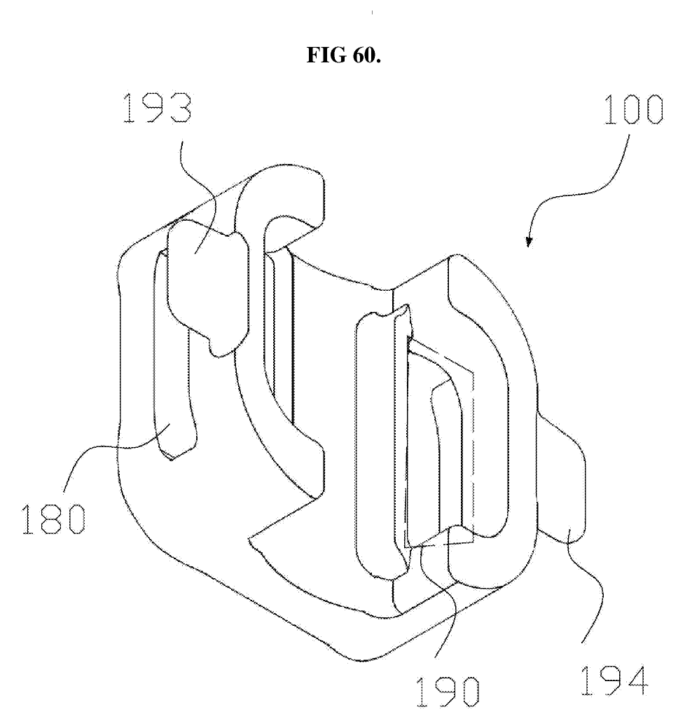

FIG. 60 is a drawing showing the overall appearance of the base member of another embodiment of the orthodontic bracket according to the present invention.

The base member 100 of another embodiment is also attached to the tooth T, and its role of transmitting the corrective force provided by the orthodontic wire 10 to the tooth T together with the cap member 200 coupled thereon is the same as the base member 100 of the previous embodiment. However, the detailed configuration differs in that it is for more convenient snap fit coupling with the cap member 200, and for this, the base member 100 has a 1-1 base connector 180 formed on the other side of the first wire slot 110, and a 1-2 base connector 190 may be formed on one side of the first wire slot 110. And on both sides of the first wire slot 110 of the base member 100, on the 1-3 surface, a 1-1 protrusion 193, and on the 1-4 surface, a 1-2 protrusion 194 may be formed, and these 1-1 protrusion 193 and 1-2 protrusion 194 can be used for threading rubber bands used as auxiliary tools during tooth T orthodontic treatment.

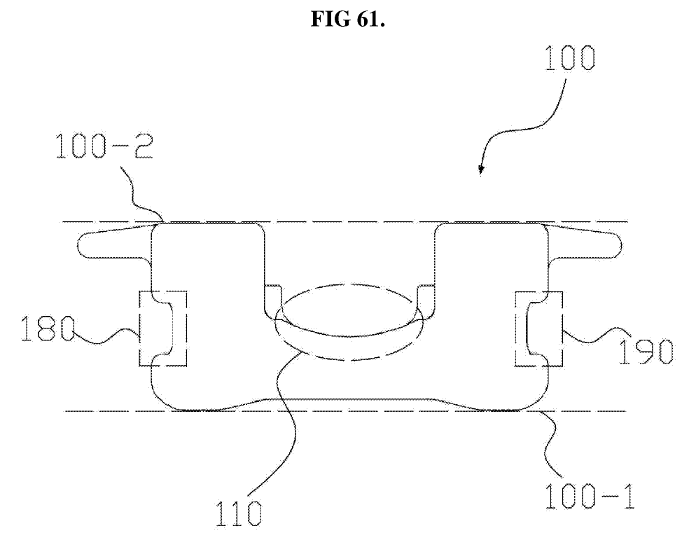

FIG. 61 is a drawing showing a side view of the base member of another embodiment of the orthodontic bracket according to the present invention.

The base member 100 of another embodiment of the orthodontic bracket 1000 according to the present invention may have a 1-1 surface 100-1 used for attaching to the tooth T and a 1-2 surface 100-2 in contact with the cap member 200, and as described above, both sides of the first wire slot 110 have the 1-1 base connector 180 and 1-2 base connector 190 formed thereon. More specifically, the 1-1 base connector 180 may be formed in a manner of penetrating from the 1-2 surface 100-2 through the 1-3 surface, and the 1-2 base connector 190 may be formed in a manner of penetrating from the 1-2 surface 100-2 through the 1-4 surface. And here, the 2-1 cap connector 220 and 2-2 cap connector 230 of the cap member 200 are inserted to achieve snap fit connection.

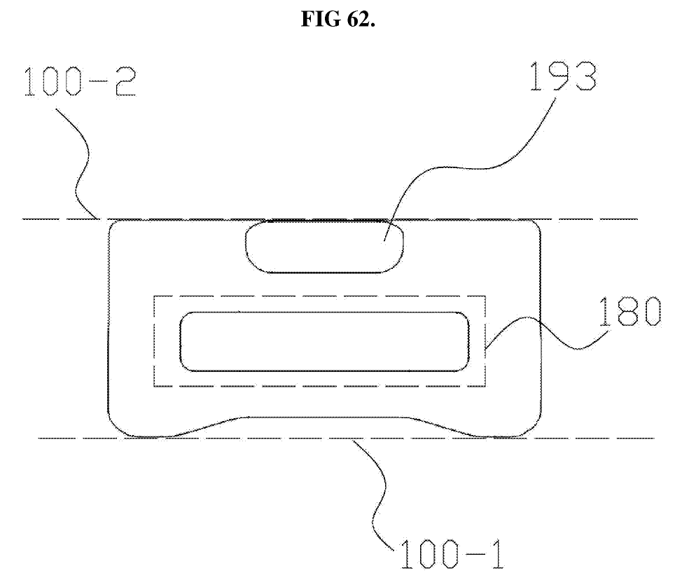

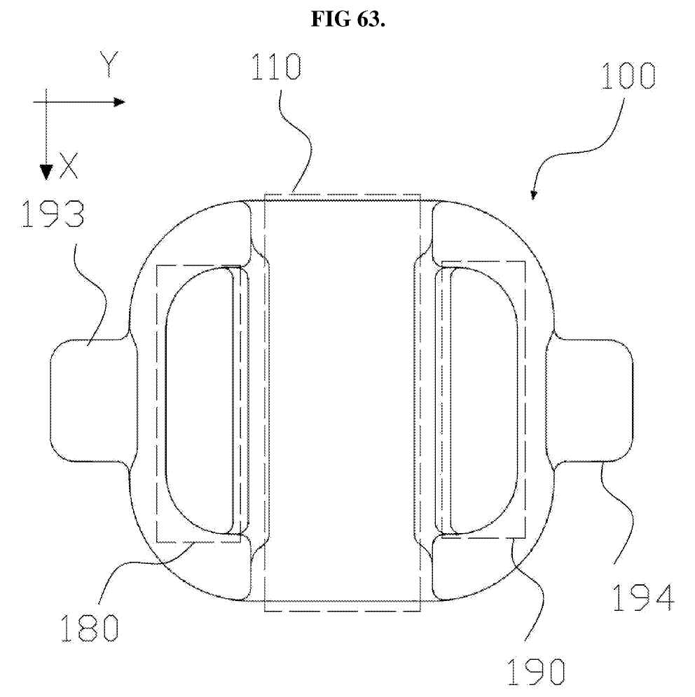

FIG. 62 is a drawing showing the appearance of the 1-3 surface of the base member of another embodiment of the orthodontic bracket according to the present invention.

Viewed from the 1-3 surface of the base member 100, it can be confirmed that the 1-1 base connector 180 is formed penetrating through the 1-3 surface to protrude outward, and here the end of the 2-1 cap connector 220 of the cap member 200 protrudes out and the 1-1 base connector 180 and 2-1 cap connector 220 are connected with each other. This type of structure can be formed equally on the 1-4 surface, which is the opposite face of the base member 100.

FIG. 63 is a drawing showing the 1-2 surface viewed from the base member of another embodiment of the orthodontic bracket according to the present invention.

As described above, it can be confirmed through the drawing that the 1-1 base connector 180 and 1-2 base connector 190 are formed on both sides of the first wire slot 110 formed in the center near the width direction Y of the base member 100. More specifically, it can be confirmed that the 1-1 base connector 180 is formed on the other side of the first wire slot 110 in a manner of penetrating from the 1-2 surface 100-2 through the 1-3 surface, and the 1-2 base connector 190 is formed on one side of the first wire slot 110 in a manner of penetrating from the 1-2 surface 100-2 through the 1-4 surface. Through this structure, the present invention can support more convenient connection and coupling between the cap member 200 and base member 100.

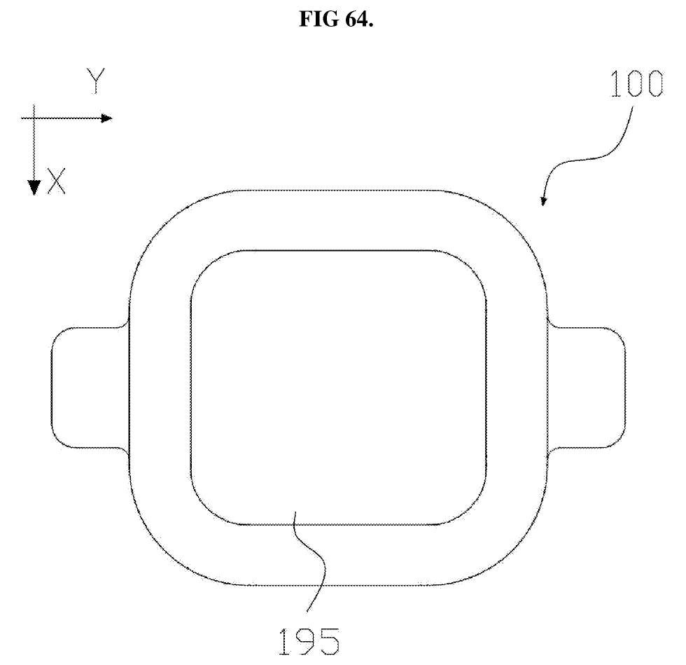

FIG. 64 is a drawing showing a view of the 1-1 surface of another embodiment of the base member of the present invention.

The 1-1 surface 100-1 of the base member 100 is a surface that performs the role of being attached to the tooth T, and may be formed concave to be easily attached to the tooth T. And on this 1-1 surface 100-1, a bonding groove 195 or pattern for widening the bonding contact area with the bonding agent may be formed. Through this structure, the present invention can stably attach the base member 100 to the tooth T surface and prevent the bonding agent from overflowing to the outside.

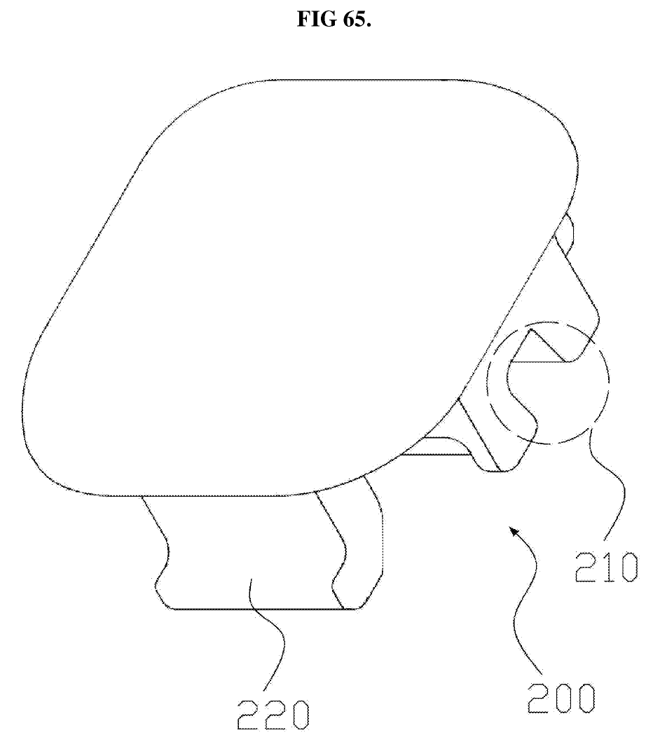

FIG. 65 is a drawing showing the overall appearance of the cap member of another embodiment of the orthodontic bracket according to the present invention.

The cap member 200 of another embodiment of the present invention may comprise the 2-1 cap connector 220 and 2-2 cap connector 230 for connection with the base member 100, and between them, the second wire slot 210 that performs the role of supporting the orthodontic wire 10 may be formed. For reference, the second wire slot 210 may be formed so that its cross-section has a rectangular shape, and to add torque during orthodontic treatment, it may be manufactured in a slightly tilted shape at an angle of 3 to 20 degrees.

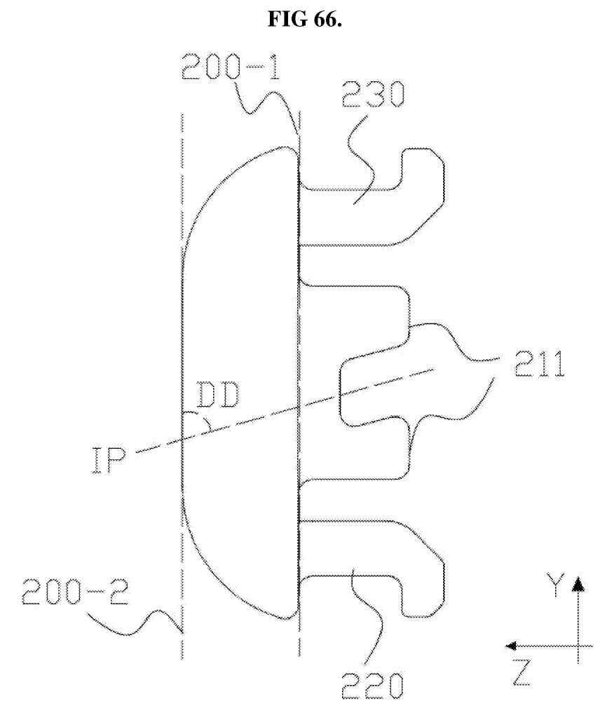

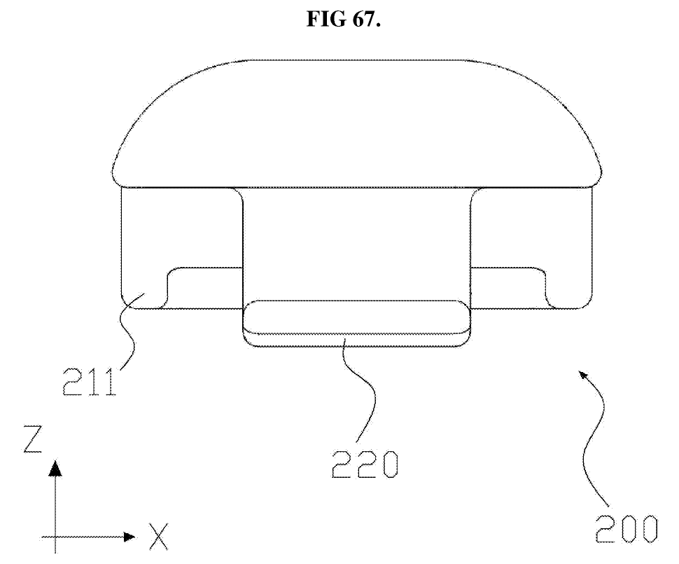

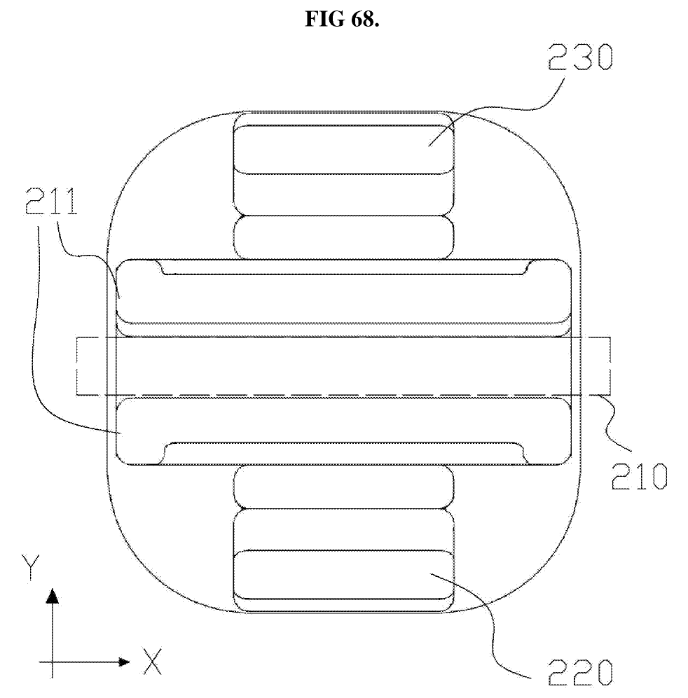

FIG. 66 is a drawing showing a side view of another embodiment of the cap member of the present invention, and FIG. 67 is a drawing showing the 2-3 surface of the cap member of the present invention.

The cap member 200 faces the base member 100 and may comprise the 2-1 surface 200-1 in contact with the base member 100 and the 2-2 surface 200-2 which is the opposite face of the 2-1 surface 200-1, and in the center of the width direction Y of the 2-1 surface 200-1, the second wire slot 210 may be formed. And on both sides of the second wire slot 210, the slot protrusion 211 formed along the length direction of the second wire slot 210 may be formed.

On the other side of the second wire slot 210, the 2-1 cap connector 220 for snap fit connection with the 1-1 base connector 180 of the base member 100 is formed, and on one side of the second wire slot 210, the 2-2 cap connector 230 for supporting snap fit connection with the 1-2 base connector 190 of the base member 100 may be formed. Looking at the structure for snap fit connection in more detail, the end of the 2-1 cap connector 220 is formed facing the outside of the cap member 200 based on the width direction Y, and the end of the 2-2 cap connector 230 is also formed facing the outside of the cap member 200 based on the width direction, and when the cap member 200 is pushed toward the base member 100, this part temporarily moves inward, and then moves outward while meeting the 1-1 base connector 180 opened to the 1-3 surface of the base member 100 and the 1-2 base connector 190 opened to the 1-4 surface, achieving snap fit connection. Additionally, the second wire slot 210 may be formed so that its cross-section has a rectangular shape. Specifically, the imaginary plane IP parallel to the inner side wall of the second wire slot 210 can meet with the imaginary plane passing through the 2-2 surface of the cap member 200 at an inclination, so that the second wire slot 210 may be manufactured to have a tilted rectangular or parallelogram cross-section, and the angle may be selected in the range of 3 to 20 degrees. By forming the second wire slot 210 to have a tilted rectangular shape in this way, the present invention can effectively provide the torque force needed in the correction process to the tooth T. For reference, the lateral side length value of the second wire slot 210 with a rectangular cross-section in the width direction may be 0.3 to 0.6 millimeters, and the long horizontal side length value may be selected from 0.5 to 0.8 millimeters.

FIG. 68 is a drawing showing the 2-1 surface of another embodiment of the cap member of the present invention.

It can be confirmed that in the center of the width direction Y of the 2-1 surface 200-1 of the cap member 200, the second wire slot 210 is formed, and on both sides thereof, the slot protrusion 211 is formed, and the second wire slot 210 may be formed to accommodate 45 to 95% of the orthodontic wire 10 to be placed therein based on cross-section. For reference, the cap member 200 of another embodiment of the present invention is used for adjusting the alignment, horizontal alignment, and angle of anterior teeth, and the second wire slot 210 of the cap member 200 with a rectangular cross-section in the width direction is mainly used for tooth angle adjustment through torque application, and the cap member 200 with a semicircular second wire slot 210 after confirmation is mainly used in the initial stage of orthodontic treatment for tooth alignment. In this way, the present invention supports the selection and use of various brackets according to the position of the tooth T, the type of orthodontic work, and the timing, thereby shortening the duration of orthodontic treatment and further enhancing its effectiveness.

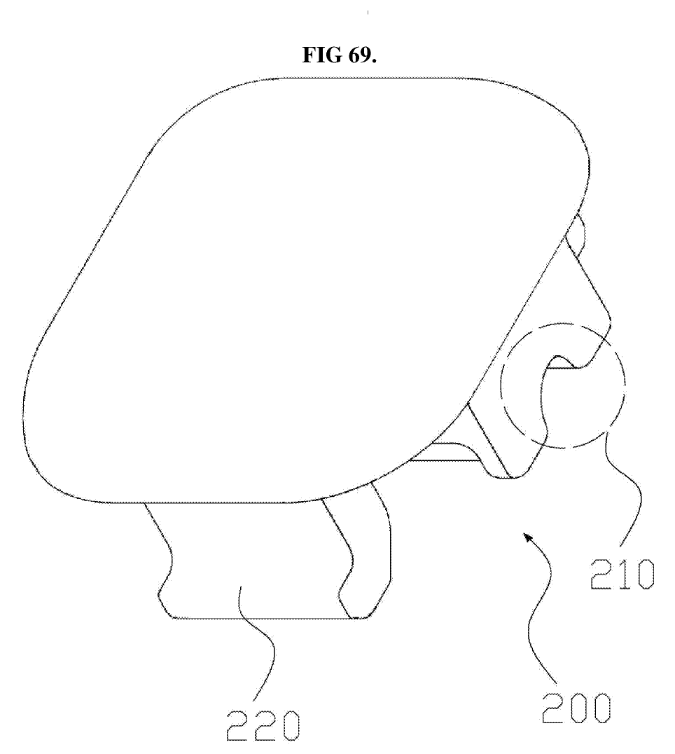

FIG. 69 is a drawing showing the overall appearance of yet another embodiment of the cap member of the present invention.

Yet another embodiment of the cap member 200 of the present invention is similar to the cap member 200 of the other embodiment in many respects, but differs in that instead of the cross-section of the second wire slot 210 being rectangular, a curved surface is formed inside to have a semicircular shape. Yet another embodiment of the cap member 200 supports a round cross-section orthodontic wire 10 and can be utilized to provide weak corrective force to the tooth T in the initial stage of tooth T orthodontic treatment. For reference, the 2-2 surface 200-2 of the cap member 200 may be formed with an identification mark in an embossed, etc. manner indicating the cross-sectional shape and/or inclination of the second wire slot 210.

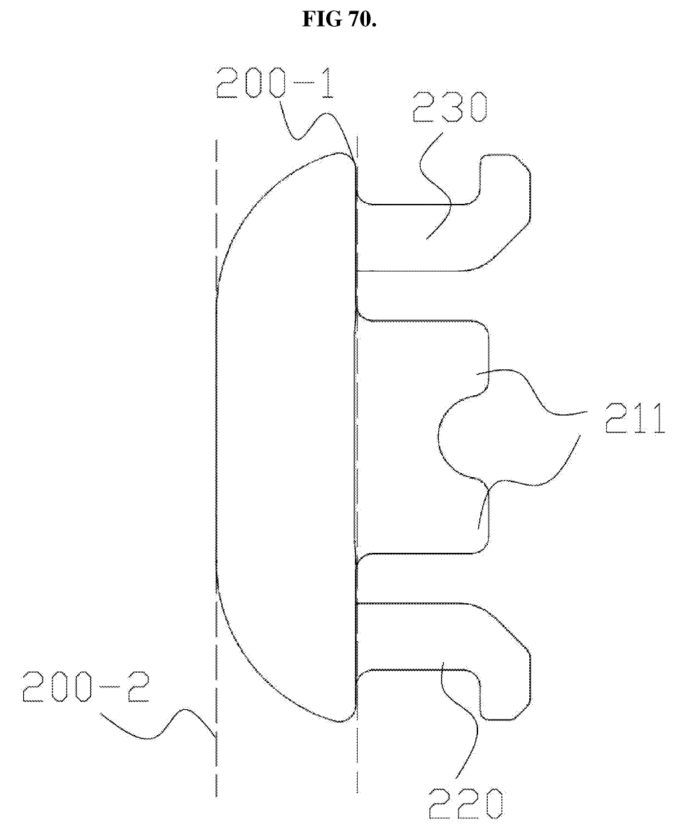

FIG. 70 is a drawing showing a side view of yet another embodiment of the cap member of the present invention.

Through the side view, it can be confirmed more specifically that the second wire slot 210 of yet another embodiment of the cap member 200 is manufactured in a semicircular shape, unlike the second wire slot 210 of the cap member 200 of the other embodiment. The diameter value of this second wire slot 210 may be 0.3 to 0.9 millimeters, and a cap member 200 equipped with a second wire slot 210 that is 0.8 to 1.2 millimeters larger than the diameter value of the round cross-section orthodontic wire 10 to be used can be selected and used. By using the cap member 200 equipped with this size of second wire slot 210, the present invention can reduce friction with the orthodontic wire 10 and fully transmit the corrective force provided by the orthodontic wire 10 to the tooth T.

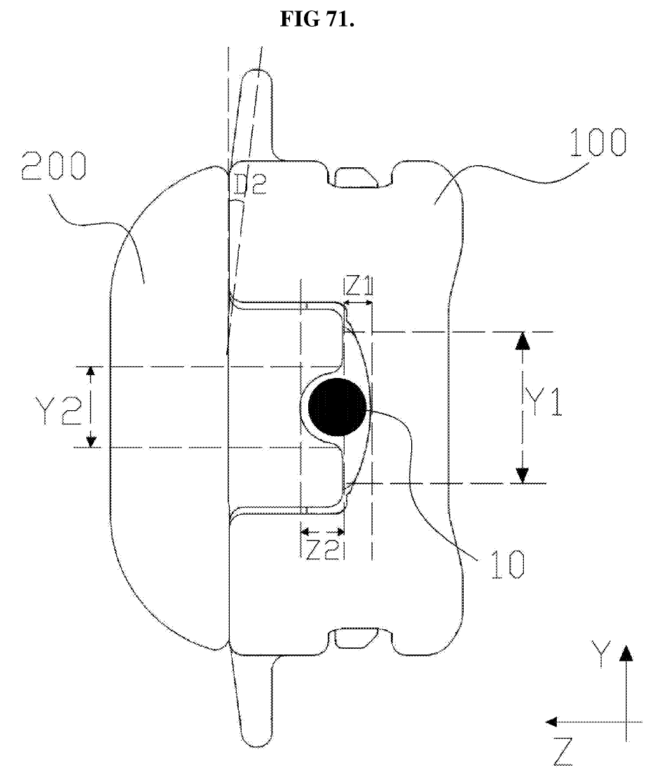

FIG. 71 is a drawing showing the appearance of yet another embodiment of the orthodontic bracket of the present invention, with the base member and cap member combined.

Yet another embodiment of the present invention also transmits the corrective force provided by the orthodontic wire 10 to the tooth T through the wire slot WS formed through the second wire slot 210 of the cap member 200 and the first wire slot 110 of the base member 100. To effectively provide this corrective force, the first wire slot 110 of the base member 100 may be formed so that the width value Y1 is larger than the width value Y2 of the second wire slot 210 of the cap member 200, and may be manufactured with a curved surface formed in the width direction. And the depth value Z2 of the second wire slot 210 of the cap member 200 may be formed with a value larger than the depth value Z1 of the first wire slot 110 of the base member 100. Through this structure, the first wire slot 110 of the base member 100 can stably support the orthodontic wire 10 by accommodating the slot protrusion 211 formed on both sides of the second wire slot 210 therein. For reference, the 1-1 protrusion 193 formed on the 1-3 surface… may be formed so as to have a first inclination D2 of approximately 15 degrees relative to a virtual surface covering the 1-2 surface 100-2 of the base member 100.

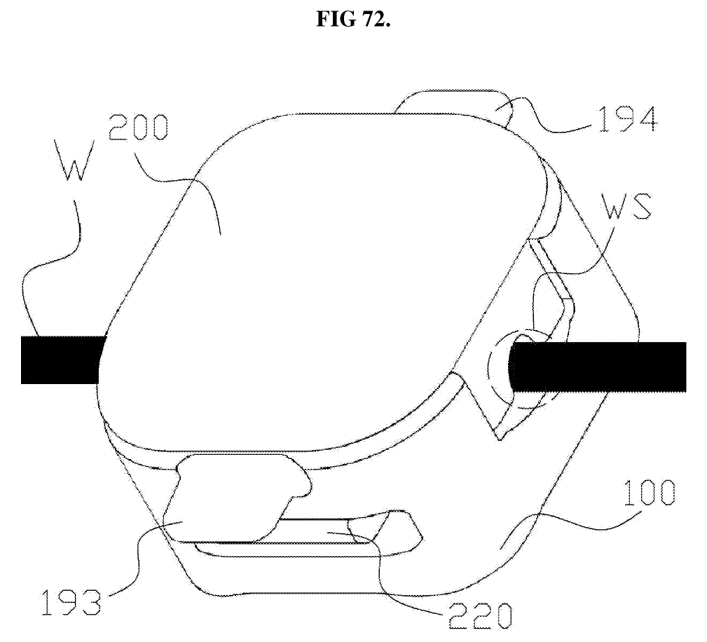

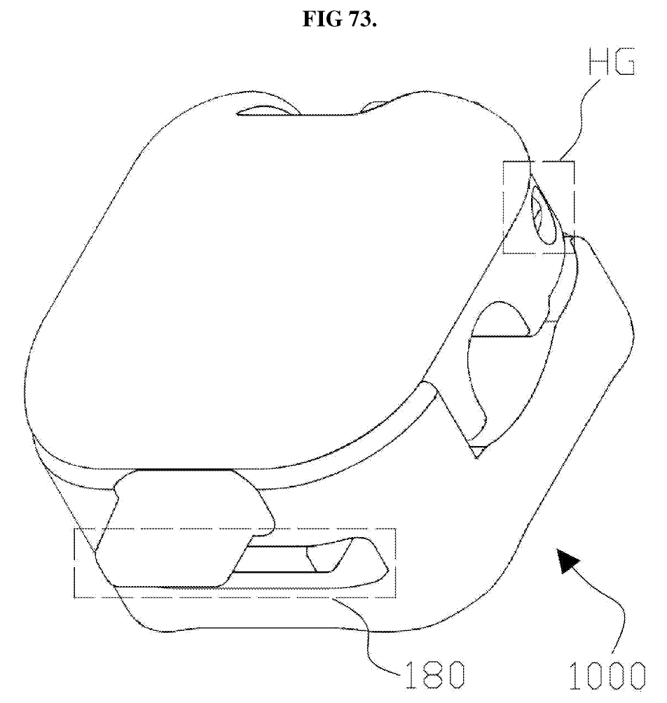

FIG. 72 is a drawing showing, in yet another embodiment of the orthodontic bracket of the present invention, the appearance of the orthodontic wire placed between the base member and cap member.

The orthodontic wire 10 is placed on the first wire slot 110 of the base member 100, and when the cap member 200 moves while pressing down, the cap member 200 and base member 100 are connected by snap fit, and the corrective force provided by the orthodontic wire 10 is transmitted to the tooth T through the wire slot WS formed by the first wire slot 110 and second wire slot 210. Looking at this process in more detail, the 2-1 cap connector 220 and 2-2 cap connector 230 of the cap member 200 are pressed down by the base member 100, briefly moving to the inside of the cap member 200, and then moving outward while meeting the open area of the 1-1 base connector 180 and 1-2 base connector 190, snap fit locking is completed.

The process of detaching and removing the cap member 200 from the base member 100 can be performed in the reverse order of the coupling process, where after moving the 2-1 cap connector 220 and 2-2 cap connector 230 of the cap member 200 in the inward direction of the cap member 200, the coupling between the cap member 200 and base member 100 can be released by lifting the cap member 200 in the direction of the 2-2 surface 200-2. This process can also be performed using a separate tool capable of conveniently pressing the 2-1 cap connector 220 and 2-2 cap connector 230. In this way, the present invention makes connection and release between the cap member 200 and base member 100 very convenient and easy, enabling easy provision of a bracket with appropriate slots corresponding to the size and shape of the orthodontic wire 10 used at each stage of orthodontic treatment.

FIG. 73 is a drawing showing the overall appearance of another embodiment of the orthodontic bracket of the present invention.

Another embodiment of the orthodontic bracket 1000 of the present invention differs from the other embodiment of the orthodontic bracket 1000 described above in that the cap member 200 and base member 100 are connected to each other by a hinge method HG. That is, while in the other embodiment described above, the cap member 200 and base member 100 are configured separately and independently, in another embodiment, the cap member 200 is connected to the base member 100 by a hinge method HG and the portion capable of rotating is special. This yet another embodiment can be used in posterior teeth after premolars rather than anterior teeth, and together with round cross-section orthodontic wires 10 used together, effectively supports the sliding movement of teeth after premolars.

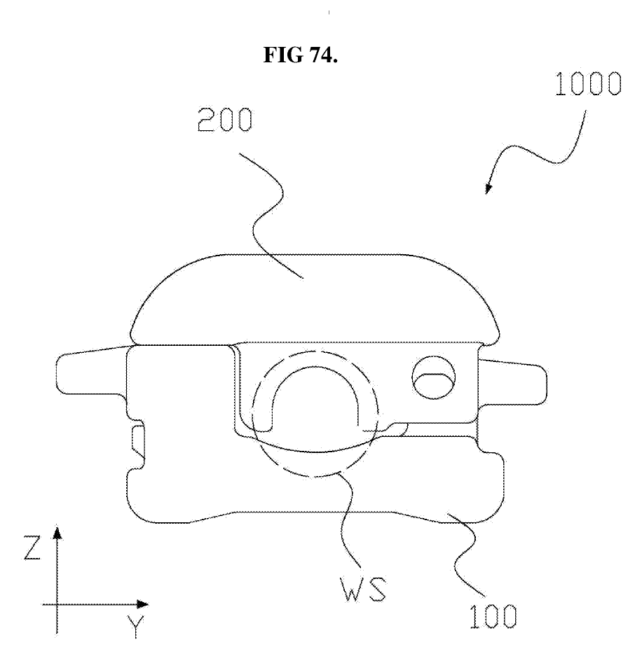

FIG. 74 is a drawing showing a side view of yet another embodiment of the orthodontic bracket of the present invention.

The yet another embodiment of the orthodontic bracket 1000 can be confirmed in more detail through the side view, confirming that the upper cap member 200 and lower base member 100 are connected to each other by a hinge method. Also, the shape of the wire slot WS formed by the combination of the second wire slot 210 of the cap member 200 and the first wire slot 110 of the base member 100 can also be confirmed, and in the case of the drawing, it can be confirmed that the second wire slot 210 is formed in a semicircular shape to support a round cross-section orthodontic bracket 1000. In detail, it can be confirmed that the width value of the first wire slot 110 is larger than the width value of the second wire slot 210, and the curvature value of the curved surface of the first wire slot 110 is smaller than the curvature value of the curved surface of the second wire slot 210, forming a gentle curved surface. For reference, in yet another embodiment of the present invention, it is mainly used for premolars and molars, and the second wire slot 210 is generally manufactured in a semicircular shape, but it does not restrict it from being formed in a rectangular shape if necessary.

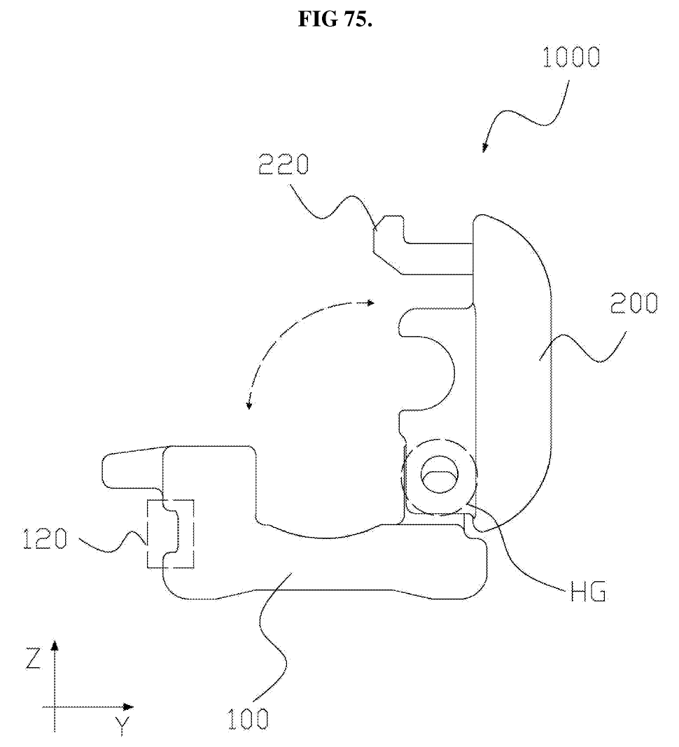

FIG. 75 is a drawing showing, in yet another embodiment of the orthodontic bracket of the present invention, the appearance with the cap member open.

As mentioned above, the cap member 200 of yet another embodiment of the orthodontic bracket 1000 according to the present invention can rotate centered on the axis operating by the hinge method HG. That is, when connecting and coupling the base member 100 and cap member 200, pressing the cap member 200 toward the base member 100 side causes the 2-1 cap connector 220 to briefly move to the inside of the cap member 200 and then return to its original position while snap fit connection is made with the 1-1 base connector 180. Conversely, upon releasing the base member 100 and cap member 200, after the end of the 2-1 cap connector 220 has been moved to the inside of the cap member 200 by separate tools, etc., rotating the cap member 200 upward releases the connection between the base member 100 and cap member 200. Through this method, the present invention can further improve user convenience related to tooth T orthodontic work in premolars and molars.

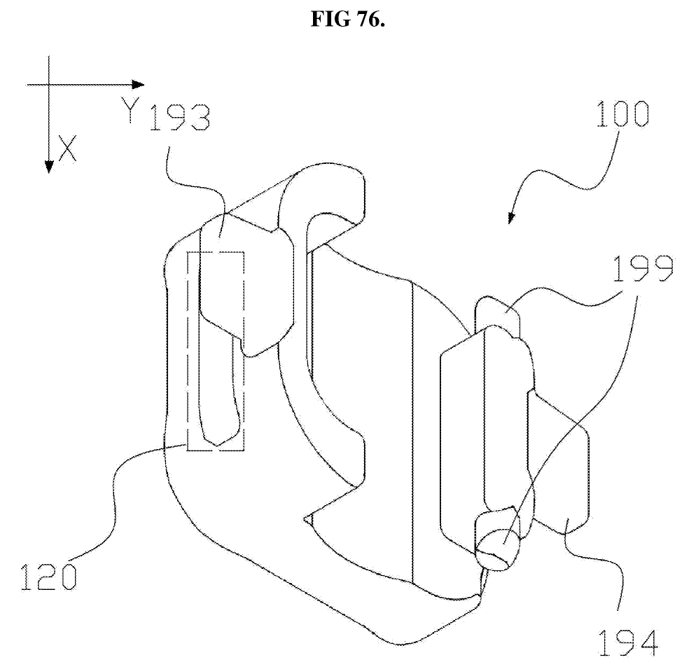

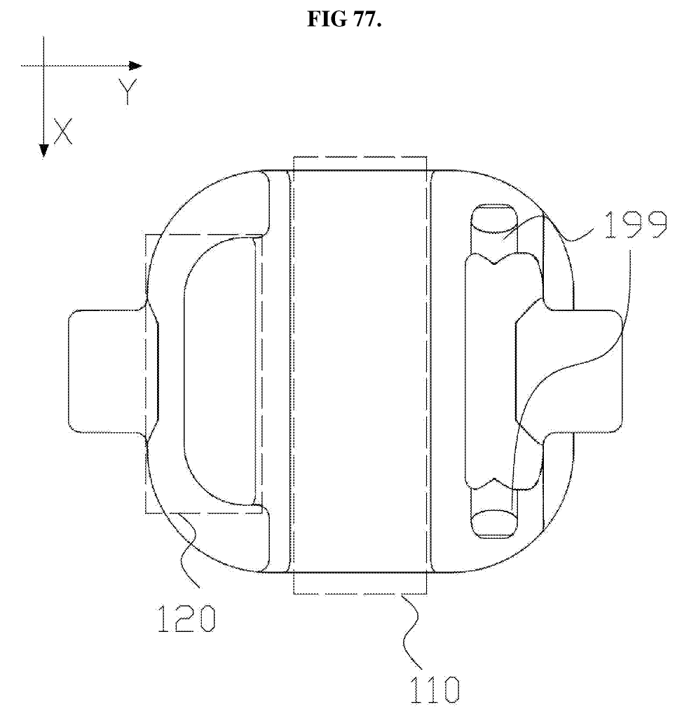

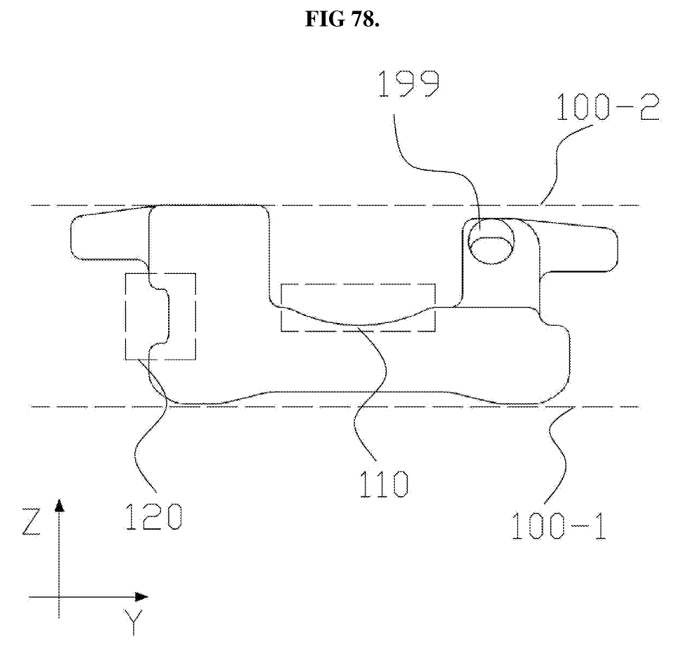

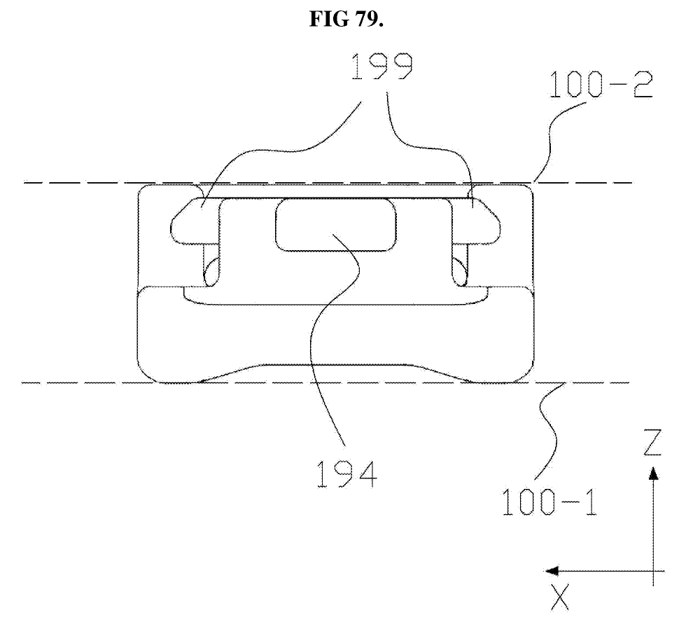

FIG. 76 is a drawing showing the overall appearance of the base member of yet another embodiment of the orthodontic bracket of the present invention, FIG. 77 is a drawing showing the appearance of the 1-2 surface of the base member of yet another embodiment, FIG. 78 is a drawing showing a side view of the base member of yet another embodiment, and FIG. 79 is a drawing showing the 1-4 surface of the base member of yet another embodiment.

The base member 100 of yet another embodiment is formed with a pair of hinge protrusions 199 on one side of the first wire slot 110 for hinge connection with the cap member 200, and on the other side of the first wire slot 110, a 1-1 base connector 180 for snap fit connection with the 2-1 cap connector 220 of the cap member 200 may be formed. That is, similar to the other embodiment of the base member 100 described above, the 1-1 base connector 180 is formed starting from the 1-2 surface 100-2 and opened to the outside through the 1-3 surface, but on the opposite side, instead of the 1-2 base connector 190, a pair of hinge protrusions 199 is formed. For reference, the first wire slot 110 of the base member 100 and the second wire slot 210 of the cap member 200 may be formed to have the same length values.

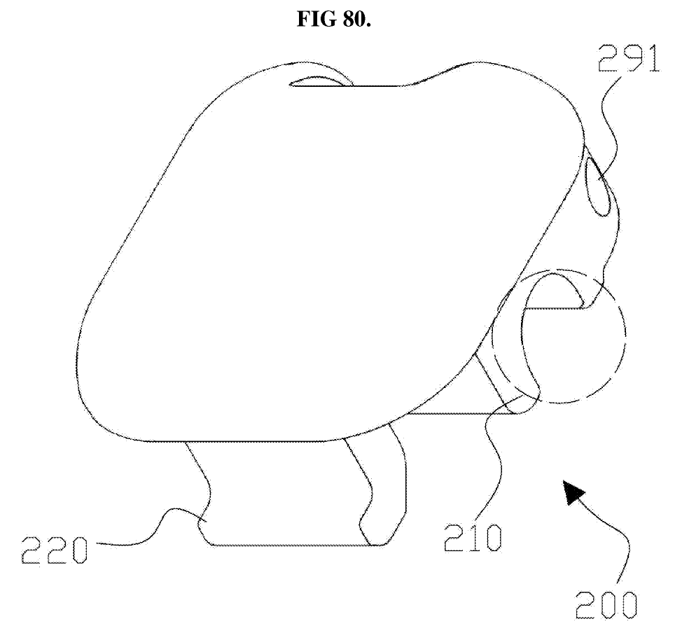

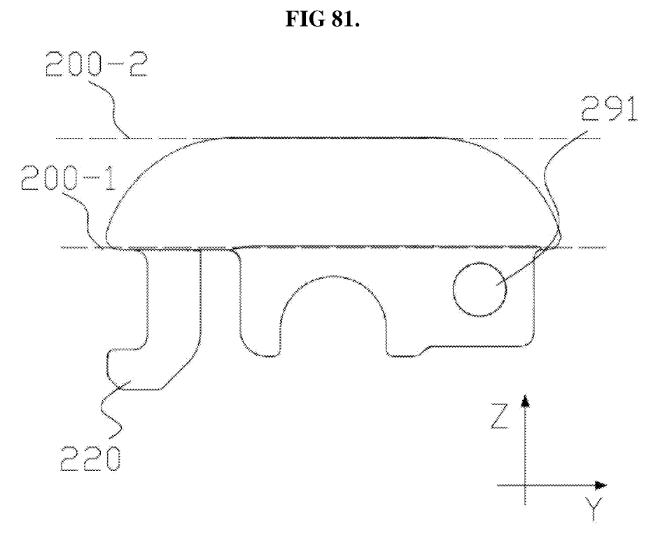

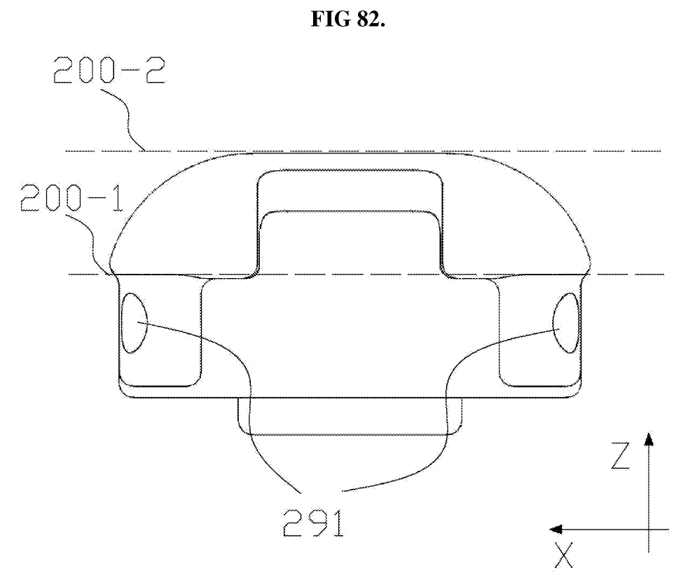

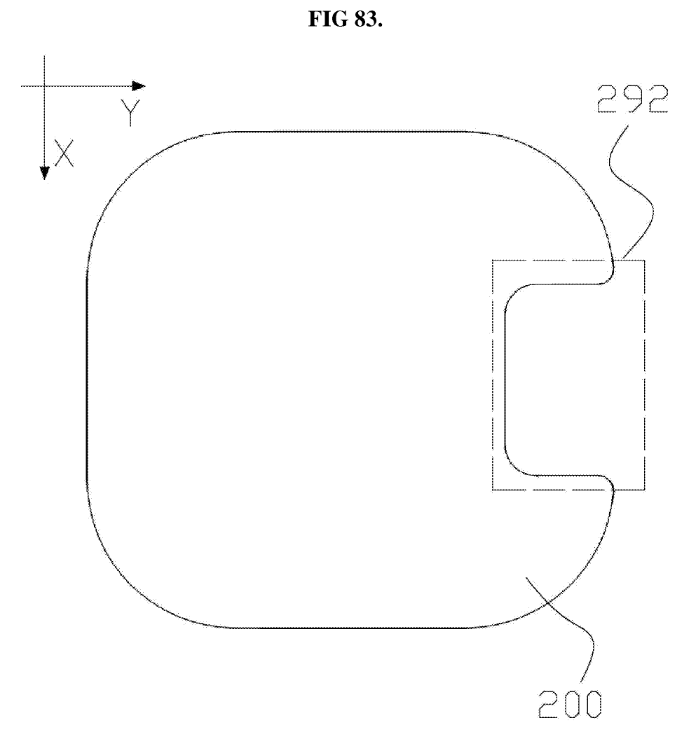

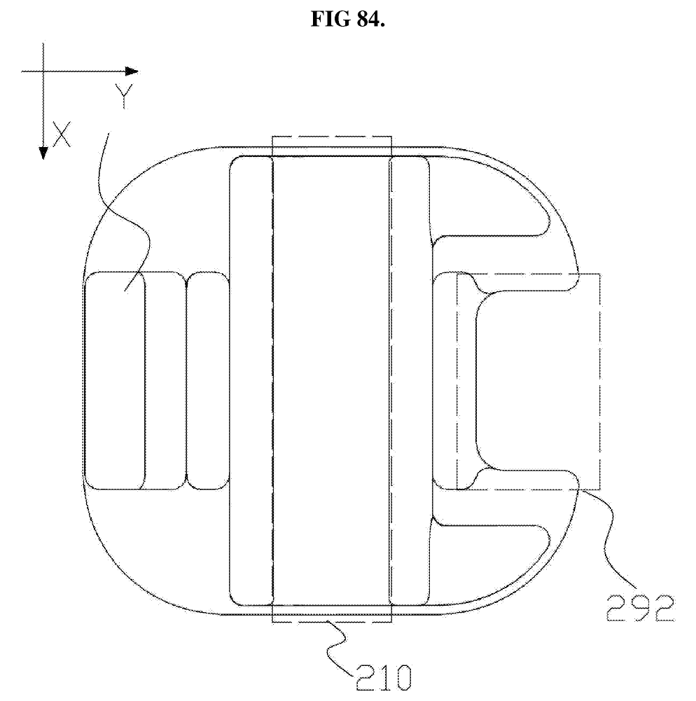

FIG. 80 is a drawing showing the overall appearance of the cap member of yet another embodiment, FIG. 81 is a drawing showing a side view of the cap member of yet another embodiment, FIG. 82 is a drawing showing the portion where a hinge groove is formed in the cap member of yet another embodiment, FIG. 83 is a drawing showing the cap member of yet another embodiment viewed from above, and FIG. 84 is a drawing showing the cap member of yet another embodiment viewed from above.

The cap member 200 coupled to this yet another embodiment base member 100 may also be formed with a pair of hinge grooves 291 for hinge connection, and by inserting the hinge protrusions 199 of the base member 100 into these hinge grooves 291, the cap member 200 and base member 100 are connected as one to complete the yet another embodiment orthodontic bracket 1000 according to the present invention. Also, the cap member 200 of yet another embodiment may be formed with a cap groove portion 292 to avoid interference between the 1-2 protrusion 194 of the base member 100 and the cap member 200 when opening and closing around the hinge axis. This part accommodates the 1-2 protrusion 194 of the base member 100 inside when the cap member 200 is opened, thereby preventing the 1-2 protrusion 194 from restricting the opening of the cap member 200. Through this configuration, yet another embodiment of the orthodontic bracket 1000 according to the present invention can conveniently support the sliding movement of premolars and/or molars during the orthodontic process.

As described above, the present invention has been described with reference to preferred embodiments, but those skilled in the art in the relevant technical field will understand that the present invention can be modified and changed in various ways within the scope not departing from the spirit and scope of the present invention described in the claims below.

### Description of Reference Numerals

T: tooth

SL: slot

WS: wire slot

RE: resin

RE1: first resin

RE2: second resin

TR: temporary resin

RM: removal tool

CP: contact plane

10: orthodontic wire

20: conventional metal orthodontic device

21: rubber band hook

30: conventional self-ligating bracket

31: cover

50: wire

100: base member

100-1: 1-1 surface

100-2: 1-2 surface

100-3: 1-3 surface

100-4: 1-4 surface

110: first wire slot

171: 1-1 space

172: 1-2 space

173: 3rd open portion

174: 4th open portion

175: identification mark

176: wall pattern

180: 1-1 base connector

181: 1-1 rail portion

182: 1-1 groove portion

190: 1-2 base connector

191: 1-2 rail portion

192: 1-2 groove portion

200: cap member

200-1: 2-1 surface

200-2: 2-2 surface

200-3: 2-3 surface

200-4: 2-4 surface

210: second wire slot

211: slot protrusion

220: 2-1 cap connector

221: 2-1 rail portion

222: 2-1 latch

230: 2-2 cap connector

231: 2-2 rail portion

232: 2-2 latch

281: 2-1 protrusion

282: 2-2 protrusion

290: identification mark

1000: orthodontic bracket according to the present invention

What is claimed is:

1. A bracket for orthodontic treatment, comprising:
a base member; and
a cap member,
wherein the base member and the cap member are detachably connected by a snap-fit engagement.

2. The orthodontic bracket of claim 1, wherein one side of the 1-2 surface of the base member and one side of the 2-1 surface of the cap member are connected by a hinge method.

3. The orthodontic bracket of claim 1, wherein the cap member further comprises:
a cap groove capable of accommodating the 1-2 protrusion of the base member therein when rotating about the hinge axis.

4. The orthodontic bracket of claim 1, wherein an orthodontic wire is disposed between the base member and the cap member, and
the base member is formed of a resin comprising engineering plastic.

5. The orthodontic bracket of claim 1, wherein the base member comprises:
a 1-1 surface used for attachment to a tooth;
a 1-2 surface facing the cap member; and
a first wire slot formed on the 1-2 surface.

6. The orthodontic bracket of claim 5, wherein the base member further comprises:
a 1-1 base connector on the other side of the first wire slot for snap fit connection with the cap member;
a 1-2 base connector on one side of the first wire slot for snap fit connection with the cap member; and
a pair of hinge protrusions on one side of the first wire slot for hinge connection with the cap member.

7. The orthodontic bracket of claim 6, wherein the 1-2 base connector is formed through the 1-4 surface of the base member, and
the 1-1 base connector is formed through the 1-3 surface of the base member.

8. The orthodontic bracket of claim 7, wherein the width value of the first wire slot is larger than the width value of the second wire slot of the cap member,
a slot protrusion of the cap member is accommodated inside the first wire slot,
the length value of the first wire slot is the same as the length value of the second wire slot of the cap member, and
the second wire slot accommodates 50 to 90 percent (%) of the cross-sectional area of an orthodontic wire therein.

9. The orthodontic bracket of claim 7, wherein the first wire slot has a curved surface formed in the width direction, and
the curvature value of the curved surface of the first wire slot is smaller than the curvature value of the curved surface of the second wire slot of the cap member.

10. The orthodontic bracket of claim 1, wherein the 1-1 surface of the base member is attached to the front surface of a tooth, and
the cap member comprises:
a 2-1 surface in the direction of contact with the base member; and
a second wire slot formed on the 2-1 surface.

11. The orthodontic bracket of claim 10, wherein the cap member further comprises:
a 2-1 cap connector on the other side of the second wire slot for snap fit connection with the base member;
a pair of hinge grooves on one side of the second wire slot for hinge connection with the base member; and
a 2-2 cap connector on one side of the second wire slot for snap fit connection with the base member.

12. The orthodontic bracket of claim 11, wherein the end of the structure for connection of the 2-1 cap connector is a hook facing outward of the cap member based on the width direction, and
the end of the structure for connection of the 2-2 cap connector is a hook facing outward of the cap member based on the width direction.

13. The orthodontic bracket of claim 10, wherein the cap member further comprises:
a slot protrusion formed along the length direction of the second wire slot,
the width value of the second wire slot is smaller than the width value of the first wire slot of the base member, and
the length value of the second wire slot is the same as or greater than the length value of the first wire slot of the base member.

14. The orthodontic bracket of claim 13, wherein the second wire slot is formed in a semicircular shape,
the diameter value of the second wire slot is 0.3 to 0.9 millimeters (mm),
the second wire slot has a curved surface formed in the width direction,
the curvature value of the curved surface of the second wire slot is greater than the curvature value of the curved surface of the first wire slot of the base member, and
the second wire slot accommodates 45 to 95 percent (%) of the cross-sectional area of an orthodontic wire therein.

15. The orthodontic bracket of claim 10, wherein the width-direction cross-section of the second wire slot is formed in a rectangular shape,
the lateral side length value of the width-direction rectangular cross-section of the second wire slot is 0.3 to 0.6 millimeters, and
the longer horizontal side length value among the horizontal sides of the width-direction rectangular cross-section of the second wire slot is 0.5 to 0.8 millimeters.

16. The orthodontic bracket of claim 15, wherein a virtual plane parallel to the inner side wall of the second wire slot meets perpendicularly with a virtual plane passing through the 2-2 surface of the cap member.

17. The orthodontic bracket of claim 15, wherein the inclination formed between a virtual plane parallel to the inner side wall of the second wire slot and a virtual plane passing through the 2-2 surface of the cap member is 3 to 20 degrees.

18. The orthodontic bracket of claim 1, wherein the base member further comprises:
a 1-1 protrusion formed on the 1-3 surface; and
a 1-2 protrusion formed on the 1-4 surface.

19. The orthodontic bracket of claim 18, wherein the 1-1 protrusion is formed to have a first inclination with a virtual plane covering the 1-2 surface of the base member, and
the 1-2 protrusion is formed to have a first inclination with a virtual plane covering the 1-2 surface.

20. The orthodontic bracket of claim 19, wherein the first inclination is 15 degrees, and
the 1-1 protrusion and/or the 1-2 protrusion is used for engaging a rubber band.
